(19) United States
(12) Patent Application Publication
(10) Pub. No.: US 2004/0179190 A1
(43) Pub. Date: Sep. 16, 2004

(54) Optical properties measurement method, exposure method, and device manufacturing method

(75) Inventors: Kazuyuki Miyashita, Tokyo (JP); Takashi Mikuchi, Ageo-shi (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: Nikon Corporation, Chiyoda-ku (JP)

(21) Appl. No.: 10/702,435

(22) Filed: Nov. 7, 2003

Related U.S. Application Data
(63) Continuation of application No. PCT/JP02/04435, filed on May 7, 2002.

(30) Foreign Application Priority Data
May 7, 2001 (JP) 2001-135,779
Feb. 8, 2002 (JP) 2002-031,902
Feb. 8, 2002 (JP) 2002-031,916

(51) Int. Cl. G01B 9/00

(52) U.S. Cl. 356/124

(57) ABSTRACT

A pattern arranged on an object is sequentially transferred onto a wafer arranged on an image plane side of a projection optical system so as to form a matrix shaped first area, which is made up of a plurality of divided areas, and in the periphery of the first area an overexposed second area is formed. And, a formed state of an image of the pattern in a plurality of divided areas is detected by an image processing method such as contrast detection. In this case, since the overexposed second area is located on the outer side of the first area, the borderline of the divided areas in the outermost section of the first area and the second area can be detected with a good S/N ratio, and the position of other divided areas can be calculated with substantial precision, with the borderline serving as datums. Accordingly, the formed state of the pattern image can be detected in a short period of time.

### CROSS-REFERENCE TO RELATED APPLICATIONS

This is a continuation of International Application PCT/JP02/04435, with an international filing date of May 7, 2002, the entire content of which being hereby incorporated herein by reference, which was not published in English.

### BACKGROUND OF THE INVENTION

1. Field of the Invention

The present invention relates to optical properties measurement methods, exposure methods, and device manufacturing methods, and more particularly to an optical properties measurement method for measuring the optical properties of a projection optical system, an exposure method in which exposure is performed using the projection optical system that has been adjusted taking into consideration the optical properties measured by the optical properties measurement method, and a device manufacturing method using the exposure method.

2. Description of the Related Art

Conventionally, in a lithographic process to produce semiconductor devices, liquid crystal display devices, or the like, an exposure apparatus has been used that transfers a pattern formed on a mask or a reticle (hereinafter generally referred to as a ‘reticle’) onto a substrate such as a wafer or a glass plate (hereinafter also appropriately referred to as a ‘wafer’) on which a resist or the like is coated, via a projection optical system. As such an apparatus, in recent years, from the viewpoint of putting importance on throughput, the reduction projection exposure apparatus based on a step-and-repeat method (or the so-called ‘stepper’) or the exposure apparatus of a sequentially moving type such as the scanning exposure apparatus based on a step-and-scan method is relatively widely used.

In addition, integration of devices such as semiconductors (integrated circuits) is increasing year by year, and due to such circumstances, a higher resolution, that is, the capability to transfer finer patterns with good precision, is being further required in the production equipment such as the projection exposure apparatus that produces such semiconductor devices. In order to improve the resolution of the projection exposure apparatus, the optical properties of the projection optical system has to be improved, therefore, accordingly, it is important to accurately measure and evaluate the optical properties (including the image forming characteristics) of the projection optical system.

In an accurate measurement of the optical properties of the projection optical system, such as the image plane of a pattern, it is a premise to be able to accurately measure the optimal focus position (best focus position) at each evaluation point (measurement point) within the field of the projection optical system.

As the measurement method for measuring the best focus position in a conventional projection exposure apparatus, the following two methods are mainly known.

One is a measurement method known as the so-called CD/focus method. In this method, a predetermined reticle pattern (for example, a line-and-space pattern or the like) serves as a test pattern, and the test pattern is transferred onto a test wafer at a plurality of wafer positions in the optical axis direction of the projection optical system. Then, the test wafer is developed, and the line width value of the resist image that is obtained (the image of the pattern transferred) is measured using a scanning electron microscope (SEM) or the like, and based on the relationship between the line width value and the wafer position in the optical axis direction of the projection optical system (hereinafter also appropriately referred to as the ‘focus position’), the best focus position is determined.

The other method is a measurement method known as the so-called SMP focus measurement method, as is disclosed in, for example, Japanese Patent Nos. 2580668 and 2712330, and the corresponding U.S. Pat. No. 4,908,656. In this method, a resist image of a wedge-shaped mark is formed on the wafer at a plurality of focus positions, and the change in the line width value of the resist image due to the different focus positions is replaced with the dimensional change amplified in the longitudinal direction. Then, the length of the resist image in the longitudinal direction is measured using a mark detection system such as an alignment system, which detects the marks on the wafer. And then, an approximated curve that denotes a relationship between the focus position and the length of the resist image is sliced in the vicinity of the local maximal value at a predetermined slice level, and the midpoint of the focus position range obtained is decided as the best focus position.

Then, for various types of test patterns, the optical properties of the projection optical system such as astigmatism and curvature of field are measured based on the best focus position obtained in the manner described above.

However, in the CD/focus method described above, for example, because the line width value of the resist image was measured with the SEM, focus adjustment of the SEM had to be precisely performed, and the time required for measurement per point was extremely long, thus measurement at multiple points took from several hours up to several tens of hours. In addition, it can be expected that the test pattern used for measuring the optical properties of the projection optical system will become finer, and the evaluation points in the field of the projection optical system will increase. Accordingly, with the conventional measurement method using the SEM, there was an inconvenience of the throughput until the measurement results are obtained greatly decreasing. In addition, because the level required for measurement error and reproducibility of the measurement results is increasing, it is becoming difficult to cope with such requirements by the conventional measurement method. Furthermore, the approximated curve that denotes the relationship between the focus position and the line width value uses an approximated curve of the fourth order or over in order to reduce errors, which meant that there was a restriction of having to obtain the line width related to at least five types of focus position per each evaluation point. In addition, the difference between the line width at a focus position shifted from the best focus position (including both the +direction and −direction in the optical axis direction of the projection optical system) and the line width at the best focus position is required to be 10% or over in order to reduce errors, however, this condition has become difficult to satisfy.

In addition, in the SMP focus measurement method described above, because the measurement is normally performed with monochromatic light, the influence of interference may differ depending on the shape of the resist image, which in turn may lead to a measurement error (dimension offset). Furthermore, when the length of the resist image of the wedge-shaped mark is measured by image processing, information that covers both ends of the thinning resist image in the longitudinal direction has to be taken in with preciseness, however, there is a problem that the resolution of current image processing units (such as a CCD camera) is not sufficient enough. In addition, because the test pattern was large, it was difficult to increase the number of evaluation points within the field of the projection optical system.

Other than the methods described above, mainly as an improvement of the drawback in the above CD/focus method, an invention for determining the best exposure condition such as the best focus position is disclosed in, for example, Japanese Patent Application Laid-open No. H11-233434. In this method, the wafer on which the pattern is transferred by test exposure is developed, then after development the resist image of the pattern to be formed on the wafer is picked up, and then pattern matching is performed with a predetermined template using the pick-up data to determine the best exposure condition such as the best focus position. According to the invention disclosed in the above publication, it does not have any problems as in the SMP measurement method, of insufficient resolution in current image processing units (such as the CCD camera) and the inconvenience of not being able to increase the number of evaluation points within the field of the projection optical system.

However, in the case of employing and also automating such a template matching method, a frame (pattern) is usually formed that serves as datums with the pattern on the wafer to make the template matching simple.

And, when the deciding method of the best exposure condition using such template matching is employed, among various processing conditions, there were some cases when the measurement could not be performed because the contrast of the pattern showed significant deterioration when the image was picked up by a wafer alignment system based on an image processing method, such as an alignment sensor of an FIA (field image alignment) system, due to the frame serving as datums on template matching formed in the vicinity of the pattern.

### SUMMARY OF THE INVENTION

The present invention was made under such circumstances, and has as its first object to provide an optical properties measurement method that can measure optical properties of a projection optical system with good accuracy and reproducibility within a short period of time.

In addition, the second object of the present invention is to provide an exposure method that can perform exposure with high precision.

And, the third object of the present invention is to provide a device manufacturing method that can improve the productivity when producing high integration devices.

According to a first aspect of the present invention, there is provided a first optical properties measurement method in which optical properties of a projection optical system that projects a pattern on a first surface onto a second surface is measured, the measurement method comprising: a first step in which a rectangular shaped first area in general made up of a plurality of divided areas arranged in a matrix shape is formed on an object, by a measurement pattern arranged on the first surface being sequentially transferred onto the object arranged on the second surface side of the projection optical system while at least one exposure condition is changed; a second step in which an overexposed second area is formed in an area on the object that is at least part of the periphery of the first area; a third step in which a formed state of an image of the measurement pattern in a plurality of divided areas that are at least part of the plurality of divided areas making up the first area is detected; and a fourth step in which optical properties of the projection optical system are obtained, based on results of the detection.

In the description, the term ‘exposure condition’ means exposure conditions in a broad sense that includes setting conditions of all parts related to exposure such as the optical properties of the projection optical system, other than the narrow sense of the word such as illumination conditions (including the type of masks) and exposure dose amount on an image plane.

With this method, a rectangular shaped first area in general made up of a plurality of divided areas arranged in a matrix shape is formed on an object, by a measurement pattern arranged on the first surface being sequentially transferred onto the object arranged on the second surface side of the projection optical system while at least one exposure condition is changed, and an overexposed second area is formed in an area on the object that is at least part of the periphery of the first area (the first and second steps).

Then, a formed state of an image of the measurement pattern in a plurality of divided areas that are at least part of the plurality of divided areas making up the first area is detected (the third step). When the object is a photosensitive object, detection of the formed state of the image of the measurement pattern may be performed on a latent image formed on the object without developing the object, or when the object on which the above image has been formed has been developed, the detection may be performed on the resist image formed on the object or on image that is obtained by an etching process on the object where the resist image is formed (etched image). The photosensitive layer for detecting the formed state of the image on the object is not limited to a photoresist, as long as an image (at least either a latent image or a manifest image) can be formed, by irradiating light (energy) on the layer. For example, the photosensitive layer may be an optical recording layer or a magenetooptic recording layer, accordingly, the object on which the photosensitive layer is formed is not limited to a wafer, a glass plate, or the like, and it may be a plate or the like on which the optical recording layer, the magenetooptic recording layer, or the like can be formed.

For example, when the detection of the formed state of the image is performed on the resist image or the etched image, various types of alignment sensors can be used; microscopes such as an SEM as a matter of course, an alignment detection system of an exposure apparatus such as an alignment detection system based on an image processing method that forms the image of alignment marks on an imaging device like the alignment sensor of the so-called FIA (Field Image Alignment) system, an alignment sensor that irradiates a coherent detection light onto an object and detects the scattered light or diffracted light generated from the object like the alignment sensor of the LSA system, or an alignment sensor that performs detection by making two diffracted lights (for example, in the same order) generated from an object interfere with each other, or the like.

In addition, when detection of the formed state of the image is to be performed on a latent image, the FIA system or the like can be used.

In any case, because the overexposed second area (an area where the pattern image is not formed) exists on the outer side of the first area, when detecting the divided areas located on the outermost periphery section within the first area (hereinafter referred to as ‘outer periphery section divided area’), it prevents the contrast of the image in the outer periphery section divided area from deteriorating due to the pattern image located on the outer adjacent area of the outer periphery section divided area. Accordingly, the borderline of the outer periphery section divided area and the second area can be detected with a good S/N ratio, and by calculating the position of other divided area with the borderline as datums, almost the exact position of other divided areas can be obtained. In this manner, since the almost exact position of the plurality of divided areas in the first area can be obtained, the formed state of the pattern image can be detected within a short period of time, for example, by detecting the image contrast or the light amount of reflected light such as the diffracted light in each divided area.

Then, the optical properties of the projection optical system is obtained based on the detection results (the fourth step). In this step, because the optical properties are obtained based on objective and quantitative detection results using the image contrast or the light amount of reflected light such as the diffracted light, the optical properties can be measured with good accuracy and reproducibility when compared with the conventional measurement method.

In addition, because the measurement pattern can be smaller compared with the conventional method measuring the size, more measurement patterns can be arranged within the pattern area on the mask (or the reticle). Accordingly, the number of evaluation points can be increased, which means that the space in between the evaluation points can be narrowed, and as a consequence, the measurement accuracy in the optical properties measurement can be improved.

Therefore, according to the first optical measurement method in the present invention, the optical properties of the projection optical system can be measured with good accuracy and reproducibility within a short period of time.

In this case, the first step may be performed in prior to the second step, however, the second step may be performed prior to the first step. The latter case is especially suitable, for example, when a high sensitive resist such as a chemically amplified photoresist is used as the photosensitive agent, since it can reduce the time required from the forming (transferring) of the image of the measurement pattern to development.

With the first optical properties measurement method in the present invention, the second area can be at least part of a rectangular frame shaped area that encloses the first area, slightly larger than the first area. In such a case, by detecting the outer edge of the second area, the position of the plurality of divided areas making up the first area can be easily calculated with the outer edge serving as datums.

In the first optical properties measurement method in the present invention, in the second step, the second area can be formed by transferring a predetermined pattern arranged on the first surface onto the object arranged on the second surface side of the projection optical system. In this case, as the predetermined pattern, various patterns may be considered, like a rectangular frame shaped pattern, or a part of the rectangular framed pattern, such as an U-shaped pattern. For example, when the predetermined pattern is a rectangular shaped pattern in general, in the second step, the rectangular shaped pattern in general arranged on the first surface can be transferred onto the object arranged on the second surface side of the projection optical system by a scanning exposure method (or by a step-and-stitch method). Or, when the predetermined pattern is a rectangular shaped pattern in general, in the second step, the rectangular shaped pattern in general arranged on the first surface can be sequentially transferred onto the object arranged on the second surface side of the projection optical system.

Besides the description so far, in the first optical properties measurement method in the present invention, in the second step, the measurement pattern arranged on the first surface can be sequentially transferred onto the object arranged on the second surface side of the projection optical system with an overexposed exposure amount, so as to form the second area.

In the first optical properties measurement method in the present invention, in the third step, each position can be calculated for the plurality of divided areas making up the first area, with part of the second area as datums.

In the first optical properties measurement method in the present invention, in the third step, the formed state of an image in a plurality of divided areas that are at least part of the plurality of divided areas making up the first area can be detected by a template matching method, based on imaging data corresponding to the plurality of divided areas that make up the first area and to the second area.

In the first optical properties measurement method in the present invention, in the third step, the formed state of an image in a plurality of divided areas that are at least part of the plurality of divided areas making up the first area can be detected with a representative value related to pixel data of each of the divided areas obtained by imaging serving as a judgment value. In such a case, since the formed state of the image (the image of the measurement pattern) is detected using the representative value related to the pixel data of each divided area, which is an objective and quantitative value, as the judgment value, the formed state of the image can be detected with good accuracy and good reproducibility.

In this case, the representative value can be at least one of an additional value, a differential sum, dispersion, and a standard deviation of the pixel data. Or, the representative value can also be at least one of an additional value, a differential sum, dispersion, and a standard deviation of a pixel value within a designated range in each divided area. As a matter of course, the designated range in each divided area, and the area in which pixel data for calculating the representative value is extracted (such as the divided area) may have any shapes, such as a polygonal shape like a rectangle, a circle, an ellipse, or a triangle.

With the first optical properties measurement method in the present invention, on detecting the formed state of the image, binarization can be performed comparing the representative value for each of the divided areas to a predetermined threshold value. In such a case, the image (the image of the measurement pattern) availability can be detected with good accuracy and good reproducibility.

In this description, the additional value, the dispersion, the standard deviation and the like of the pixel value to be used as the above representative value will be appropriately referred to as a ‘score’ or a “contrast index value”.

With the first optical properties measurement method in the present invention, the exposure condition can include at least one of a position of the object in an optical axis direction of the projection optical system and an energy amount of an energy beam irradiated on the object.

With the first optical properties measurement method in the present invention, on transferring the measurement pattern, the measurement pattern can be sequentially transferred onto the object while a position of the object in an optical axis direction of the projection optical system and an energy amount of an energy beam irradiated on the object are changed, respectively, on detecting the formed state of the image, image availability of the measurement pattern in the at least part of the plurality of divided areas on the object can be detected, and on obtaining the optical properties, the best focus position can be decided from a correlation between an energy amount of the energy beam and a position of the object in the optical axis direction of the projection optical system that corresponds to the plurality of divided areas where the image is detected.

In such a case, on transferring the measurement pattern, the image of the measurement pattern is sequentially transferred onto the plurality of areas on the object while changing the two exposure conditions, that is, the position of the object in the optical axis direction of the projection optical system and the energy amount of the energy beam irradiated on the object. As a consequence, the image of the measurement pattern whose position of the object in the optical axis direction of the projection optical system and the energy amount of the energy beam irradiated on the object are different is transferred in each area on the object.

Then, on detecting the formed state of the image, the image availability of the measurement pattern is detected in at least a part of the plurality of divided areas on the object, for example, for each position in the optical axis direction of the projection optical system. As a consequence, for each position in the optical axis direction of the projection optical system, the energy amount of the energy beam with which the image was detected can be obtained. Because the formed state of the image is detected by the method that uses image contrast or the light amount of reflected light such as diffracted light, the formed state of the image can be detected within a shorter period of time compared with the conventional size measurement method. In addition, because image contrast or the light amount of reflected light such as diffracted light, which are objective and quantitative, are used in the detection, the detection accuracy and the reproducibility of the detection results of the formed state can be improved when compared with the conventional method.

And, on obtaining the optical properties, an approximation curve that denotes the correlation between the energy amount of the energy beam with which the image has been detected and the position in the optical axis direction of the projection optical system can be obtained, and for example, from the local extremum of the approximation curve, the best focus position can be obtained.

According to a second aspect of the present invention, there is provided a second optical properties measurement method in which optical properties of a projection optical system that projects a pattern on a first surface onto a second surface is measured, the measurement method comprising: a first step in which a measurement pattern including a multibar pattern arranged on the first surface is sequentially transferred onto an object arranged on the second surface side of the projection optical system while at least one exposure condition is changed, and a predetermined area made up of a plurality of adjacent divided areas is formed where the multibar pattern transferred on each divided area and its adjacent pattern are spaced apart at a distance greater than distance L, which keeps contrast of an image of the multibar pattern from being affected by the adjacent pattern; a second step in which a formed state of an image in a plurality of divided areas that are at least part of the plurality of divided areas making up the predetermined area is detected; and a third step in which optical properties of the projection optical system are obtained, based on results of the detection.

The multibar pattern, in this case, refers to a pattern that has a plurality of bar patterns (line patterns) arranged at a predetermined interval. In addition, the pattern adjacent to the multibar pattern includes both the frame pattern that is located at the border of the divided area where the multibar pattern is formed, and the multibar pattern in the neighboring divided area.

In this method, the measurement pattern including the multibar pattern arranged on the first surface (the object plane) is sequentially transferred onto the object arranged on the second surface (image plane) side of the projection optical system while at least one exposure condition is changed, and the predetermined area made up of a plurality of adjacent divided areas is formed where the multibar pattern transferred on each divided area and its adjacent pattern are spaced apart at a distance greater than distance L, which keeps contrast of the image of the multibar pattern from being affected by the adjacent pattern (the first step).

Next, the formed state of the image in the plurality of divided areas that are at least part of the plurality of divided areas making up the predetermined area is detected (the second step).

Because the multibar pattern transferred onto each divided area and its adjacent pattern are arranged a distance L apart so that the contrast of the image of the multibar pattern will not be affected by the adjacent pattern, detection signals of the multibar patterns transferred onto each divided area that have a good S/N ratio can be obtained. In this case, because detection signals of the image of the multibar pattern having a good S/N ratio can be obtained, by performing binarization on, for example, the signal intensity of the detection signals, using a predetermined threshold value, the formed state of the image of the multibar pattern can be converted into binarization information (pattern availability information), and the formed state of the multibar pattern can be detected with good accuracy and good reproducibility in each divided area.

And, based on the detection results, the optical properties of the projection optical system are obtained (the third step). Accordingly, the optical properties can be measured with good accuracy and good reproducibility.

In addition, for similar reasons as in the first optical properties measurement method, the number of evaluation points can be increased, and the spacing in between the evaluation points can be narrowed, and as a result, the measurement accuracy of the optical properties measurement can be improved.

In this case, in the second step, the formed state of an image can be detected by an image processing method.

That is, based on the imaging signals, by an image processing method such as template matching or contrast detection, the formed state of the image of the multibar pattern formed in each divided area can be detected with good accuracy.

For example, in the case of template matching, objective and quantitative information on correlated values can be obtained for each divided area, and in the case of contrast detection, objective and quantitative information on contrast values can be obtained for each divided area. Therefore, in any case, by comparing the obtained information with the respective threshold values and converting the formed state of the image of the multibar pattern into binarization information (pattern availability information), the formed state of the multibar pattern in each divided area can be detected with good accuracy and good reproducibility.

In the second optical properties measurement method in the present invention, distance L only has to be a distance where the contrast of the image of the multibar pattern is not affected by its adjacent pattern. For example, when resolution of an imaging device that images each of the divided areas is expressed as R_{f}, contrast of the multipattern image is expressed as C_{f}, process factor determined by process is expressed as P_{f}, and detection wavelength of the imaging device is expressed as λ_{f}, then the distance L can be expressed as a function L=f(C_{f}, R_{f}, P_{f}, and λ_{f}). In this case, because the process factor affects the contrast of the image, the distance L can be set as a function L=f′(C_{f}, R_{f}, and λ_{f}) that does not include the process factor.

In the second optical properties measurement method in the present invention, the predetermined area can be a rectangular shape in general made up of a plurality of divided areas arranged in a matrix on the object.

In this case, in the second step, a rectangular outer frame made up of an outline of the outer periphery of the predetermined area can be detected based on imaging data corresponding to the predetermined area, and with the outer frame as datums, each position of a plurality of divided areas that make up the predetermined area can be calculated.

With the second optical properties measurement method in the present invention, in the first step, as a part of the exposure condition, an energy amount of an energy beam irradiated on the object can be changed so that a plurality of specific divided areas that are at least a part of a plurality of divided areas located on the outermost portion within the predetermined area becomes an overexposed area. In such a case, on the outer frame detection described above, the S/N ratio of the detection data (such as imaging data) of the frame section improves, which makes outer frame detection easier.

With the second optical properties measurement method in the present invention, in the second step, the formed state of an image in a plurality of divided areas that are at least part of the plurality of divided areas making up the predetermined area can be detected by a template matching method, based on imaging data corresponding to the plurality of divided areas making up the predetermined area.

With the second optical properties measurement method in the present invention, in the second step, the formed state of an image in a plurality of divided areas that are at least part of the plurality of divided areas making up the predetermined area can be detected with a representative value related to pixel data of each of the divided areas obtained by imaging serving as a judgment value.

In this case, the representative value can be at least one of an additional value, a differential sum, dispersion, and a standard deviation of the pixel data. Or, the representative value can be at least one of an additional value, a differential sum, dispersion, and a standard deviation of a pixel value within a designated range in each divided area.

As a matter of course, the designated range in each divided area and the area in which pixel data for calculating the representative value is extracted (such as the divided area) may have any shapes, such as a polygonal shape like a rectangle, a circle, an ellipse, or a triangle.

In the second optical properties measurement method in the present invention, the exposure condition can include at least one of a position of the object in an optical axis direction of the projection optical system and an energy amount of an energy beam irradiated on the object.

In the second optical properties measurement method in the present invention, on transferring the measurement pattern, the measurement pattern can be sequentially transferred onto the object while a position of the object in an optical axis direction of the projection optical system and an energy amount of an energy beam irradiated on the object are changed, respectively, on detecting the formed state of the image, image availability of the measurement pattern in the at least part of the plurality of divided areas on the object can be detected, and on obtaining the optical properties, the best focus position can be decided from a correlation between an energy amount of the energy beam and a position of the object in the optical axis direction of the projection optical system that corresponds to the plurality of divided areas where the image is detected.

In such a case, on transferring the measurement pattern, the image of the measurement pattern is sequentially transferred onto the plurality of areas on the object while changing the two exposure conditions, that is, the position of the object in the optical axis direction of the projection optical system and the energy amount of the energy beam irradiated on the object. As a consequence, the image of the measurement pattern whose position of the object in the optical axis direction of the projection optical system and the energy amount of the energy beam irradiated on the object are different is transferred in each area on the object.

Then, on detecting the formed state of the image, the image availability of the measurement pattern is detected in at least a part of the plurality of divided areas on the object, for example, for each position in the optical axis direction of the projection optical system. As a consequence, for each position in the optical axis direction of the projection optical system, the energy amount of the energy beam with which the image was detected can be obtained. Because the formed state of the image is detected by the method that uses the above objective and quantitative correlated values, or contrast, the formed state of the image can be detected within a shorter period of time compared with the conventional size measurement method. In addition, because imaging data, which are objective and quantitative, are used in the detection, the detection accuracy and the reproducibility of the detection results of the formed state can be improved when compared with the conventional method.

And, on obtaining the optical properties, an approximation curve that denotes the correlation between the energy amount of the energy beam with which the image has been detected and the position in the optical axis direction of the projection optical system can be obtained, and for example, from the local extremum of the approximation curve, the best focus position can be obtained.

According to a third aspect of the present invention, there is provided a third optical properties measurement method in which optical properties of a projection optical system that projects a pattern on a first surface onto a second surface is measured, the measurement method comprising: a first step in which a rectangular shaped predetermined area in general made up of a plurality of divided areas arranged in a matrix shape is formed on an object, by arranging a measurement pattern formed on a light transmitting section on the first surface and sequentially moving the object arranged on the second surface side of the projection optical system at a step pitch whose distance corresponds to the size equal to the light transmitting section and under, while at least one exposure condition is changed; a second step in which a formed state of an image in a plurality of divided areas that are at least part of the plurality of divided areas making up the predetermined area is detected; and a third step in which optical properties of the projection optical system are obtained, based on results of the detection.

In this case, the shape of the ‘light transmitting section’ does not matter, as long as the measurement pattern is arranged within.

With this method, by arranging the measurement pattern formed on the light transmitting section on the first surface and sequentially moving the object arranged on the second surface side of the projection optical system at a step pitch whose distance corresponds to the size equal to the light transmitting section and under, while at least one exposure condition is changed, the rectangular shaped predetermined area in general made up of a plurality of divided areas arranged in a matrix shape is formed on the object (the first step). As a result, on the object, a plurality of divided areas (areas where the image of the measurement pattern is projected) is formed, arranged in a plurality of matrices that do not have conventional frame lines in the border between the divided areas.

Next, the formed state of the image in the plurality of divided areas that are at least part of the plurality of divided areas making up the predetermined area is detected (the second step). In this case, because there are no frame lines in between adjacent divided areas, the contrast of the image of the measurement pattern is not degraded by the presence of frame lines in the plurality of divided areas that are subject to detection of the formed state of the image (mainly the divided areas where there are residual images of the measurement pattern).

Therefore, data of the patterned area and the non-patterned area that have a good S/N ratio can be obtained as the detection data for the plurality of divided areas, and by comparing the data with the good S/N ratio (such as data of light intensity) with a predetermined threshold value, the formed state of the image of the measurement pattern can be converted into binarization information (pattern availability information), and the formed state of the measurement pattern in each divided area can be detected with good accuracy and good reproducibility.

Then, the optical properties of the projection optical system are obtained (the third step), based on the detection results. Accordingly, the optical properties can be measured with good accuracy and good reproducibility.

In addition, for similar reasons described earlier, the number of evaluation points can be increased and the spacing in between the evaluation points can be narrowed, and as a result, the measurement accuracy of the optical properties measurement can be improved.

In this case, in the second step, the formed state of the image can be detected by an image processing method.

That is, by an image processing method such as template matching or contrast detection using the imaging data, the formed state of the image can be detected with good accuracy.

For example, in the case of template matching, objective and quantitative information on correlated values can be obtained for each divided area, and in the case of contrast detection, objective and quantitative information on contrast values can be obtained for each divided area. Therefore, in any case, by comparing the obtained information with the respective threshold values and converting the formed state of the image of the multibar pattern into binarization information (pattern availability information), the formed state of the measurement pattern in each divided area can be detected with good accuracy and good reproducibility.

In the third optical properties measurement method in the present invention, the step pitch can be set so that projection areas of the light transmitting section are one of being substantially in contact and being overlapped on the object.

In the third optical properties measurement method in the present invention, on the object, a photosensitive layer can be made of a positive type photoresist on its surface, the image can be formed on the object after going through a development process after the measurement pattern is transferred, and the step pitch can be set so that a photosensitive layer between adjacent images on the object is removed by the development process.

With the third optical properties measurement method in the present invention, in the first step, as a part of the exposure condition, an energy amount of an energy beam irradiated on the object can be changed so that a plurality of specific divided areas that are at least a part of a plurality of divided areas located on the outermost portion within the predetermined area becomes an overexposed area. In such a case, the S/N ratio on detecting the outer frame of the predetermined area improves.

In the third optical properties measurement method in the present invention, the second step can include: an outer frame detection step in which a rectangular outer frame made up of an outline of the outer periphery of the predetermined area is detected based on imaging data corresponding to the predetermined area; and a calculation step in which each position of a plurality of divided areas that make up the predetermined area is calculated with the outer frame as datums.

In this case, in the outer frame detection step, the outer frame detection can be performed based on at least eight points that are obtained, which are at least two point obtained on a first side to a fourth side that make up the rectangular outer frame that form an outline of the outer periphery of the predetermined area. In addition, in the calculation step, each position of the plurality of divided areas that make up the predetermined area can be calculated by using known arrangement information of a divided area and equally dividing an inner area of the outer frame that has been detected.

In the third optical properties measurement method in the present invention, the outer frame detection step can include: a rough position detecting step in which rough position detection is performed on at least one side of a first side to a fourth side that make up the rectangular outer frame that form an outline of the outer periphery of the predetermined area; and a detail position detecting step in which the position of the first side to the fourth side is detected using detection results of the rough position detection performed on at least one side calculated in the rough position detecting step.

In this case, in the rough position detecting step, border detection can be performed using information of a pixel column in a first direction that passes near an image center of the predetermined area, and a rough position of the first side and the second side that are respectively located on one end and the other end in the first direction of the predetermined area and extend in a second direction perpendicular to the first direction can be obtained, and in the detail position detecting step border detection can be performed, using a pixel column in the second direction that passes through a position a predetermined distance closer to the second side than the obtained rough position of the first side and also a pixel column in the second direction that passes through a position a predetermined distance closer to the first side than the obtained rough position of the second side, and the third side and the fourth side that are respectively located on one end and the other end in the second direction of the predetermined area extending in the first direction and two points each on both the third side and the fourth side can be obtained, border detection can be performed, using a pixel column in the first direction that passes through a position a predetermined distance closer to the fourth side than the obtained third side and also a pixel column in the first direction that passes through a position a predetermined distance closer to the third side than the obtained fourth side, and two points each on both the third side and the fourth side of the predetermined area can be obtained, four corners of the predetermined area, which is a rectangular shaped area, can be obtained as intersecting points of four straight lines that are determined based on two points each being located on the first side to the fourth side, and based on the four corners that are obtained, rectangle approximation can be performed by a least squares method to calculate the rectangular outer frame of the predetermined area including rotation.

In this case, on the border detection, a detection range of a border where error detection may easily occur can be narrowed down, using detection information of a border where error detection is difficult to occur. In such a case, especially, even when none of the plurality of divided areas located on the outermost periphery within the predetermined area is set as an overexposed area, the border detection previously described can be performed with good accuracy.

Or, on the border detection, intersecting points of a signal waveform formed based on pixel values of each of the pixel columns and a predetermined threshold value t can be obtained, and then a local maximal value and a local minimal value close to each intersecting point can be obtained, an average value of the local maximal value and the local minimal value that have been obtained can be expressed as a new threshold value t′, and a position where the signal waveform crosses the new threshold value t′ in between the local maximal value and the local minimal value can be obtained, which is determined as a border position.

In this case, as threshold value t, a value set in advance can be used, or the threshold value t can be set by obtaining the number of intersecting points of a threshold value and a signal waveform formed of pixel values of linear pixel columns extracted for the border detection while the threshold value is changed within a predetermined fluctuation range, deciding a threshold value to be a temporary threshold value when the number of intersecting points obtained matches a target number of intersecting points determined according to the measurement pattern, obtaining a threshold range that includes the temporary threshold value and the number of intersecting points matches the target number of intersecting points, and deciding the center of the threshold range center as the threshold value t.

In this case, the fluctuation range can be set based on an average and a standard deviation of the pixel values of linear pixel columns extracted for the border detection.

With the third optical properties measurement method in the present invention, in the second step, the formed state of an image in a plurality of divided areas that are at least part of the plurality of divided areas making up the first area can be detected by a template matching method, based on imaging data corresponding to the predetermined area.

Or, in the second step, the formed state of an image in a plurality of divided areas that are at least part of the plurality of divided areas making up the predetermined area can be detected with a representative value related to pixel data of each of the divided areas obtained by imaging serving as a judgment value.

In this case, the representative value can be at least one of an additional value, a differential sum, dispersion, and a standard deviation of the pixel data. Or, the representative value can be at least one of an additional value, a differential sum, dispersion, and a standard deviation of a pixel value within a designated range in each divided area. In the latter case, the designated range can be a reduced area where each of the divided areas is reduced at a reduction rate decided according to a designed positional relationship between an image of the measurement pattern and the divided area.

In the third optical properties measurement method in the present invention, the exposure condition can include at least one of a position of the object in an optical axis direction of the projection optical system and an energy amount of an energy beam irradiated on the object.

With the third optical properties measurement method in the present invention, in the first step, the measurement pattern can be sequentially transferred onto the object while a position of the object in an optical axis direction of the projection optical system and an energy amount of an energy beam irradiated on the object are changed, respectively, in the second step, image availability of the measurement pattern in the at least part of the plurality of divided areas on the object can be detected, and in the third step, the best focus position can be decided from a correlation between an energy amount of the energy beam and a position of the object in the optical axis direction of the projection optical system that corresponds to the plurality of divided areas where the image is detected.

According to a fourth aspect of the present invention, there is provided a fourth optical properties measurement method in which optical properties of a projection optical system that projects a pattern on a first surface onto a second surface is measured, the measurement method comprising: a first step in which a measurement pattern arranged on the first surface is sequentially transferred onto a plurality of areas on an object arranged on the second surface side of the projection optical system while at least one exposure condition is changed; a second step in which the measurement pattern transferred with different exposure conditions on the plurality of areas is imaged, imaging data for each area consisting of a plurality of pixel data is obtained, and a formed state of an image of the measurement pattern is detected in a plurality of areas that are at least part of the plurality of areas, using a representative value related to pixel data for each area; and a third step in which optical properties of the projection optical system are obtained, based on results of the detection.

With this method, the image of the measurement pattern is sequentially transferred onto the plurality of areas on the object, while at least one exposure condition is changed (the first step). As a result, in each area on the object, the image of the measurement pattern whose exposure condition on exposure is different is transferred.

Next, the plurality of areas on the object is imaged, the imaging data for each area consisting of a plurality of pixel data is obtained, and the formed state of the image of the measurement pattern is detected in the plurality of areas that are at least part of the plurality of areas, using the representative value related to pixel data for each area (the second step). In this case, the formed state of the image is detected using the representative value related to the pixel data of each divided area as the judgment value, that is, the formed state is detected depending on the amount of the representative value. And, because the formed state of the image is detected in this manner by an image processing method using the representative value related to the pixel data, the formed state of the image can be detected within a shorter period of time when compared with the conventional size measuring method (such as CD/focus method or SMP focus measurement method). In addition, because an objective and quantitative imaging data (pixel data) is used, the detection accuracy and the reproducibility of the formed state can be improved when compared with the conventional method.

Then, the optical properties of the projection optical system are obtained, based on the detection results of the formed state of the image (the third step). When the object is a photosensitive object, the detection of the formed state of the image of the measurement pattern may be performed on the latent image formed on the object without the object being developed, or the detection may be performed after the object on which the above image is formed is developed, on the resist image formed on the object or on the image (etched image) obtained going through the etching process of the object on which the resist image is formed. The photosensitive layer for detecting the formed state of the image on the object is not limited to a photoresist, as long as an image (a latent image or a manifest image) can be formed by an irradiation of light (energy). For example, the photosensitive layer may be an optical recording layer or a magenetooptic recording layer. Therefore, accordingly, the object on which the photosensitive layer is formed is not limited to a wafer, a glass plate, or the like, and it may be a plate or the like on which the optical recording layer, the magenetooptic recording layer, or the like can be formed.

For example, when the detection of the formed state of the image is performed on the resist image or the etched image, various types of alignment sensors can be used; microscopes such as an SEM as a matter of course, an alignment detection system of an exposure apparatus such as an alignment detection system based on an image processing method that forms the image of alignment marks on an imaging device like the alignment sensor of the so-called FIA (Field Image Alignment) system, an alignment sensor that irradiates a coherent detection light onto an object and detects the scattered light or diffracted light generated from the object like the alignment sensor of the LSA system, or an alignment sensor that performs detection by making two diffracted lights (for example, in the same order) generated from an object interfere with each other, or the like.

In addition, when detection of the formed state of the image is to be performed on a latent image, the FIA system or the like can be used.

In any case, since the optical properties are obtained based on detection results using the objective and quantitative imaging data, the optical properties can be measured with good accuracy and reproducibility when compared with the conventional measurement method.

In addition, for similar reasons described earlier, the number of evaluation points can be increased and the spacing in between the evaluation points can be narrowed, and as a result, the measurement accuracy of the optical properties measurement can be improved.

Accordingly, with the fourth optical properties measurement method, the optical properties of the projection optical system can be measured within a short period of time, with good accuracy and good reproducibility.

In this case, in the second step, the formed state of an image of the measurement pattern can be detected in a plurality of areas that are at least part of the plurality of areas by setting a representative value that is at least one of an additional value, a differential sum, a dispersion, and a standard deviation of all pixel data for each area, and comparing the representative value with a predetermined threshold value.

Or, in the second step, the formed state of an image of the measurement pattern can be detected in a plurality of areas that are at least part of the plurality of areas by setting a representative value that is at least one of an additional value, a differential sum, a dispersion, and a standard deviation of partial pixel data for each area, and comparing the representative value with a predetermined threshold value.

In this case, the partial pixel data can be pixel data within a designated range within the each area, and the representative value can be one of an additional value, a differential sum, a dispersion, and a standard deviation of the pixel data.

In this case, the designated range can be a partial area in the each area, which is determined according to an arrangement of the measurement pattern within the each area.

With the fourth optical properties measurement method in the present invention, in the second step, the formed state of an image of the measurement pattern can be detected for a plurality of different threshold values by comparing the threshold values with the representative value, and in the third step, the optical properties can be measured based on results of the detection obtained for each of the threshold values.

With the fourth optical properties measurement method in the present invention, the second step can include: a first detection step in which a first formed state of an image of the measurement pattern is detected by setting a representative value that is at least one of an additional value, a differential sum, a dispersion, and a standard deviation of all pixel data for each area in a plurality of areas that are at least part of the plurality of areas, and comparing the representative value with a predetermined threshold value; and a second detection step in which a second formed state of the image of the measurement pattern is detected by setting a representative value that is at least one of an additional value, a differential sum, a dispersion, and a standard deviation of partial pixel data for each area in a plurality of areas that are at least part of the plurality of areas, and comparing the representative value with a predetermined threshold value, and in the third step, optical properties of the projection optical system are obtained, based on results of detecting the first formed state and results of detecting the second formed state.

In this case, in the second step, the first formed state and the second formed state of an image of the measurement pattern can each be detected for a plurality of different threshold values, by comparing the threshold values and the representative value for each threshold value, and in the third step, optical properties of the projection optical system can be obtained, based on results of detecting the first formed state and results of detecting the second formed state obtained for each of the threshold values.

In the fourth optical properties measurement method in the present invention, the exposure condition can include at least one of a position of the object in an optical axis direction of the projection optical system and an energy amount of an energy beam irradiated on the object.

With the fourth optical properties measurement method in the present invention, in the first step, the measurement pattern can be sequentially transferred onto a plurality of areas on the object while a position of the object in an optical axis direction of the projection optical system and an energy amount of an energy beam irradiated on the object are changed, respectively, in the second step, the formed state of the image can be detected for each position in the optical axis direction of the projection optical system, and in the third step, the best focus position can be decided from a correlation between an energy amount of the energy beam with which the image was detected and a position of the object in the optical axis direction of the projection optical system.

According to a fifth aspect of the present invention, there is provided an exposure method in which an energy beam for exposure is irradiated on a mask, and a pattern formed on the mask is transferred onto an object via a projection optical system, the method comprising: an adjustment step in which the projection optical system is adjusted taking into consideration optical properties that are measured using one of the first to fourth optical properties measurement method; and a transferring step in which the pattern formed on the mask is transferred onto the object via the projection optical system that has been adjusted.

With this method, the projection optical system is adjusted so that the optimum transfer is performed, taking into consideration the optical properties of the projection optical system that have been measured by one of the first to fourth optical properties measurement method in the present invention, and because the pattern formed on the mask is transferred onto the object via the adjusted projection optical system, fine patterns can be transferred onto the object with high precision.

In addition, in a lithographic process, by using the exposure method in the present invention, fine patterns can be transferred onto the object with good precision, which allows microdevices with higher integration to be produced with good yield. Accordingly, further from another aspect of the present invention, it can also be said that there is provided a device manufacturing method that uses exposure methods described in the present invention.

### BRIEF DESCRIPTION OF THE DRAWINGS

In the accompanying drawings;

FIG. 1 is a schematic view of an exposure apparatus related to a first embodiment of the present invention;

FIG. 2 is a view for describing an example of a concrete arrangement of an illumination system IOP in FIG. 1;

FIG. 3 is a view of an example of a reticle used for measuring optical properties of a projection optical system in the first embodiment;

FIG. 4 is a flowchart (No. 1) that shows the processing algorithm in a CPU of a main controller on optical properties measurement in the first embodiment;

FIG. 5 is a flowchart (No. 2) that shows the processing algorithm in the CPU of the main controller on optical properties measurement in the first embodiment;

FIG. 6 is a view for describing an arrangement of a divided area that makes up a first area;

FIG. 7 is a view of a wafer W_{T} in a state where the first areas DCₙ are formed;

FIG. 8 is a view of a wafer W_{T} in a state where evaluation point corresponding areas DBₙ are formed;

FIG. 9 is a view of an example of a resist image formed on an evaluation point corresponding area DB₁ formed on wafer W_{T} when wafer W_{T} has been developed;

FIG. 10 is a flow chart (No. 1) showing the details of step 456 (calculation processing of optical properties) in FIG. 5;

FIG. 11 is a flow chart (No. 2) showing the details of step 456 (calculation processing of optical properties) in FIG. 5;

FIG. 12 is a flow chart showing the details of step 508 in FIG. 10;

FIG. 13 is a flow chart showing the details of step 702 in FIG. 12;

FIG. 14A is a view for describing the processing in step 508, FIG. 14B is a view for describing the processing in step 510, and FIG. 14C is a view for describing the processing in step 512;

FIG. 15A is a view for describing the processing in step 514, FIG. 15B is a view for describing the processing in step 516, and FIG. 15C is a view for describing the processing in step 518;

FIG. 16 is a view for describing border detection process in outer frame detection;

FIG. 17 is a view for describing corner detection in step 514;

FIG. 18 is a view for describing rectangle detection in step 516;

FIG. 19 is a view in a table data form of an example of results of detecting an image formed state in the first embodiment;

FIG. 20 is a view showing a relation between pattern residual number (exposure energy amount) and focus position;

FIGS. 21A to 21C are views for describing a modified example in the case differential data are used for border detection;

FIG. 22 is a view for describing a measurement pattern formed on a reticle used to measure optical properties of a projection optical system in a second embodiment in the present invention;

FIG. 23 is a flowchart that shows the processing algorithm in a CPU of a main controller on optical properties measurement in the second embodiment;

FIG. 24 is a flow chart showing the details of step 956 (calculation processing of optical properties) in FIG. 23;

FIG. 25 is view of an arrangement of divided areas that make up evaluation point corresponding areas on a wafer W_{T} in the second embodiment;

FIG. 26 is a view for describing imaging data area of each pattern in each divided area;

FIG. 27 is a view in a table data form of an example of results of detecting an image formed state of a first pattern CA1 in the second embodiment;

FIG. 28 is a view showing a relation between pattern residual number (exposure energy amount) and focus position, along with an approximation curve in a first stage;

FIG. 29 is a view showing a relation between exposure energy amount and focus position, along with an approximation curve in a second stage;

FIG. 30 is a view for describing imaging data area (sub-area) of each pattern in each divided area;

FIG. 31 is a view for describing a modified example in the second embodiment, showing a relation between exposure energy amount and focus position at a plurality of threshold values;

FIG. 32 is a view for describing a different modified example in the second embodiment, showing a relation between threshold values and focus position;

FIG. 33 is a view for describing another modified example in the second embodiment, showing an example of a figure (including spurious resolution) that contains a plurality of mountain shapes;

FIG. 34 is a flow chart for explaining an embodiment of a device manufacturing method according to the present invention; and

FIG. 35 is a flow chart of an example of a processing performed in step 304 in FIG. 34.

### DETAILED DESCRIPTION OF THE PREFERRED EMBODIMENTS

First Embodiment

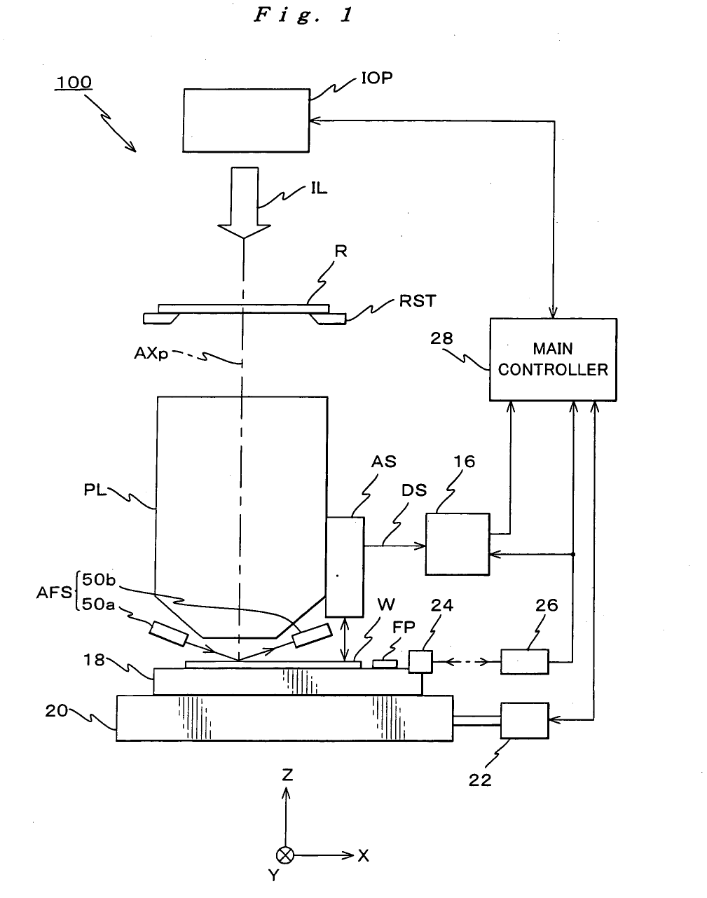

A first embodiment of the present invention is described below, referring to FIGS. 1 to 20.

FIG. 1 shows a schematic configuration of an exposure apparatus 100 related to the first embodiment suitable for carrying out an optical properties measurement method and exposure method related to the present invention. Exposure apparatus 100 is a reduction projection exposure apparatus (the so-called stepper) based on a step-and-repeat method.

Exposure apparatus 100 comprises: an illumination system IOP; a reticle stage RST that holds a reticle R serving as a mask; a projection optical system PL that projects an image of a pattern formed on reticle R on a wafer W serving as an object on which a photosensitive agent (photoresist) is coated; an XY stage 20 that holds wafer W and moves within a two dimensional plane (within an XY plane); a drive system 22 that drives XY stage 20; a control system for such parts; and the like. The control system is mainly structured of a main controller 28, which is made up of a microcomputer (or a workstation) or the like that has an overall control over the entire apparatus.

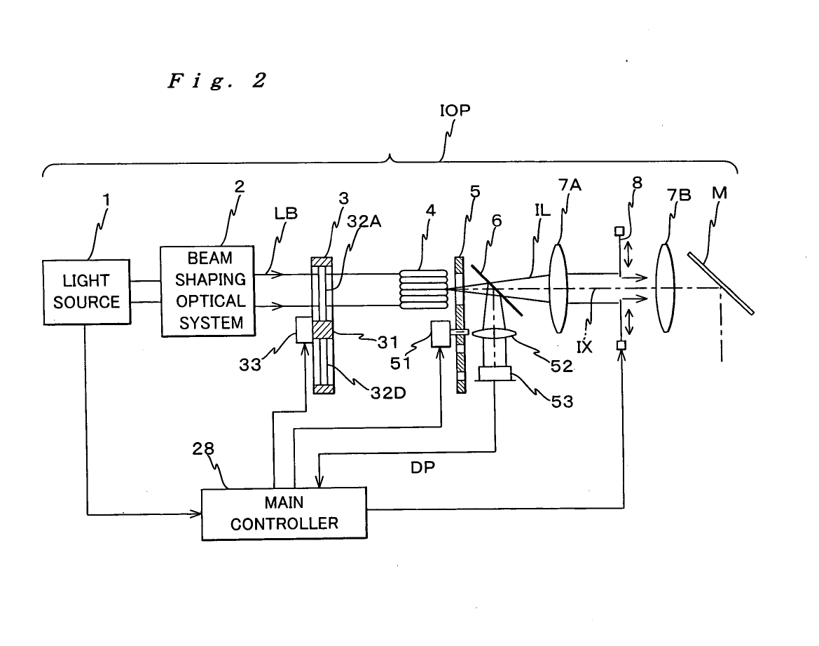

As is shown in FIG. 2, illumination system IOP comprises: a light source 1; a beam shaping optical system 2; energy rough adjuster 3; an optical integrator (homogenizer) 4; an illumination system aperture stop plate 5; a beam splitter 6; a first relay lens 7A; a second relay lens 7B; reticle blind 8, and the like. As the optical integrator, a fly-eye lens, a rod type (internal reflection type) integrator, or a diffractive optical element can be used. In the embodiment, a fly-eye lens is used as optical integrator 4; therefore, it will hereinafter also be referred to as fly-eye lens 4.

Each section of illumination system IOP referred to above will now be described. As light source 1, a KrF excimer laser (oscillation wavelength: 248 nm), an ArF excimer laser (oscillation wavelength: 193 nm), or the like is used. In actual, light source 1 is arranged on a floor surface of a clean room where the main body of the exposure apparatus is arranged, or in a different room that has a lower degree of cleanliness (a service room), or the like, and it connects to the incident end of the beam shaping optical system via a light guiding optical system (not shown).

Beam shaping optical system 2 shapes the sectional shape of laser beam LB emitted from light source 1 so that it effectively enters fly-eye lens 4 arranged on the rear of the optical path of laser beam LB. Beam shaping optical system 2 is made up of, for example, a cylinder lens or a beam expander (both omitted in Figs.) or the like.

Energy rough adjuster 3 is disposed on the optical path of laser beam LB behind beam shaping optical system 2, and in this case, a plurality of (for example, six) ND filters (only two ND filters 32A and 32D are shown in FIG. 2) whose transmittance (=1−attenuation ratio) is different is arranged on the periphery of a rotating plate 31. A drive motor 33 rotates rotating plate 31, so that the transmittance to laser beam LB entering energy rough adjuster 3 can be switched in geometric series in a plurality of steps from a hundred percent. Drive motor 33 operates under the control of main controller 28.

Fly-eye lens 4 is disposed on the optical path of laser beam LB in the rear of energy rough adjuster 3, and it forms a plane light source, that is, a secondary light source, made up of many point light sources (light source images) on the focal plane on the outgoing side in order to illuminate reticle R with a uniform illuminance distribution. The laser beam outgoing from the secondary light source will hereinafter be referred to as ‘pulse illumination light IL’.

In the vicinity of the focal plane on the outgoing side of fly-eye lens 4, illumination system aperture stop plate 5 is disposed. And, on illumination system aperture stop plate 5, at a substantially equal angle, for example, an aperture stop made of a normal circular opening, an aperture stop (a small σ stop) for making coherence factor σ small which is made by a small, circular opening, a ring-like aperture stop (annular stop) for a ring-shaped illumination, and a modified aperture stop for modified illumination made of a plurality of openings disposed in an eccentric arrangement, and the like are arranged (only two types of aperture stops are shown in FIG. 2). A drive unit 51 such as a motor operating under the control of main controller 28 rotates illumination system aperture stop plate 5, and one of the aperture stops is selectively set on the optical path of pulse illumination light IL. Instead of, or in combination with illumination system aperture stop plate 5, for example, an optical unit comprising at least one of a plurality of diffractive optical elements, a movable prism (conical prism, polyhedron prism, etc.) which moves along the optical axis of the illumination optical system, and a zoom optical system is preferably arranged in between light source 1 and optical integrator 4, so as to suppress the light amount distribution (the size and shape of the secondary light source) of illumination light IL on the pupil plane of the illumination optical system, or in other words, to suppress the light amount loss that occurs when the illumination condition of reticle R changes.

On the optical path of pulse illumination light IL after illumination system aperture stop plate 5, beam splitter 6 that has small reflectivity and large transmittance is disposed, and further down the optical path, a relay optical system made up of the first relay lens 7A and the second relay lens 7B is disposed, with reticle blind 8 arranged in between.

Reticle blind 8, which is arranged on a plane conjugate with respect to the pattern surface of reticle R, is made up of, for example, two L-shaped movable blades, or four movable blades arranged both horizontally and vertically, and the opening made with the enclosing movable blades sets the illumination area on reticle R. In this case, by adjusting the position of each of the movable blades, the shape of the opening can be set to an optional rectangular shape. The movable blades are each driven under the control of main controller 28 via a blind drive unit (not shown), according to the shape of the pattern area of reticle R.

On the optical path of pulse illumination light IL in the rear of the second relay lens 7B making up the relay optical system, a deflection mirror M is disposed that bends pulse illumination light IL having passed through the second relay lens 7B toward reticle R.

Meanwhile, on the optical path of the light reflected off beam splitter 6, an integrator senor 53 made up of a photoelectric conversion element is disposed via a condenser lens 52. As integrator sensor 53, a pin type photodiode or the like that has sensitivity to the far ultraviolet region and a high response frequency to detect the pulse emission of light source unit 1 can be used. The correlation coefficient (or the correlation function) of the output DP of integrator sensor 53 and the illuminance (intensity) of pulse illumination light IL on the surface of wafer W is obtained in advance, and is stored in the storage device within main controller 28.

The operation of illumination system IOP that has the structure descried above will now be briefly described. The pulsed laser beam LB emitted from light source 1 enters beam shaping optical system 2 where its sectional shape is formed so that it may efficiently enter fly-eye lens 4 arranged further downstream, and then it enters energy rough adjuster 3. Then, laser beam LB that has passed through one of the ND filters of energy rough adjuster 3 enters fly-eye lens 4, forms a plane light source, that is, a secondary light source, made up of many point light sources (light source images) on the focal plane on the outgoing side of fly-eye lens 4. Pulse illumination light IL outgoing from the secondary light source then passes through one of the aperture stops of illumination system aperture stop plate 5 and reaches beam splitter 6 that has large transmittance and small reflectivity. Pulse illumination light IL that has passed through beam splitter 6 also serving as the exposure light then proceeds to the first relay lens 7A and then passes through the rectangular opening of reticle blind 8, and then it is bent vertically downward by mirror M after passing through the second relay lens 7B, so that it illuminates the illumination area that has a rectangular shape (such as a square) on reticle R held on reticle stage RST, with uniform illuminance distribution.

Meanwhile, pulse illumination light IL reflected off beam splitter 6 is received by integrator sensor 53 made up of such photoelectric conversion element via condenser lens 52, and photoelectric conversion signals of integrator sensor 53 are supplied to main controller 28 as output DP (digit/pulse) via a peakhold circuit and an A/D converter (not shown).

Returning to FIG. 1, reticle stage RST is disposed below illumination system IOP in FIG. 1. On reticle stage RST, reticle R is held by suction via vacuum chucking or the like. Reticle stage RST is structured finely movable in an X-axis direction (the lateral direction of the page surface of FIG. 1), a Y-axis direction (the perpendicular direction of the page surface of FIG. 1), and a θz direction (the rotational direction around a Z-axis perpendicular to the XY plane) by a drive system (not shown). This allows reticle stage RST to perform position setting (reticle alignment) of reticle R in a state where the pattern center of reticle R (reticle center) substantially coincides with an optical axis AXp of projection optical system PL. FIG. 1 shows the state where this reticle alignment has been performed.

Projection optical system PL is disposed below reticle stage RST in FIG. 1, so that the direction of its optical axis AXp matches the Z-axis direction perpendicular to the XY plane. As projection optical system PL, a dioptric system is used, which is a double telecentric reduction system and is made up of a plurality of lens elements sharing optical axis AXp in the Z-axis direction (not shown). Among the lens elements, a specific number of lens elements operate under the control of an image forming characteristics correction controller based on instructions from main controller 28, so that the optical properties of projection optical system PL (including image forming characteristics) such as magnification, distortion, coma aberration, and curvature of field can be adjusted.

The projection magnification of projection optical system PL is, for example, ⅕ (or ¼). Therefore, when reticle R is illuminated by pulse illumination light IL with uniform illuminance in a state where alignment between the pattern of reticle R and the area subject to exposure on wafer W has been performed, the pattern of reticle R is reduced by projection optical system PL and projected on wafer W which is coated with a photoresist, and a reduced image of the pattern is formed on the area on wafer W subject to exposure.

XY stage 20 is actually made up of a Y stage that moves on a base (not shown) in the Y-axis direction, and an X stage on the Y stage that moves in the X-axis direction. In FIG. 1, however, these are representatively shown as XY stage 20. A wafer table 18 is mounted on XY stage 20, and on this wafer table 18, wafer W is held via a wafer holder (not shown) by vacuum chucking or the like.

Wafer table 18 finely drives the wafer holder that holds wafer W in the Z-axis direction and in the direction of inclination against the XY plane, and is also called the Z-tilt stage. On the upper surface of wafer table 18, a movable mirror 24 is provided, on which the laser beam of a laser interferometer 26 is projected to measure the position of wafer table 18 within the XY plane by receiving the reflection beam. Laser beam interferometer 26 is provided, facing the reflection surface of movable mirror 24. In actual, as the movable mirror, an X movable mirror that has a reflection surface perpendicular to the X-axis and a Y movable mirror that has a reflection surface perpendicular to the Y-axis are provided, and corresponding to these mirrors, an X laser interferometer for measuring the X direction position and a Y laser interferometer for measuring the Y direction position are provided as the laser interferometer, however, in FIG. 1, these are representatively shown as movable mirror 24 and laser beam interferometer 26. In addition, instead of movable mirror 24, the end surface of wafer table 18 may be polished as a reflection surface. X laser interferometer and Y laser interferometer are a multiple-axis interferometer that has a plurality of length measurement axes, and other than the X, Y positions of wafer table 18, rotation (yawing (θz rotation, which is the rotation around the Z-axis), pitching (θx rotation, which is the rotation around the X-axis), and rolling (θy rotation, which is the rotation around the Y-axis)) can also be measured. Accordingly, in the following description, the position of wafer table 18 is to be measured in directions of five degrees of freedom with laser interferometer 26; that is, in X, Y, θz, θy, and θx directions.

The measurement values of laser interferometer 26 is supplied to main controller 28, and main controller 28 performs position setting of wafer table 18 by controlling XY stage 20 via drive system 22, based on the measurement values of laser interferometer 26.

In addition, the position of the surface of wafer W in the Z-axis direction and the amount of inclination are measured with a focus sensor AFS, which consists of a multiple point focal position detection system (focus sensor) based on an oblique incident method that has a light sending system 50a and a light receiving system 50b, as is disclosed in, for example, Japanese Patent Application Laid-open No. H05-190423 and the corresponding U.S. Pat. No. 5,502,311 or the like. The measurement values of focus sensor AFS are also supplied to main controller 28, and based on the measurement values of focus sensor AFS, main controller 28 drives wafer table 18 in the Z direction, θx direction, and θy direction via drive system 22, so as to control the position of wafer W in the optical axis direction of projection optical system PL and its inclination. As long as the national laws in designated states or elected states, to which this international application is applied, permit, the disclosures of the above publication and U.S. Patent are fully incorporated herein by reference.

The position in five degrees of freedom (X, Y, Z, θx, and θy) and attitude control of wafer W is performed in the manner described above, via wafer table 18. The error of the remaining Oz (yawing) is corrected by rotating at least either reticle stage RST or wafer table 18, based on yawing information of wafer table 18 measured by laser interferometer 26.

In addition, on wafer table 18, a fiducial plate FP is fixed whose surface is arranged at the same height as the surface of wafer W. On the surface of this fiducial plate FP, various types of reference marks are formed, including the reference marks used for the so-called baseline measurement of the alignment detection system or the like, which will be referred to later in the description.

Furthermore, in the embodiment, on the side surface of projection optical system PL, an alignment detection system AS is provided, which is based on an off-axis method and serves as a mark detection system for detecting the alignment marks formed on wafer W. Alignment detection system AS has alignment sensors that are called an LSA (Laser Step Alignment) system and an FIA (Field Image Alignment) system, and it is capable of measuring the X and Y two dimensional positions of the reference marks on fiducial plate FP and the alignment marks on the wafer.

The LSA system is the most versatile sensor for measuring a mark position by irradiating a laser beam on a mark and measuring the mark position using the diffracted and scattered light, and is conventionally used widely in process wafers. The FIA system is an image forming type alignment sensor for measuring a mark position based on an image processing method, which is effectively used when measuring asymmetric marks on an aluminum layer or the surface of the wafer. With this system, a broadband light such as a halogen lamp illuminates a mark, and by processing the mark image the position of the mark is measured.

In the embodiment, these alignment sensors are appropriately used depending on the purpose, and fine alignment or the like is performed for an accurate position measurement of each area subject to exposure on the wafer. Besides such sensors, as alignment detection system AS, for example, an alignment sensor that irradiates a coherent detection beam on an object mark and detects the two diffraction rays (for example, the same order) generated from the mark that are made to interfere can be used by itself, or in appropriate combination with the above FIA system or LSA system.

An alignment controller 16 performs A/D conversion on information DS from each of the alignment sensors that structure alignment detection system AS, and processes the digitalized waveform signals to detect the mark position. The results of the detection are supplied to main controller 28 from alignment controller 16.

Furthermore, with exposure apparatus 100 in the embodiment, although it is omitted in the drawings, a pair of reticle alignment microscopes such as the ones disclosed in, for example, Japanese Patent Application Laid-open No. H07-176468, and its corresponding U.S. Pat. No. 5,646,413, is provided above reticle R. The pair of reticle alignment microscopes is made up of a TTR (Through The Reticle) alignment system that uses light having the exposure wavelength to simultaneously observe reticle marks on reticle R or reference marks on reticle stage RST (both of which are not shown) and marks on fiducial plate FP via projection optical system PL. The detection signals of these reticle alignment microscopes are supplied to main controller 28 via alignment controller 16. As long as the national laws in designated states or elected states, to which this international application is applied, permit, the disclosures of the above publication and U.S. Patent are fully incorporated herein by reference.

Next, an example of a reticle used to measure the optical properties of the projection optical system related to the present invention will be described.

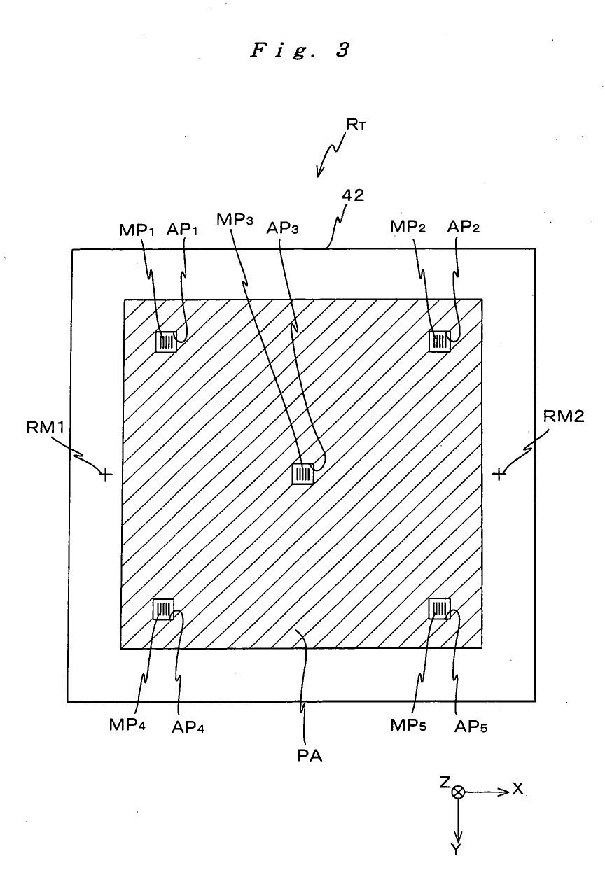

FIG. 3 shows an example of a reticle RT used to measure the optical properties of projection optical system PL. It is a planar view of reticle R_{T} from the pattern surface side (from the lower surface side in FIG. 1). As is shown in FIG. 3, on reticle RT a pattern area PA made up of a shielding member such as chromium is formed in the center of a glass substrate 42 serving as a mask substrate that is substantially square. In a total of five places, which are the center of pattern area PA (which coincides with the center of reticle R_{T} (reticle center)) and the four corners, for example, five 20 μm square aperture patterns (transmitting areas) AP₁ to AP₅ are formed, and in each center of the aperture pattern, a measurement pattern made up of a line-and-space pattern is formed (measurement patterns MP₁ to MP₅) As an example, measurement pattern MPₙ (n=1 to 5) each has a periodic direction in the X-axis direction, and five line patterns (light shielding sections) that have a line width around 1.3 μm and a length around 12 μm are arranged in a multibar pattern at a pitch around 2.6 μm. Therefore, in this embodiment, each of the measurement patterns MPₙ that have the same center as aperture patterns APₙ are arranged in an area reduced by around 60% in aperture patterns APₙ, respectively.

In the embodiment, each measurement pattern is made up of a bar pattern (line pattern) that narrowly extends in the Y-axis direction, however, this bar pattern only has to have a different size in the X-axis and the Y-axis directions.

In addition, on both ends of the X-axis direction that passes through the reticle center in pattern area PA, a pair of reticle alignment marks RM1 and RM2 is formed.

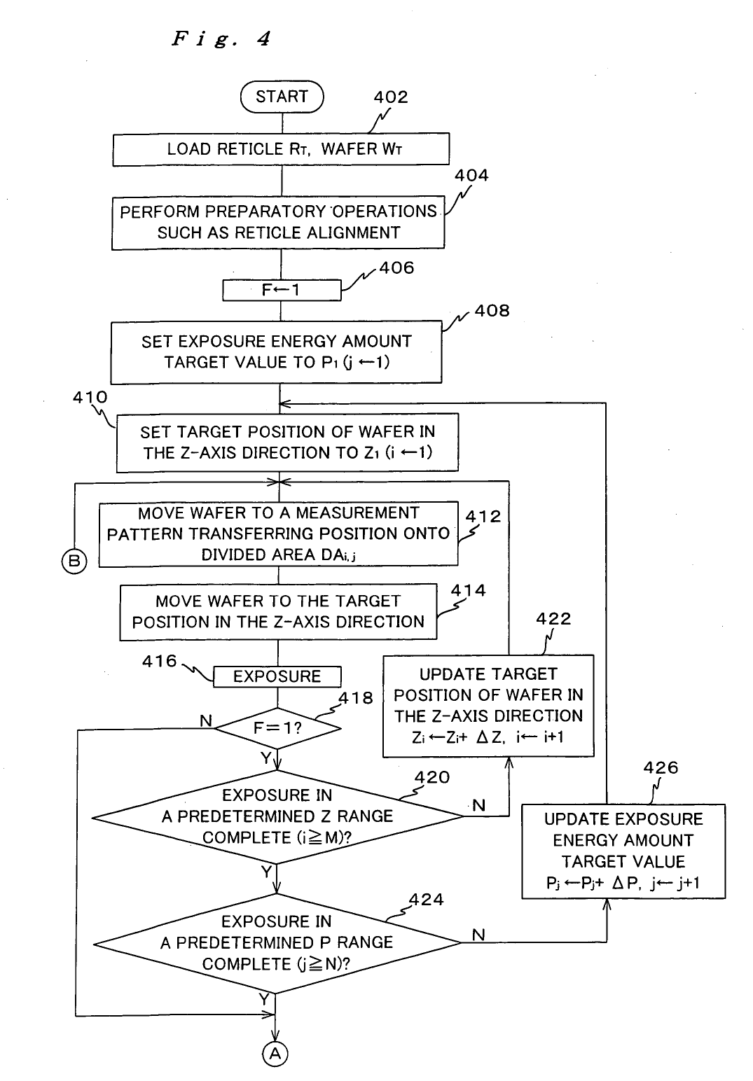

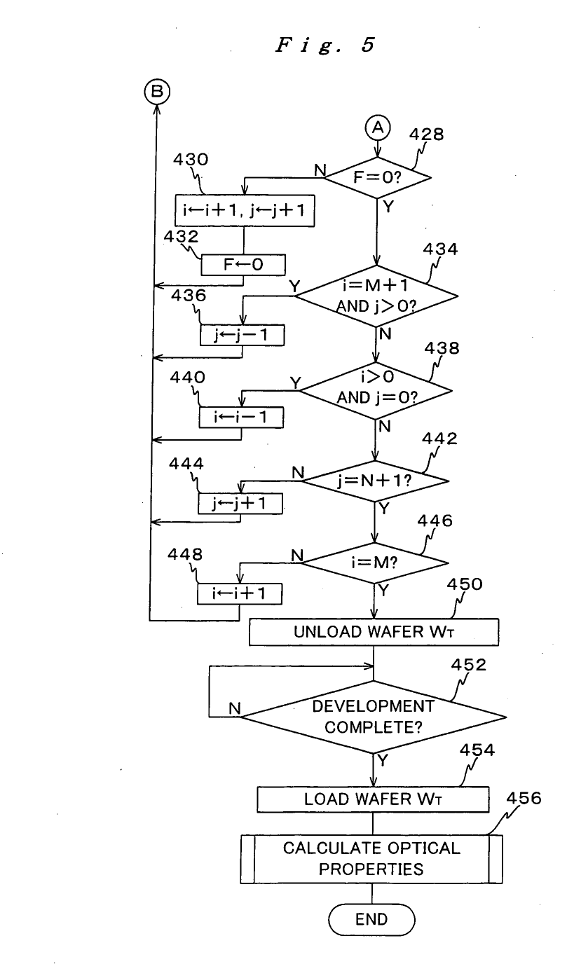

Next, the measurement method of the optical properties of projection optical system PL in exposure apparatus 100 of the embodiment will be described according to FIG. 4, which shows a simplified processing algorithm of the CPU in main controller 28, and to FIG. 5, which is a flow chart, referring to other drawings as appropriate.

First of all, in step 402 in FIG. 4, reticle R_{T} is loaded on reticle stage RST via a reticle loader (not shown), and wafer W_{T} is also loaded on wafer table 18 via a wafer loader (not shown). On the surface of wafer W_{T}, a photosensitive layer is to be formed with a positive type photoresist.

In the next step, step 404, predetermined preparatory operations such as reticle alignment, setting the reticle blind, and the like are performed. To be more specific, first, XY stage 20 is moved via drive system 22 so that the midpoint of the pair of reference marks (not shown) formed on the surface of fiducial plate FP provided on wafer table 18 substantially coincides with the optical axis of projection optical system PL, while the measurement results of laser interferometer 26 are being monitored. Next, the position of reticle stage RST is adjusted so that the center of reticle RT (reticle center) substantially coincides with the optical axis of projection optical system PL. In this case, for example, the relative position between reticle alignment marks RM1, RM2, and their corresponding reference marks is to be detected with the reticle alignment microscopes described earlier (not shown) via projection optical system PL. And, based on the detection results of the relative position detected by the reticle alignment microscopes, the position of reticle stage RST within the XY plane is adjusted via the drive system (not shown) so that the relative positional error is minimal between both reticle alignment marks RM1, RM2 and their corresponding reference marks. With this operation, the center of reticle R_{T} (reticle center) is made to substantially coincide with the optical axis of projection optical system PL accurately, and the rotation angle of reticle R_{T} is also made to accurately coincide with the coordinate axes of an orthogonal coordinate system set by the length measurement axes of laser interferometer 26. That is, reticle alignment is completed.

In addition, the size and the position of the opening of reticle blind 8 within illumination system IOP is adjusted, so that the irradiation area of illumination light IL substantially coincides with pattern area PA on reticle R_{T}.

The predetermined preparatory operations are completed in the manner described above, and then the step moves on to step 406 where a flag F is set (F←1) for judging whether exposure in the first area has been completed, which is to be described later in the description.

In the next step, step 408, the target value of an exposure energy amount (corresponds to the integrated energy amount of illumination light IL irradiated on wafer W_{T}, and is also referred to as the exposure dose amount) is initialized. That is, a counter j is initialized to ‘1’, and a target value Pⱼ of the exposure energy amount is set to P₁ (j→1). In the embodiment, the exposure energy amount varies from P₁ to P_{N} (for example, N=23) by a scale of ΔP (Pⱼ=P₁ to P₂₃), centering, for example, on an optimal exposure energy amount (predicted value) determined from sensitivity characteristics of the photoresist.

In the next step, step 410, the target value of the focus position of wafer W_{T} (the position in the Z-axis direction) is initialized. That is, a counter i is initialized to ‘1’, and a target value Zᵢ of the focus position of wafer W_{T} is set to Z₁ (i←1). In the embodiment, counter i is used for setting the target value of the focus position of wafer W_{T} and also for setting the movement target position of wafer W_{T} on actual exposure in the column direction. And, in the embodiment, the focus position of wafer W_{T} varies from Z₁ to Z_{M} (for example, M=13) by a scale of ΔZ (Zᵢ=Z₁ to Z₁₃), centering, for example, on an optimal focus position (such as the designed value) related to projection optical system PL.

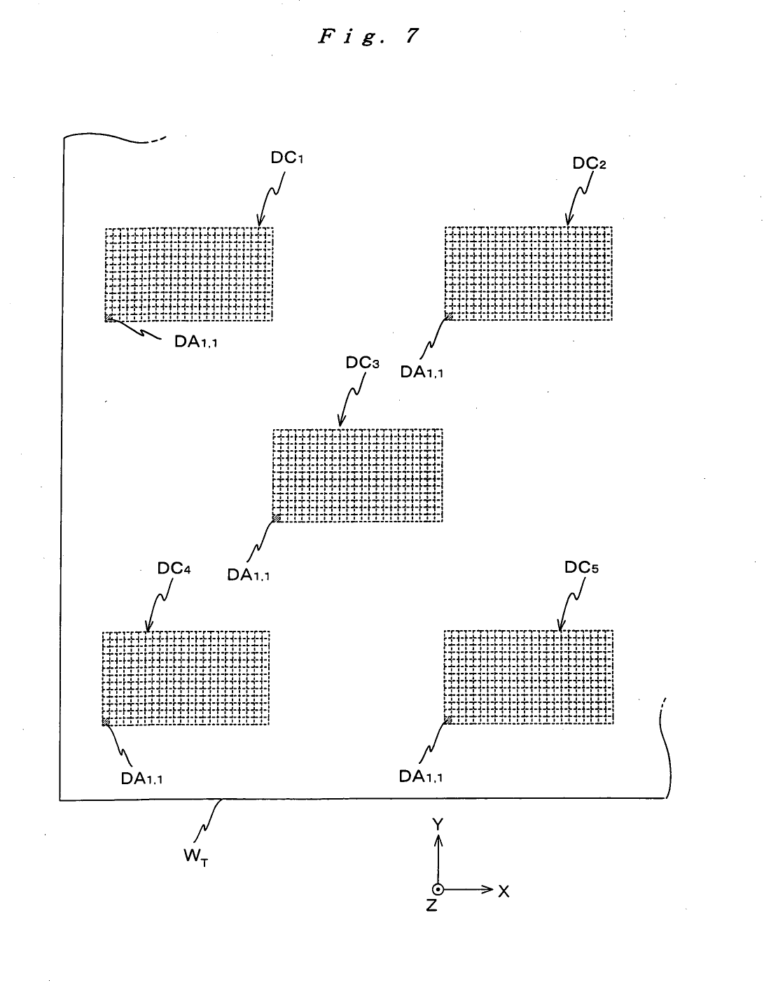

Accordingly, in the embodiment, exposure is performed N×M times (for example, 23×13=299), so that the measurement pattern MPₙ (n=1 to 5) is sequentially transferred onto wafer W_{T} while respectively changing the position of wafer W_{T} in the optical axis direction of projection optical system PL and the energy amount of pulse illumination light IL irradiated on wafer W_{T}. On a first area DC₁ to DC₅ (refer to FIGS. 7 and 8) (to be described later) within an area DB₁ to DB₅ on wafer W_{T} corresponding to each of the evaluation points within the field of projection optical system PL (hereinafter referred to as ‘evaluation point corresponding area’), N×M measurement patterns MPₙ are to be transferred.

The reason for specifying the first area DC₁ within evaluation point corresponding area DBₙ (n=1 to 5), is because in this embodiment, each evaluation point corresponding area DBₙ will be consisting of the first area DCₙ where the above N×M measurement patterns MPₙ are transferred and a rectangular frame shaped second area DDn that encloses the first area (refer to FIG. 8).

Evaluation point corresponding area DBₙ (that is, the first area DCₙ) corresponds to a plurality of evaluation points within the field of projection optical system PL where the optical properties are to be detected.

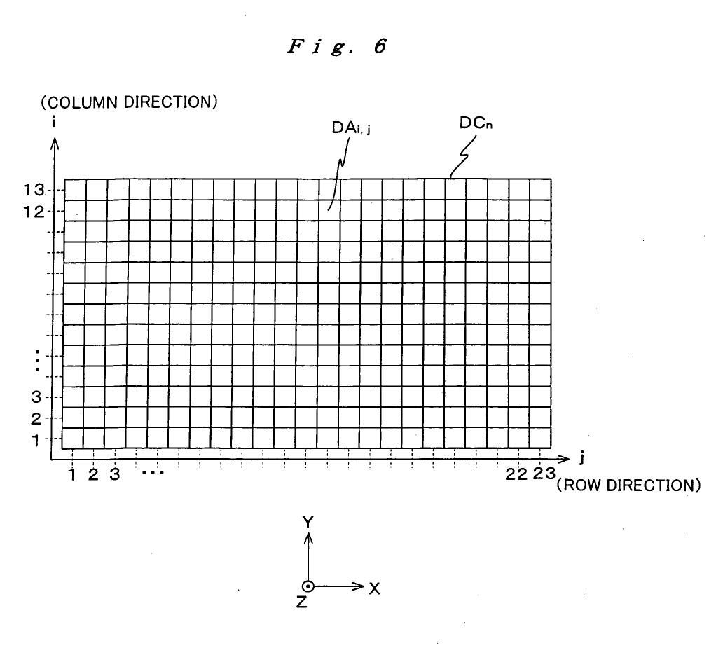

Although the description may fall out of sequence, for the sake of convenience, each of the above first areas DCₙ of wafer W_{T} on which measurement pattern MPₙ is transferred by the exposure operation (to be described later) will now be described, referring to FIG. 6. As is shown in FIG. 6, in the embodiment, measurement pattern MPₙ is transferred onto each of the M×N (=23×13=299) virtual divided areas DA_{i, j} (i=1 to M, j=1 to N) arranged in a matrix of M rows and N columns (13 rows and 23 columns), and the first area DCₙ composed of M×N divided areas DA_{i, j} on which these measurement patterns MPₙ have been transferred is formed on wafer W_{T}. As is shown in FIG. 6, virtual divided areas DA_{i, j} are arranged so that the +X direction is the row direction (the increasing direction of j) and the +Y direction is the column direction (the increasing direction of i). In addition, the subscripts i and j, and M and N used in the description below is to have the same meaning as the description above.

Referring back to FIG. 4, in the next step, step 412, XY stage 20 (wafer W_{T}) is moved to a position where the image of measurement pattern MPₙ is to be transferred; to virtual divided area DA_{i, j} in each of the evaluation point corresponding areas DBₙ (in this case, DA_{1, 1} (refer to FIG. 7) on wafer W_{T}, via drive system 22 while the measurement values of laser interferometer 26 is being monitored.

In the next step, step 414, wafer table 18 is finely driven in the Z-axis direction and the direction of inclination, so that the focus position of wafer W_{T} coincides with target value Zᵢ that is set (in this case, Z₁), while the measurement values from focus sensor AFS is being monitored.

In the next step, step 416, exposure is performed. On exposure, exposure amount control is performed so that the exposure energy amount (exposure amount) at one point on wafer W_{T} matches the target value that has been set (in this case, P₁). The exposure energy amount can be adjusted by changing at least either the pulse energy amount of illumination light IL or the number of pulses of illumination light IL irradiated on the wafer during exposure of each divided area, therefore, as the control method, for example the next first to third methods can be employed independently, or in combination.

That is, as a first method, the repetition frequency of the pulse is maintained at a constant level while the transmittance of laser beam LB is changed using energy rough adjuster 3, so as to adjust the energy amount of illumination light IL given to the image plane (wafer surface). As a second method, the repetition frequency of the pulse is maintained at a constant level while the energy per pulse of laser beam LB is changed by instructions given to light source 1, so as to adjust the energy amount of illumination light IL given to the image plane (wafer surface). And, as a third method, the transmittance and the energy per pulse of laser beam LB are maintained at a constant level while the repetition frequency of the pulse is changed, so as to adjust the energy amount of illumination light IL given to the image plane (wafer surface).

In this manner, the images of measurement pattern MPₙ are transferred onto divided area DA_{1, 1} of each of the above first divided area DCₙ on wafer W_{T}, as is shown in FIG. 7.

Referring back to FIG. 4, when exposure in the above step 416 is completed, the judgment is made in step 418 whether flag F is set up, that is, if F=1 or not. In this case, because flag F was set in step 406, the decision in this step is positive, therefore, the step then proceeds to the next step, step 420.

In step 420, the judgment is made whether exposure in a predetermined Z range has been completed by judging whether the target value of the focus position of wafer W_{T} is Z_{M} or over. In this case, because exposure has only been completed at only the first target value Z₁, the step then moves onto step 422 where counter i is incremented by 1 (i→i+1) and ΔZ is added to the target value of the focus position of wafer W_{T} (Zi→Z+ΔZ). In this case, the target value of the focus position is changed to Z₂ (=Z₁+ΔZ), and then the step returns to step 412. In step 412, XY stage 20 is moved a predetermined step pitch SP in a predetermined direction (in this case, the −Y direction) within the XY plane, so that the position of wafer W_{T} is set at divided area DA_{2,1} of each of the first areas DCₙ on wafer W_{T} where the image of measurement patterns MPₙ are each transferred. In the embodiment, the above step pitch SP is set around 5 μm so that it substantially matches the size of the projected image of each aperture pattern APₙ on wafer W_{T}. Step pitch SP is not limited to around 5 μm, however, it is preferable to keep it under 5 μm, that is, the size of the projected image of each aperture pattern APₙ on wafer W_{T}. The reasons for this will be described later in the description.

In the next step, step 414, wafer table 18 is stepped by ΔZ in the direction of optical axis AXp so that the focus position of wafer W_{T} coincides with target value (in this case, Z₂), and in step 416, exposure is performed as is previously described, and the image of measurement patterns MPₙ are each transferred onto divided area DA_{2, 1} of each of the first areas DCₙ on wafer W_{T}.

Hereinafter, until the judgment in step 420 turns out positive, that is, until the target value of the focus position of wafer W_{T} set at this point reaches Z_{M}, the loop processing of steps 418→420→422→412→414→416 (including decision making) is repeatedly performed. With this operation, measurement patterns MPₙ are transferred respectively onto divided area DA_{i, 1} (i=3 to M) of each of the first areas DCₙ on wafer W_{T}.

Meanwhile, when exposure of divided area DA_{M, 1} is completed, and the judgment in step 420 above turns out positive, the step then moves to step 424 where the judgment is made whether the target value of the exposure energy amount set at that point is P_{N} or over. In this case, because the target value of the exposure energy amount set at that stage is P₁, the decision making in step 424 turns out negative, therefore, the step moves to step 426.

In step 426, counter j is incremented by 1 (j←j+1) and ΔP is added to the target value of the exposure energy amount (Pⱼ←Pⱼ+ΔP). In this case, the target value of the exposure energy amount is changed to P₂ (=P₁+ΔP), and then the step returns to step 410.

Then, in step 410, when the target value of the focus position of wafer W_{T} has been initialized, the loop processing of steps 412→414→416→418→420→422 is repeatedly performed. This loop processing continues until the judgment in step 420 turns positive, that is, until exposure in the predetermined focus position range (Z₁ to Z_{M}) of wafer W_{T} with the exposure energy amount at target value P₂ is completed. With this operation, the image of measurement pattern MPₙ is transferred onto divided area DA_{i, 2} (i=1 to M) in each of the first areas DCₙ on wafer W_{T}.

Meanwhile, when exposure is completed at target value P₂ of the exposure energy amount in the predetermined focus position range (Z₁ to Z_{M}) of wafer W_{T}, the decision in step 420 turns positive, and the step moves to step 424 where the judgment is made whether the target value of the exposure energy amount is equal to or exceeds P_{N}. In this case, since the target value of the exposure energy amount is P₂, the decision in step 424 turns out to be negative, and the step then moves to step 426. Then, in step 426, counter j is incremented by 1 and ΔP is added to the target value of the exposure energy amount (Pⱼ←Pⱼ+ΔP). In this case, the target value of the exposure energy amount is changed to P₃, and then the step returns to step 410. Hereinafter, processing (including decision making) similar to the one referred to above is repeatedly performed.

When exposure at the predetermined exposure energy range (P₁ to P_{N}) is completed in the manner described above, the decision in step 424 turns positive and the step moves onto step 428 in FIG. 5. By the operation above, as is shown in FIG. 7, N×M (as an example, 23×13=299) transferred images (latent images) of measurement pattern MPₙ are formed under different exposure conditions in each of the first areas DCₙ on wafer W_{T}. In actual, each of the first areas DCₙ is formed at the stage when N×M (as an example, 23×13=299) divided areas that contain the transferred images (latent images) of measurement pattern MPₙ are formed on wafer W_{T}, however, in the description above, to make the description straightforward, the first areas DCₙ are described as if they were formed in advance on wafer W_{T}.

In step 428 in FIG. 5, the judgment is made whether flag F referred to earlier has been lowered or not, that is, whether F=0. In this case, because flag F has been set up in step 406, the decision made in step 428 is negative, therefore, the step moves to step 430 where counters i and j are incremented by 1 (i←i+1 and j←j+1), respectively. With this operation, counters i and j will be set at i=M+1 and j=N+1, and the areas subject to exposure will be divided area DA_{M+1, N+1}=DA_{14, 24}, which is shown in FIG. 8.

In the next step, step 432, flag F is lowered (F←0), and then the step returns to step 412 in FIG. 4. In step 412, the position of wafer W_{T} is set to divided area DA_{M+1, N+1}=DA_{14, 24} of each of the first divided areas DCₙ on wafer W_{T} where the image of measurement pattern MPₙ is to be transferred, and then the step moves on to step 414. However, in this case, because the target value of the focus position of wafer W_{T} is already set at Z_{M} and does not need any altering, the step moves on to step 416 without any particular operation, where exposure of divided area DA_{14, 24} is performed. And, when exposure is performed, exposure energy amount P is the maximum exposure amount P_{N}.

In the next step, step 418, because flag F=0, steps 420 and 424 are skipped, and the step moves to step 428. In step 428, the judgment is made whether flag F is lowered or not, however, in this case because flag F=0, the decision here is positive, and the step moves on to step 434.

In step 434, the judgment is made whether the current state of both the counters i and j satisfy i=M+1 and j>0. In this case, i=M+1 and j=N+1, therefore, the decision here is positive, so the step moves to step 436 where counter j is decremented by 1 (j←j−1), then the step returns to step 412. Hereinafter, the loop processing (including the decision making) of steps 412→414→416→418→428→434→436 is repeatedly performed, until the decision in step 434 turns negative. With this operation, exposure at the maximum exposure amount referred to earlier is sequentially performed on divided areas DA_{14, 23} to DA_{14, 0} shown in FIG. 8.

Then, when exposure of divided area DA_{14, 0} is completed, i=M+1(=14) and j=0, therefore, the judgment in step 434 turns out to be negative, so the step moves onto step 438. In step 438, the judgment is made whether counters i and j satisfy both i>0 and counter j=0, and, at this point, since i=M+1 and j=0, the judgment at this step is positive so the step moves to step 440 where counter i is decremented by 1 (i←i−1), and then the step returns to step 412. Hereinafter, the loop processing (including the decision making) of steps 412→414→416→418→428→434→438→440 is repeatedly performed, until the decision in step 438 turns negative. With this operation, exposure at the maximum exposure amount referred to earlier is sequentially performed on divided areas DA_{13, 0} to DA_{0, 0} shown in FIG. 8.

Then, when exposure of divided area DA_{0, 0} is completed, i=0 and j=0, therefore, the judgment in step 438 turns out to be negative, so the step moves onto step 442. In step 442, the judgment is made whether counter j satisfies j=N+1 or not, however, at this point, since j=0, the judgment at this step is negative and the step moves to step 444 where counter j is incremented by 1 (j←j+1), and then the step returns to step 412. Hereinafter, the loop processing (including the decision making) of steps 412→414→416→418→428→434→438→442→444 is repeatedly performed, until the decision in step 442 turns out to be positive. With this operation, exposure at the maximum exposure amount referred to earlier is sequentially performed on divided areas DA_{0, 1} to DA_{0, 24} shown in FIG. 8.

Then, when exposure of divided area DA_{0, 24} is completed, j=N+1(=24), therefore, the judgment in step 442 turns positive, and the step then moves on to step 446. In step 446, the judgment is made whether counter i satisfies i=M or not, however, at this point, since i=0, the judgment at this step is negative so the step moves to step 448 where counter i is incremented by 1 (i←i+1), and then the step returns to step 412. Hereinafter, the loop processing (including the decision making) of steps 412→414→416→418→428→434→438→442→446→448 is repeatedly performed, until the decision in step 446 turns out to be positive. With this operation, exposure at the maximum exposure amount referred to earlier is sequentially performed on divided areas DA_{1, 24} to DA_{13, 24} shown in FIG. 8.

Then, when exposure of divided area DA_{13, 24} is completed, i=M(=23), therefore, the judgment in step 446 turns positive, and this completes the exposure operation of wafer W_{T}. And, with the operation, on wafer W_{T}, latent images of evaluation point corresponding areas DBₙ (n=1 to 5) consisting of rectangular shaped first areas DCₙ and rectangular frame shaped second areas DDₙ are formed, as is shown in FIG. 8. In this case, each divided area that makes up the second areas DDₙ is obviously in an overexposed (overdosed) state.

When exposure of wafer W_{T} is completed in the manner described above, the step then moves on to step 450. In step 450, wafer W_{T} is unloaded from wafer stable 18 via a wafer unloader (not shown) and also carried to a coater developer (not shown), which is inline connected to exposure apparatus 100, using a wafer carrier system.

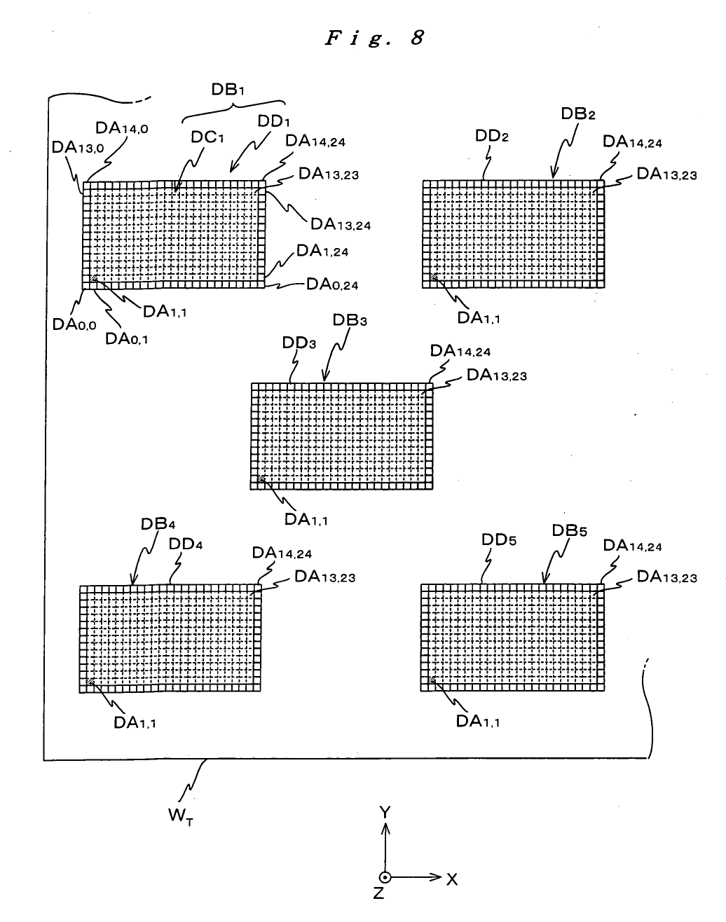

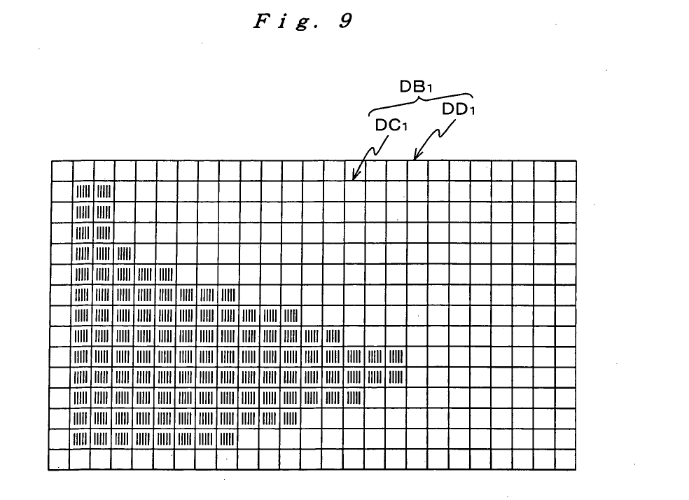

After wafer W_{T} is carried to the above coater developer, the step then moves onto step 452 where the step is on hold until the development of wafer W_{T} has been completed. During the waiting period in step 452, the coater developer develops wafer W_{T}. When the development is completed, resist images of evaluation point corresponding areas DBₙ (n=1 to 5) consisting of rectangular shaped first areas DCₙ and rectangular frame shaped second areas DDₙ are formed on wafer W_{T}, as is shown in FIG. 8, and wafer W_{T} on which the resist images are formed will be used as a sample for measuring the optical properties of projection optical system PL. FIG. 9 shows an example of the resist image of evaluation point corresponding area DB₁, formed on wafer W_{T}.

In FIG. 9, evaluation point corresponding area DB₁ is made up of (N+2)×(M+2)=25×15=275 divided areas DA_{i, j} (i=0 to M+1, j=0 to N+1), and although the drawing shows as if the resist images of the frames that separate adjacent divided areas exist, these were drawn so that the individual divided areas would be easier to recognize. Therefore, in actual, the resist images of the frames that separate adjacent divided areas do not exist. And, taking away such frames can prevent conventional problems such as the contrast of patterns decreasing due to the interference by the frames when picking up images by alignment sensors of the FIA system or the like. Therefore, in the embodiment, step pitch SP referred to earlier is set so that it does not exceed the size of the projected image of each aperture pattern APₙ on wafer W_{T}.

In addition, in this case, when the distance between resist images of measurement patterns MPₙ made up of multibar patterns in adjacent divided areas is expressed as L, distance L is set to a range where the contrast of the image of one measurement pattern MPₙ is not influenced by the existing image of the other measurement pattern MPₙ. When the resolution of the imaging device (in the case of this embodiment, the alignment sensor of the FIA system in alignment detection system AS) that picks up the divided area is expressed as R_{f}, the contrast of the image of the measurement pattern is expressed as C_{f}, the process factor that is determined by the process including the reflectivity and the refractive index of the resist is expressed as P_{f}, and the detection wavelength of the alignment sensor of the FIA system is expressed as λ_{f}, as an example, such distance L can be expressed as a function L=f (C_{f}, R_{f}, P_{f}, λ_{f},).

Since process factor P_{f} affects the contrast of the image, distance L may be determined by function L=f′ (C_{f}, R_{f}, λ_{f},), without including the process factor.

In addition, as it can be seen from FIG. 9, in the rectangular frame shaped second area DD₁ that encloses the rectangular first area DC₁, there are no pattern residual areas. This is because the exposure energy to expose each divided area that structures the second area DD₁ is set so that the areas are overexposed, as is described earlier in the description. The reason for this is to increase the contrast of the outer frame on an outer frame detection, which will be described later, and to increase the S/N ratio of the detection signals.

In the waiting state in the above step 452, when the notice from the control system of the coater developer (not shown) that the development of wafer W_{T} has been completed is confirmed, the step then moves to step 454 where instructions are sent to the wafer loader (not shown) so as to reload wafer W_{T} on wafer table 18 as is described in step 402, and then the step moves on to step 456 where a subroutine to calculate the optical properties of the projection optical system (hereinafter also referred to as ‘optical properties measurement routine’) is performed.

In the optical properties measurement routine, first of all, in step 502 in FIG. 10, wafer W_{T} is moved to a position where the resist image of the above evaluation point corresponding area DBₙ on wafer W_{T} can be detected with alignment detection system AS, referring to a counter n. This movement, that is, the position setting, is performed by controlling XY stage 20 via drive system 22, while monitoring the measurement values of laser interferometer 26. In this case, counter n is initialized at n=1. Accordingly, in this case, wafer W_{T} is set at a position where the resist image of the above evaluation point corresponding area DB₁ on wafer W_{T} shown in FIG. 9 can be detected with alignment detection system AS. In the following description regarding the optical properties measurement routine, the resist image of evaluation point corresponding area DBₙ will be summed up as ‘evaluation point corresponding area DBₙ’ as appropriate.

In the next step, step 504, the resist image of evaluation point corresponding area DBₙ (in this case DB₁) on wafer W_{T} is picked up using the FIA system alignment sensor of alignment detection system AS (hereinafter appropriately shortened as ‘FIA sensor’), and the imaging data is taken in. The FIA sensor divides the resist image by a pixel unit of its imaging device (such as a CCD), and supplies the grayscale of the resist image corresponding to each pixel as an 8 bit digital data (pixel data) to main controller 28. That is, the imaging data is structured of a plurality of pixel data. In this case, when the shade is more intense (becomes grayer, close to black) the value of the pixel data becomes larger.

In the next step, step 506, the imaging data of the resist image formed on evaluation point corresponding area DBₙ (in this case DB₁) from the FIA sensor is organized so as to make an imaging data file.

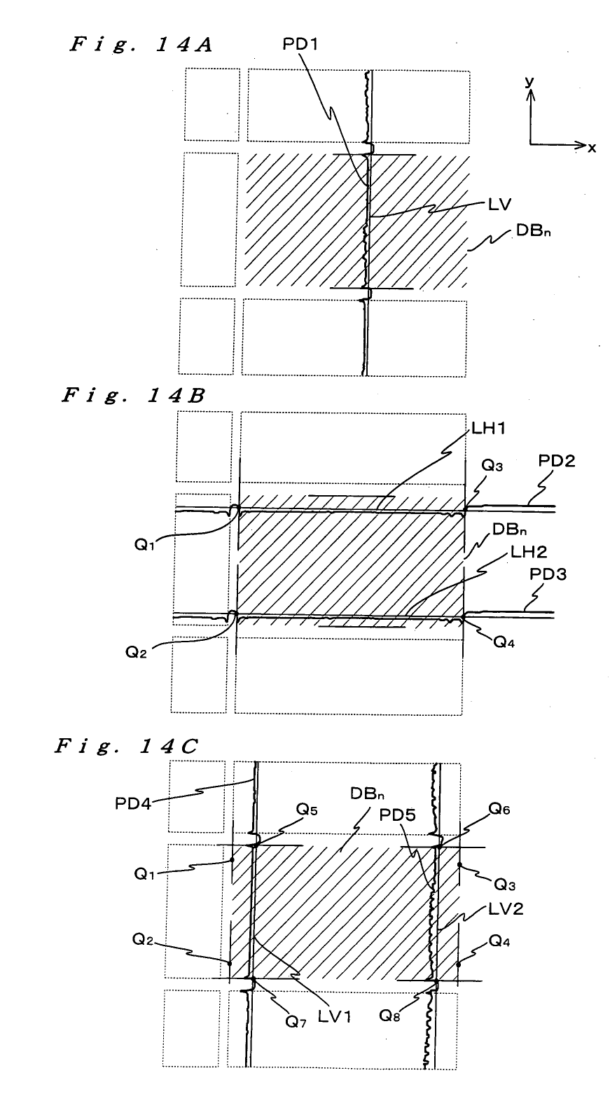

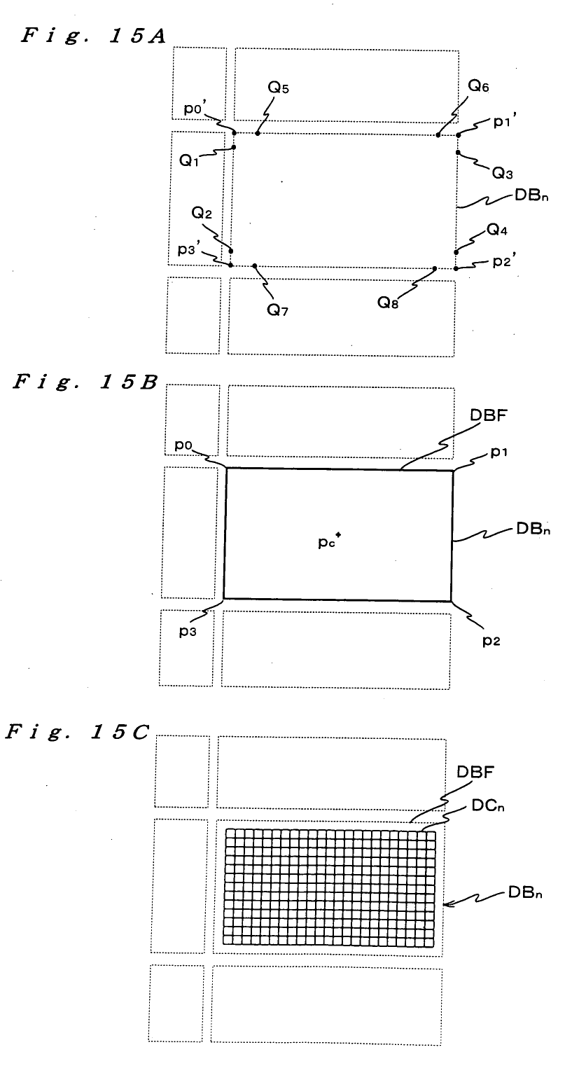

In the next steps (subroutine) 508 to 516, the rectangular shaped outer frame, which is the outer periphery of evaluation point corresponding area DBₙ (in this case DB₁), is detected in the following manner. FIGS. 14A to 14C, and 15A and 15B show the outer frame detection in order. In these drawings, the rectangular shaped are that has the reference DBₙ corresponds to evaluation point corresponding area DBₙ subject to outer frame detection.

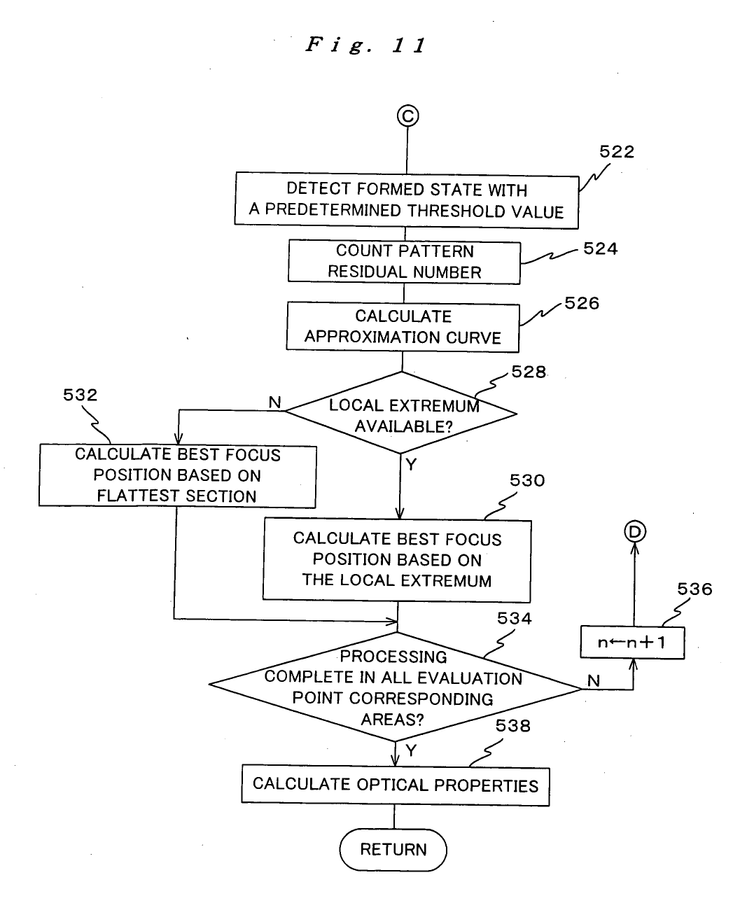

First of all, in subroutine 508, boarder detection is performed using pixel column information that passes through close to the center of the image of evaluation point corresponding area DBₙ (in this case DB₁) as is shown in FIG. 14A, and the rough position of the upper side and the lower side of evaluation point corresponding area DBₙ is detected. FIG. 12 shows the processing performed in subroutine 508.

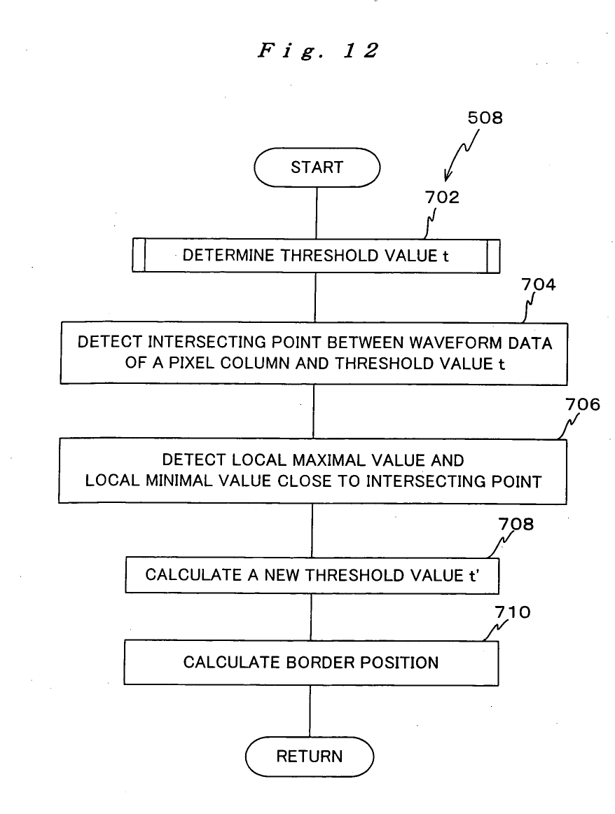

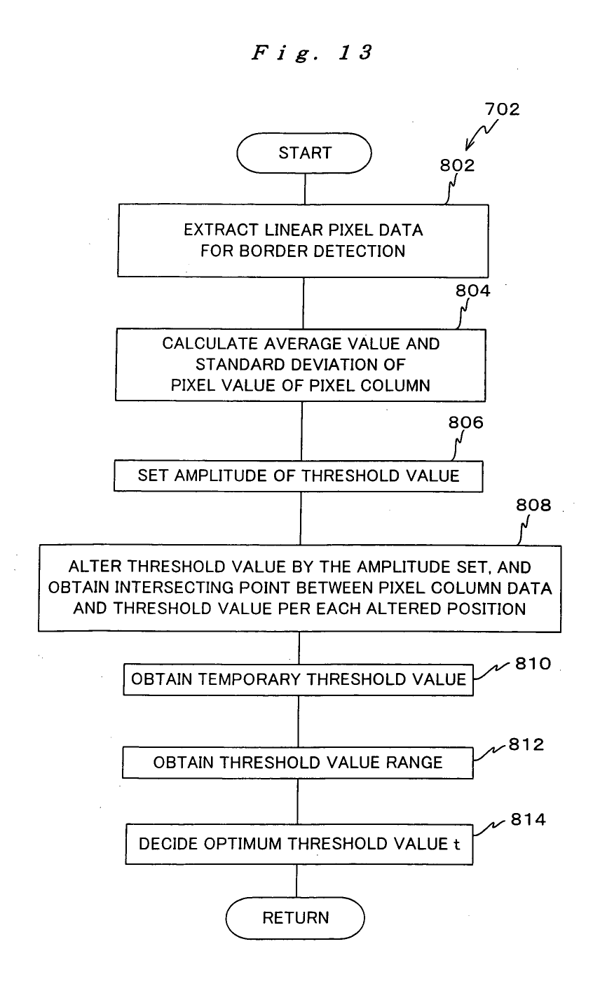

In subroutine 508, first of all, an optimal threshold value t is decided (automatically set) in subroutine 702 shown in FIG. 12. FIG. 13 shows the processing performed in subroutine 702.

In subroutine 702, first of all, in step 802 in FIG. 13, a linear pixel column for boarder detection, for example, a linear pixel column data arranged along a straight line LV shown in FIG. 14A, is extracted from the imaging data file referred to earlier. With this operation, pixel column data that have the pixel values corresponding to waveform data PD1 in FIG. 14A have been obtained.

In the next step, step 804, the average value and the standard deviation (or dispersion) of the pixel values of the pixel column (values of the pixel data) are obtained.

In the next step, step 806, the amplitude of a threshold value (threshold level line) SL is set, based on the average value and the standard deviation that have been obtained.

In the next step, step 808, as is shown in FIG. 16, threshold value (threshold level line) SL is altered at the amplitude set above at a predetermined pitch, and the intersection number of waveform data PD1 and threshold value (threshold level line) SL is obtained for each altering position, and information of the processed results (the values of each threshold level line and the intersection number) is stored in a storage device (not shown).

In the next step, step 810, a threshold value to (will be referred to as a temporary threshold value) is obtained, which is a value where the obtained intersection number coincides with the intersection number determined by the object pattern (in this case, evaluation point corresponding area DBₙ), based on the information of the above processed results stored in the above step 808.

In the next step, step 812, the threshold range that includes the above temporary threshold value t₀ and has the same the intersection number is obtained.

In the next step, step 814, the center of the threshold range obtained in the above step 812 is determined as the optimum threshold value t, and then the step returns to step 704 in FIG. 12.

Incidentally, in the case above, the threshold value is altered discretely (in the predetermined step pitch) based on the average value and the standard deviation (or dispersion) of the pixel values of the pixel column for the purpose of speeding up the process, however, the altering method of the threshold value is not limited to this, and for example, it is a matter of course that the threshold value may be altered continuously.

In step 704 in FIG. 12, the intersecting point of threshold value (threshold level line) t decided above and waveform data PD1 described earlier is obtained (that is, the point where threshold value t crosses waveform data PD1). The detection of this intersecting point is actually performed by scanning its pixel column from the outside toward the inside, as is indicated in FIG. 16 by the arrows A and A′. Therefore, at least two intersecting points are detected.

Referring back to FIG. 12, in the next step, step 706, from the position of each intersecting point that has been obtained, the pixel column is scanned bi-directionally, so as to obtain the local maximal value and local minimal value of the pixel value in the vicinity of each of the intersecting points.

In the next step, step 708, the average value of the local maximal value and local minimal value obtained above is calculated, which will be expressed as the new threshold value t′. In this case, because there are at least two intersecting points, the new threshold value t′ will also be obtained for each of the intersecting points.

In the next step, step 710, the intersecting point of threshold value t′ and waveform data PD1 (that is, the point where threshold value t′ crosses waveform data PD1) is obtained for each of the intersecting points obtained in step 708 described above, in between the local maximal value and local minimal value, and the position of each of the points (pixels) obtained is to be the boarder position. That is, the border position (in this case, the rough position of the upper side and the lower side of evaluation point corresponding area DBₙ) is calculated in the manner described above, and then the step returns to step 510 in FIG. 10.

In step 510 in FIG. 10, border detection is performed in a similar method as in step 508 previously described, using the pixel column on a straight line LH1 in the lateral direction (the direction substantially parallel to the X-axis direction) a little below the upper side obtained in step 508 described above and the pixel column on a straight line LH2 in the lateral direction a little above the lower side obtained, as is shown in FIG. 14B, and a total of four points are obtained; two each on the left side and the right side of evaluation point corresponding area DBₙ. FIG. 14B shows a waveform data PD2 that corresponds to the pixel value of the pixel column data on the above straight line LH1 and a waveform data PD3 that corresponds to the pixel value of the pixel column data on the above straight line LH2, both being used on border detection in step 510. In addition, FIG. 14B also shows points Q1 to Q4 that are obtained in step 510.

Referring back to FIG. 10, in the next step, step 512, border detection is performed in a similar method as in step 508 previously described, using the pixel column on a straight line LV1 in the longitudinal direction a little to the right of the two points Q1 and Q2 on the left side obtained in step 510 described above and the pixel column on a straight line LV2 in the longitudinal direction a little to the left of two points Q3 and Q4 on the right side obtained, as is shown in FIG. 14C, and a total of four points are obtained; two each on the upper side and the right lower of evaluation point corresponding area DBₙ. FIG. 14C shows a waveform data PD4 that corresponds to the pixel value of the pixel column data on the above straight line LV1 and a waveform data PD5 that corresponds to the pixel value of the pixel column data on the above straight line LV2, both being used on border detection in step 512. In addition, FIG. 14C also shows points Q5 to Q8 that are obtained in step 512.

Referring back to FIG. 10, in the next step, step 514, the four corners of the outer frame of evaluation point corresponding area DBₙ that is a rectangular shaped area, p₀′, p₁′, p₂′, and p₃′, are obtained as the intersecting points of the straight lines that are determined by the two points on each of the sides, based on each of the two points (Q₁, Q₂), (Q₃, Q₄), (Q₅, Q₆), and (Q₇, Q₈) on the left, right, upper, and lower sides of evaluation point corresponding area DBₙ obtained in the above steps 510 and 512, as is shown in FIG. 15A. The calculation method of these corners will be described below based on FIG. 17, referring to the calculation of corner p₀′ as an example.

As is shown in FIG. 17, when corner p₀′ is located at a position that satisfies α times (α>0) a vector K1, which points from boarder position Q₂ to Q₁, and a position β times (β<0) a vector K2, which points from boarder position Q₅ to Q₆, at the same time, simultaneous equation (1) shown below stands (in this case, subscripts ₓ and _{y} show the x and y coordinates of each of the points).

$$\begin{matrix}{p}_{0 x}^{′} = {Q}_{2 x} + α ( {Q}_{1 x} - {Q}_{2 x} ) = {Q}_{5 x} + β ( {Q}_{6 x} - {Q}_{5 x} ) \\ {p}_{0 y}^{′} = {Q}_{2 y} + α ( {Q}_{1 y} - {Q}_{2 y} ) = {Q}_{5 y} + β ( {Q}_{6 y} - {Q}_{5 y} )\end{matrix} \} \qquad ( 1 )$$

By solving the above simultaneous equation (1), the position (P₀ₓ′, p_{0y}′) of corner p₀′ can be obtained.

The position of the remaining corners p₁′, p₂′, and p₃′ can also be obtained by setting up similar simultaneous equations and solving them.

Referring back to FIG. 10, in the next step, step 516, an outer frame DBF of evaluation point corresponding area DBₙ is calculated including rotation, by performing rectangular approximation based on the least squares method, according to the coordinate values of the four corners p₀′to p₃′ obtained in above, as is shown in FIG. 15B.

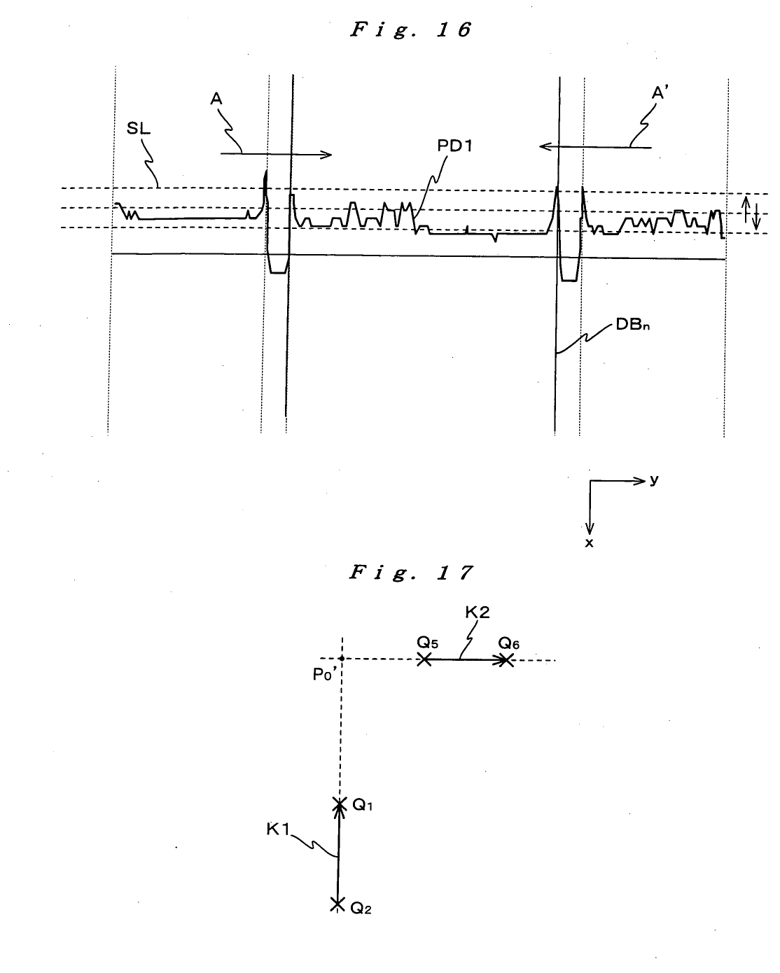

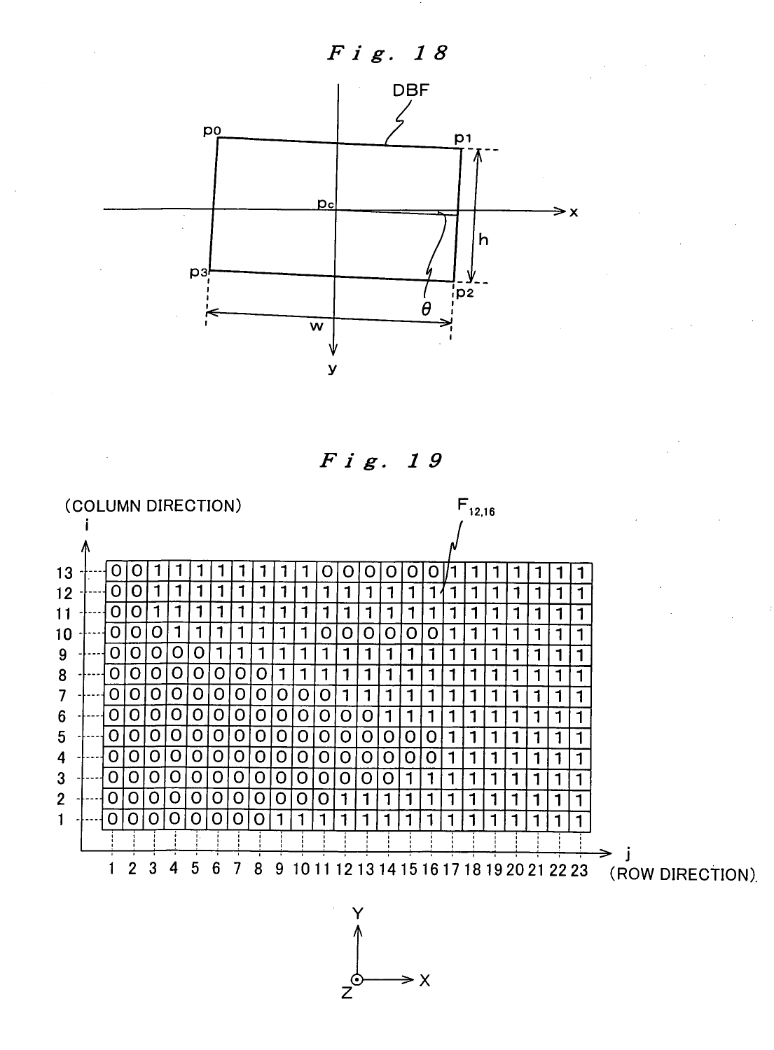

The processing in step 516 will now be described in detail, according to FIG. 18. More particularly, in step 516, rectangular approximation based on the least squares method is performed using the coordinate values of the four corners p₀′ to p₃′, and width w, height h, and rotation amount θ of outer frame DBF of evaluation point corresponding area DBₙ are obtained. In FIG. 18, the y-axis is arranged so that the bottom side of the page surface is positive.

When the coordinate of a center p_{c} is expressed as (p_{cx}, p_{cy}), the four corners of the rectangle (p₀, p₁, p₂, and p₃) can be expressed as follows, as in the equations (2) to (5).

$$\begin{matrix}[ \begin{matrix}{p}_{0 x} \\ {p}_{0 y}\end{matrix} ] = [ \begin{matrix}{p}_{cx} \\ {p}_{cy}\end{matrix} ] + [ \begin{matrix}cos θ & - sin θ \\ sin θ & cos θ\end{matrix} ] [ \begin{matrix}- w / 2 \\ - h / 2\end{matrix} ] & ( 2 ) \\ [ \begin{matrix}{p}_{1 x} \\ {p}_{1 y}\end{matrix} ] = [ \begin{matrix}{p}_{cx} \\ {p}_{cy}\end{matrix} ] + [ \begin{matrix}cos θ & - sin θ \\ sin θ & cos θ\end{matrix} ] [ \begin{matrix}w / 2 \\ - h / 2\end{matrix} ] & ( 3 ) \\ [ \begin{matrix}{p}_{2 x} \\ {p}_{2 y}\end{matrix} ] = [ \begin{matrix}{p}_{cx} \\ {p}_{cy}\end{matrix} ] + [ \begin{matrix}cos θ & - sin θ \\ sin θ & cos θ\end{matrix} ] [ \begin{matrix}w / 2 \\ h / 2\end{matrix} ] & ( 4 ) \\ [ \begin{matrix}{p}_{3 x} \\ {p}_{3 y}\end{matrix} ] = [ \begin{matrix}{p}_{cx} \\ {p}_{cy}\end{matrix} ] + [ \begin{matrix}cos θ & - sin θ \\ sin θ & cos θ\end{matrix} ] [ \begin{matrix}- w / 2 \\ h / 2\end{matrix} ] & ( 5 )\end{matrix}$$

When the total sum of the distance between each of the points of the four corners p₀′, p₁′, p₂′, and p₃′ obtained in step 514 above and the four corners p₀, p₁, p₂, and p₃ that are expressed in the above equations (2) to (5) and correspond to the above four corners is expressed as error Eₚ, it can be expressed as follows, as in equations (6) and (7).

Eₚₓ=(p₀ₓ−p₀ₓ′)²+(p₁ₓ−p₁ₓ′)²+(p₂ₓ−p₂ₓ′)²+(p₃ₓ−p₃ₓ′)² (6)

E_{py}=(p_{0y}−p_{0y}′)²+(p_{1y}−p_{1y}′)²+(p_{2y}−p_{2y}′)²+(p_{3y}−p_{3y}′)² (7)

By performing partial differentiation on each of the above equations (6) and (7) with unknown variables p_{cx}, p_{cy}, w, h, and θ, making a simultaneous equation so that the partial differentiation results to be 0, and solving the simultaneous equation, the results of the rectangular approximation can be obtained.

As a result, outer frame DBF of evaluation point corresponding area DBₙ can be obtained, as is shown in a solid line in FIG. 15B.

Referring back to FIG. 10, in the next step, step 518, outer frame DBF of evaluation point corresponding area DBₙ, which has been detected above, is divided equally using the already known number of divided areas in the lateral direction =(M+2)=15 and the number of divided areas in the lateral direction =(N+2)=25, and each of the divided areas DA_{i, j} (i=0 to 14, j=0 to 24) are obtained. That is, each of the divided areas are obtained, with outer frame DBF serving as datums.

FIG. 15C shows each of the divided areas DA_{i, j} (i=1 to 13, j=1 to 23) making up the first area DCₙ that are obtained in the manner described above.

Referring back to FIG. 10, in the next step, step 520, a representative value related to the pixel data (hereinafter appropriately referred to as a ‘score’) is calculated for each of the divided areas DA_{i, j} (i=1 to M, j=1 to N).

Hereinafter, the calculation method of score E_{i, j} (i=1 to M, j=1 to N) will be described in detail.

Normally, in a measurement subject whose image has been picked up, there is a difference in contrast in the patterned area and the non-patterned area. In the area where the pattern has disappeared, pixels that have the non-patterned area brightness exist, whereas in the area where the pattern remains, pixels that have the pattern area brightness and pixels that have the non-patterned area brightness both exist. Accordingly, the dispersion of the pixel value in each of the divided areas can be used as the representative value (score) when judging whether there are any patterns or not.

In the embodiment, as an example, the dispersion (or the standard deviation) of the pixel value in the designated rage of the divided area will be expressed as score E.

When the total number of pixels in the designated range is expressed as S and the brightness value of the k^{th} pixel is expressed as Iₖ, score E can be expressed as follows, as in equation (8).

$$E = {\sum }_{k = 1}^{S} {( S {I}_{k} - \sum {I}_{k} )}^{2} / {S}^{3} \qquad ( 8 )$$

In the case of the embodiment, as is previously described, measurement pattern MPₙ whose center is the same as that of aperture pattern APₙ (n=1 to 5) is arranged in a reduced area of around 60% of each aperture pattern. In addition, step pitch SP when exposure previously described is performed is set around 5 μm, which substantially coincides with the projected image of each aperture pattern APₙ on wafer W_{T}. Accordingly, in the pattern residual divided area, measurement pattern MPₙ is to have the same center as divided area DA_{i, j}, and it is to be located in a range (area) of divided area DA_{i, j} reduced by 60%.

Considering such points, as the designated range referred to above, for example, a range whose center is the same as divided area DA_{i, j} (i=1 to M, j=1 to N) as well as a reduced area of divided area DA_{i, j} can be used in the score calculation. However, such reduction ratio A (%) has the limitations described below.

First of all, regarding the lower limit, when the range is too narrow the area used for score calculation will only consist of the patterned area, which will make the dispersion smaller even in the pattern residual area so that it cannot be used for confirming pattern availability. In this case, A>60% has to be satisfied, as is obvious from the existing range of the pattern described above. In addition, as for the upper limit, it naturally does not exceed 100%, however, the reduction ratio should be smaller than 100%, taking the detection error into account. From these aspects, reduction ratio A has to be set at the range of 60%<A<100%.

In the case of this embodiment, since the pattern area takes up around 60% of the divided area, it can be expected that the S/N ratio will increase the more the ratio of the area used for score calculation (designated range) is increased with respect to the divided area.

However, the S/N ratio for confirming pattern availability can be set at the maximum level when the size of the patterned area and the non-patterned area in the area used for score calculation (designated range) becomes the same. Accordingly, by experimentally confirming several ratios, the ratio A=90% is employed as the ratio that can obtain the most stable results. As a matter of course, reduction ratio A is not limited to 90%, and it may be set by taking into account the relation between measurement pattern MPₙ and aperture pattern APₙ, the divided area on the wafer decided by step pitch SP, and by taking into account the percentage of the image of measurement pattern MPₙ with respect to the divided area. In addition, the designated range used for score calculation is not limited to the area that has the same center as the divided area, but may be decided taking into consideration where the image of measurement pattern MPₙ is located within the divided area.

Accordingly, in step 520, the imaging data within the specified range of each divided area DA_{i, j} are extracted from the imaging data file referred to earlier, and by using equation (8) described above, score E_{i, j} (i=1 to M, j=1 to N) of each divided area DA_{i, j} (i=1 to M, j=1 to N) is calculated.

Since score E obtained in the above method expresses pattern availability in numerical values, pattern availability can be automatically and stably confirmed by performing binarization with a predetermined threshold value.

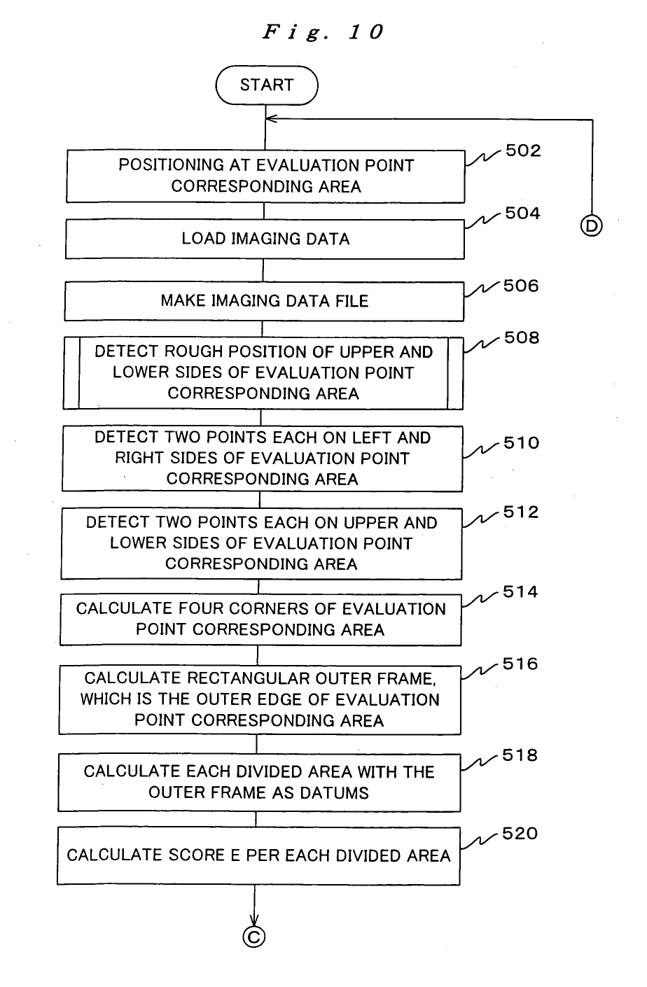

So, in the next step, step 522 (FIG. 11), score E_{i, j} obtained in the manner above and a predetermined threshold value SH are compared for each divided area DA_{i,j}, the availability of the image of measurement pattern MP is detected in each divided area DA_{i,j}, and then judgment values F_{i, j} (i=1 to M, j=1 to N) that serve as the detection results are stored in the storage device (not shown). That is, in such a manner, based on score E_{i,j}, the formed state of the image of measurement pattern MPₙ is detected for each divided area DA_{i,j}. Incidentally, although various cases can be considered as the formed state of the image referred to above, in the embodiment, the focus will be on whether the image of the pattern is formed in the divided area or not, based on the point that score E expresses pattern availability in numerical values as is described above.

When score E_{i,j} exceeds threshold value SH, it is judged that the image of measurement pattern MPₙ is formed, and judgment value F_{i, j} serving as detection results in this case is ‘0’. Meanwhile, when score E_{i, j} does not exceed threshold value SH, it is judged that the image of measurement pattern MPₙ is not formed, therefore, judgment value F_{i, j} serving as detection results in this case is ‘1’. FIG. 19 shows an example of the detection results as a table data, and corresponds to FIG. 9, previously described.

In FIG. 19, F_{12, 16}, for example, shows the detection results of the formed state of the image of measurement pattern MPₙ when exposure is performed at the position Z₁₂ in the Z-axis direction of wafer W_{T} with exposure energy amount P₁₆. And, as an example, in the case of FIG. 19, F_{12, 16} shows the value ‘1’, which means that it has been decided that the image of measurement pattern MPₙ is not formed.

Threshold value SH is a value that is set in advance, however, it is possible for the operator to change it by using an input/output device (not shown).

In the next step, step 524, the number of divided areas that have the image of the pattern formed is obtained per each focus position, based on the above detection results. That is, the number of divided areas whose judgment value is ‘0’ is counted per each focus position, and the counted results are expressed as a pattern residual number Tᵢ (i=1 to M). On such counting, the so-called skipping area whose value is different from its periphery is to be ignored. For example, in the case of FIG. 19, the focus position and pattern residual number on wafer W_{T} are as follows: pattern residual number T₁=8 at focus position Z₁, T₂=11 at Z₂, T₃=14 at Z₃, T₄=16 at Z₄, T₅=16 at Z₅, T₆=13 at Z₆, T₇=11 at Z₇, T₈=8 at Z₈, T₉=5 at Z₅, T₁₀=3 at Z₁₀, T₁₁=2 at Z₁₁, T₁₂=2 at Z₁₂, and T₁₃=2 at Z₁₃. The relation between the focus position and pattern residual number Ti can be obtained in the manner described above.

As the cause of the above skipping area occurring, false recognition upon measurement, misfire of laser, debris, noise, or the like can be considered, however, in order to reduce the influence that such skipping areas have on the detection results of pattern residual number Tᵢ, a filtering process may be performed. As the filtering process, for example, an average value (a simple average value or a weighting average value) of the data (judgment values F_{i,j}) of 3×3 divided areas that have the divided area subject to evaluation in the center can be obtained. The filtering process may, of course, be performed on the data prior to detection processing of the formed state (score E_{i,j}), and in this case, the influence of the skipping area can be effectively reduced.

In the next step, step 526, a high order approximation curve (for example, a fourth to sixth order curve) is obtained in order to calculate the best focus position from the pattern residual number.

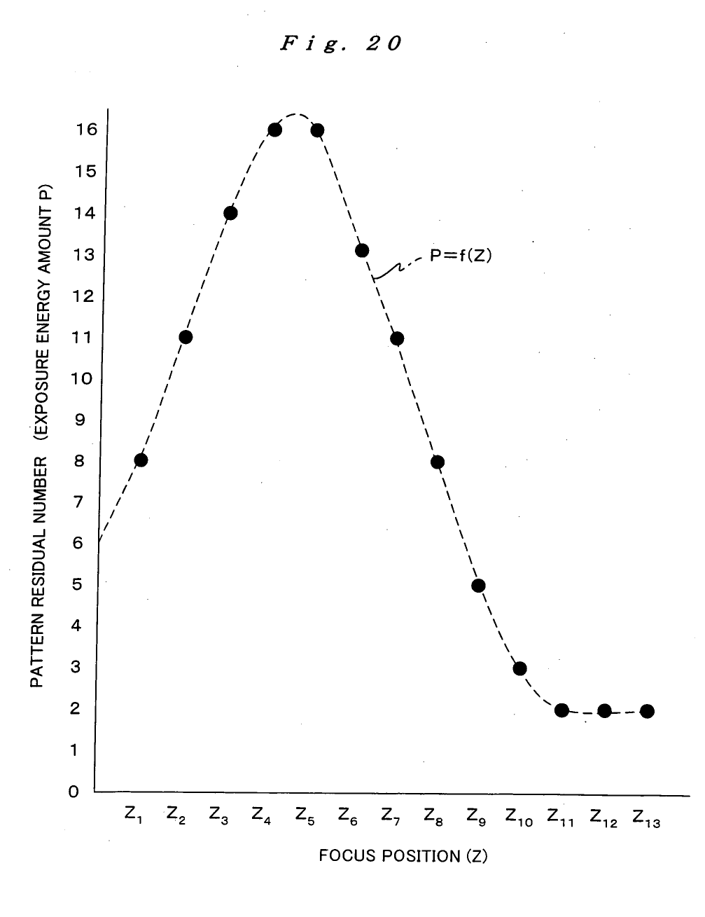

To be more specific, the number of the residual patterns detected in step 524 described above is plotted on a coordinate system whose horizontal axis shows the focus position and vertical axis shows pattern residual number Tᵢ. FIG. 20 shows the coordinate system in this case. In the case of this embodiment, on exposure of wafer W_{T}, since each divided area DA_{i, j} has the same size, the difference of the exposure energy amount between adjacent divided areas in the row direction is a constant value (=ΔP), and the difference of the focus position between adjacent divided areas in the column direction is also a constant value (=ΔZ), pattern residual number Tᵢ can be treated as being proportional to the exposure energy amount. That is, in FIG. 20, it can also be considered that the vertical axis shows exposure energy amount P.

After the above plot, curve fitting of each plot point is performed, and the high order approximation curve (the least squares approximation curve) is obtained. With this operation, for example, the curve P=f(Z) is obtained, as is shown in the dotted line in FIG. 20.

Referring back to FIG. 11, in the next step, step 528, the attempt to calculate the local extremum of the above curve P=f(Z) is made, and based on the results the judgment is made whether there actually is a local extremum or not. And, when the local extremum could be calculated, the step moves onto step 530 where the focus position of the local extremum is calculated. The calculated results are decided as the best focus position, which is also stored in the storage device (not shown).

On the other hand, when the local extremum could not be calculated in step 528 described above, the step then moves on to step 532. In step 532, a range of the focus position where the altering amount of curve P=f(Z) corresponding to the positional change of wafer W_{T} (the change in Z) is the smallest is calculated, and the position in the middle of the range is calculated as the best focus position. The calculated results, which are determined as the best focus position, are stored in the storage device (not shown). That is, the focus position is calculated according to the flattest part of curve P=f(Z).

The reason for providing a calculation step of best focus position such as step 532 referred to above, is because there may be an exceptional case where the above curve P=f(Z) does not have a clear-cut curve, depending on the type of measurement pattern MP or the type of resist or other exposure conditions. And, the calculation step is provided in order to make the calculation of the best focus position with some precision possible even in such a case.

In the next step, step 534, the judgment is made whether processing on all evaluation point corresponding areas DB₁ to DB₅ has been completed, referring to counter n previously described. In this case, since processing on only evaluation point corresponding area DB₁ has been performed, the decision made in step 534 is negative, therefore, the step moves to step 536 where counter n is incremented by 1 (n←n+1) and then returns to step 502 in FIG. 10 where the position of wafer W_{T} is set so that alignment detection system AS can detect evaluation point corresponding area DB₂.

Then the processing from the steps 504 to 534 (including the decision making) described above is performed again, and the best focus position is obtained for evaluation point corresponding area DB₂, as in the case of evaluation point corresponding area DB₁ also described above.

Then, when calculation of the best focus position has been completed for evaluation point corresponding area DB₂, in step 534 the judgment on whether processing on all evaluation point corresponding areas DB₁ to DB₅ has been completed is performed again, and the decision here is negative. Hereinafter, the above steps 502 to 536 (including the decision making) described above are repeatedly performed, until the decision in step 534 turns out to be positive. With such operation, the best focus position is obtained for the remaining evaluation point corresponding areas DB₃ to DB₅, as in the case of evaluation point corresponding area DB₁ also described above.

When the calculation of best focus position for all evaluation point corresponding areas DB₁ to DB₅ has been completed in the manner described above, the decision in step 534 turns out positive, and the step then moves to step 538 where other optical properties are calculated, base on the best focus position data that has been obtained above.

For example, in step 538, the curvature of field of projection optical system PL is calculated, based on the best focus position data of evaluation point corresponding areas DB₁ to DB₅.

In the embodiment, for the sake of simplicity, the description so far has been made on the premise that only pattern MPₙ serving as the measurement pattern is formed on the area on reticle R_{T} corresponding to each of the evaluation points in the field of projection optical system PL. However, as a matter of course, the present invention is not limited to this. For example, on reticle R_{T} in the vicinity of the area on reticle R_{T} corresponding to each of the evaluation points, a plurality of aperture patterns APₙ may be arranged, spaced by an integral multiple such as 8 times or 12 times of the step pitch SP described earlier, and within each of aperture patterns APₙ, a plurality of measurement pattern types such as an L/S pattern whose periodic direction differs or an L/S pattern whose pitch differs may be arranged. When such an arrangement is employed, not only can the best focus position (such as the average value) be obtained for the plurality of measurement pattern types, but also, for example, astigmatism for each evaluation point can be obtained from the best focus position obtained from a pair of L/S patterns whose periodic direction is perpendicular, arranged close to the position corresponding to each evaluation point. Furthermore, based on the astigmatism for each evaluation point obtained above, approximation processing using the least squares method can be performed on each evaluation point within the field of projection optical system PL in order to obtain regularity within the astigmatism surface, and from the regularity within the astigmatism surface and the curvature of field, the total focus difference can be obtained.

And, the optical properties data of projection optical system PL obtained in the manner described above is stored in a storage device (not shown), as well as being shown on a display device (not shown). With this operation, the processing in step 538 in FIG. 11, or in other words, the processing in step 456 in FIG. 5 is completed, thus completing the process of measuring the series of optical properties.

Next, the exposure operation of exposure apparatus 100 in the embodiment in the case of device manufacturing will be described.

As a premise, the information on the best focus position decided in the manner described above, or in addition to such information, the information on the curvature of field is to be input to main controller 28 via the input/output device (not shown).

For example, when information on the curvature of field is input, in prior to exposure, main controller 28 sends instructions to the image forming characteristics correction controller based on the optical properties data so as to correct the image forming characteristics of projection optical system PL as much as possible in order to correct the curvature of field by changing, for example, the position of at least one optical element (or lens element, in this embodiment)(including the spacing between other optical elements) in projection optical system PL or its inclination. The optical element used to adjust the image forming characteristics of projection optical system PL is not only a dioptric element such as a lens element, but it may also be a catoptric element such as a concave mirror, or an aberration correction plate that corrects the aberration of projection optical system PL (such as distortion, or spherical aberration), especially the non-rotationally symmetrical component. Furthermore, the correction method of the image forming characteristics of projection optical system PL is not limited to moving optical elements, and other methods such as shifting the representative wavelength of pulse illumination light IL slightly by controlling the exposure light source or changing the refractive index of projection optical system PL partially may be employed by itself, or be combined with the method of moving optical elements.

And, in response to instructions from main controller 28, the reticle loader (not shown) loads reticle R, on which the predetermined circuit pattern (device pattern) subject to transferring is formed, onto reticle stage RST. Similarly, the wafer loader (not shown) loads wafer W on wafer table 18.

Next, main controller 28 performs preparatory operations such as reticle alignment and baseline measurement in a predetermined procedure, using equipment such as the reticle alignment microscopes (not shown), fiducial mark plate P on wafer table 18, and alignment detection system AS, and following such operations, wafer alignment based on methods such as EGA (Enhanced Global Alignment) or the like is performed. Regarding the above preparatory operations such as the reticle alignment and baseline measurement, the details are disclosed in, for example, Japanese Patent Application Laid-open No. H04-324923 and the corresponding U.S. Pat. No. 5,243,195, and regarding the following operation, EGA, the details are disclosed in, for example, Japanese Patent Application Laid-open No. S61-44429 and the corresponding U.S. Pat. No. 4,780,617. As long as the national laws in designated states or elected states, to which this international application is applied, permit, the disclosures of the above publication and U.S. Patent are fully incorporated herein by reference.

When the above wafer alignment is complete, exposure operation based on the step-and-repeat method is performed in the manner described below.

On this exposure operation, first of all, the position of wafer table 18 is set so that the first shot area on wafer W coincides with the exposure position (which is directly under projection optical system PL). Main controller 28 performs this position setting by moving XY stage 20 via drive system 22 or the like, based on the XY positional information (or velocity information) of wafer W measured by laser interferometer 26.

When wafer W is moved to the predetermined exposure position in the manner described above, main controller 28 then moves wafer table 18 in the Z-axis direction and the direction of inclination via drive system 22 based on the positional information of wafer W in the Z-axis direction detected by focus sensor AFS, in order to adjust the surface position of wafer W so that the shot area subject to exposure on the surface of wafer W is within the depth of focus range of the image plane of projection optical system PL whose optical properties have been corrected in the manner previously described. Then, main controller 28 performs the exposure that is previously described. In the embodiment, prior to the exposure operation of wafer W, the image plane of projection optical system PL is calculated based on the best focus position for each evaluation point described earlier, and focus sensor AFS is optically calibrated (such as adjusting the angle of inclination of a plane-parallel plate arranged in light receiving system 50b) so that the above image plane is the implied datum when focus sensor AFS performs detection. As a matter of course, the optical calibration does not necessarily have to be performed; for example, focusing operation (and leveling operation) may also be performed to make the surface of wafer W coincide with the image plane based on the output of focus sensor AFS, taking into consideration the offset corresponding to the deviation of the image plane calculated earlier and the implied datum of focus sensor AFS.

When exposure of the first shot area is completed, or in other words, the reticle pattern has been transferred, wafer table 18 is stepped by a shot area, and then, exposure is performed in the same manner as in the previous shot area.

Hereinafter, stepping and exposure are sequentially repeated in the manner described above, and the required number of patterns is transferred onto wafer W.

As is described in detail so far, according to the optical properties measurement method of projection optical system PL in the exposure apparatus related to the embodiment, reticle R_{T} on which the rectangular shaped aperture pattern APₙ and measurement pattern MPₙ located within aperture pattern APₙ are formed is loaded on reticle stage RST disposed on the object plane side of the projection optical system, and measurement pattern MPₙ is sequentially transferred onto wafer W_{T} by sequentially moving wafer W_{T} within the XY plane at a distance corresponding to the size of aperture pattern APₙ, that is, at a step pitch which does not exceed the size of the projected image of aperture pattern APₙ on wafer W_{T}, while the position(Z) in the optical axis direction of projection optical system PL of wafer W_{T}, which is disposed on the image plane side of projection optical system PL, and energy amount P of pulse illumination light IL irradiated on wafer W_{T} are altered. With such operation, on wafer W_{T}, the rectangular evaluation point corresponding area DBₙ is formed, which consists of a plurality of divided areas DA_{i, j} (i=0 to M+1, j=0 to N+1) arranged in a matrix. In this case, from the reasons described earlier in the description, a plurality of divided areas (areas where the image of the measurement pattern is projected) arranged in a plurality of matrices that do not have the conventional frame lines on the border in between the divided areas is formed on wafer W_{T}.

Then, after wafer W_{T} is developed, of the plurality of divided areas that make up evaluation point corresponding area DBₙ formed on wafer W_{T} excluding the second area DDₙ, the formed state of the images in the M×N areas making up the first area DCₙ is detected, based on the method of image processing. Or, to be more specific, main controller 28 picks up the images of evaluation point corresponding area DBₙ on wafer W_{T} using the FIA sensors of alignment detection system AS, and using the imaging data of the resist image that has been picked up, performs detection based on the binarization method, comparing score E_{i, j} and threshold value SH for each divided area DA_{i, j}.

In the case of the embodiment, because the frame lines do not exist for adjacent divided areas, the contrast of the image of the measurement pattern is not degraded due to the interference of the frame lines in the plurality of divided areas whose images are subject to detection (mainly the divided areas where there are residual images of the measurement pattern). Therefore, as the imaging data for such plurality of divided areas, good S/N ratio data can be obtained for the patterned area and non-patterned area. Accordingly, the formed state of measurement pattern MP can be detected with good accuracy and reproducibility for each divided area. Moreover, because the formed state of the image is detected by comparing the objective and quantitative score E_{i, j} to threshold value SH and converting the results into pattern availability information (binarization information), the formed state of measurement pattern MP can be detected with good precision and reproducibility for each divided area.

In addition, in the embodiment, because the formed state of the image is detected by converting the image formed state into pattern availability information (binarization information) using score E_{i, j}, which expresses pattern availability in numerical values, the pattern availability can be confirmed automatically, in a stable manner. Accordingly, in the embodiment, on binarization, only one threshold value is required which allows to reduce the time required for detecting the state of the image as well as simplify the detection algorithm, compared with when a plurality of threshold values are set and the pattern availability is confirmed for each threshold value.

In addition, main controller 28 obtains the optical properties of projection optical system PL such as the best focus position, based on the above detection results of the formed state of the image for each divided area, that is, based on the detection results that have used the above objective and quantitative score E_{i, j} (the index value of the image contrast). Therefore, the best focus position or the like can be obtained within a short time with good precision. Accordingly, the measurement precision and the reproducibility of the measurement results of the optical properties decided based on the best focus position can be improved, which, as a consequence, can improve the throughput in the optical properties measurement.

In addition, in the embodiment, as is described above, since the formed state of the image is detected by converting the image formed state into pattern availability information (binarization information), there is no need to arrange a pattern other than the measurement pattern MP (such as a reference pattern for comparison, or a position setting mark pattern) within pattern are PA of reticle RT. In addition, the measurement pattern can be smaller, compared with the conventional size measuring method (such as CD/focus method or SMP focus measurement method). Therefore, the number of evaluation points can be increased, and the spacing between the evaluation points can be small. As a result, the measurement precision and the reproducibility of the measurement results of the optical properties can be improved.

In addition, in the embodiment, considering the fact that the frame lines do not exist between adjacent divided areas formed on wafer W_{T}, the position of each of the divided areas DA_{i, j} is calculated employing the method of using outer frame DBF, which serves as the outer periphery frame of each evaluation point corresponding area DBₙ, as datums. Then, the energy amount of pulse illumination light IL irradiated on wafer W_{T} is altered as a part of the exposure conditions, so that the second area DDₙ consisting of a plurality of divided areas located at the outermost edge of evaluation point corresponding area DBₙ is overexposed. With such an arrangement, the S/N ratio is improved when the detection of outer frame DBF referred to earlier is performed and outer frame DBF can be detected with high precision, and, as a consequence, the position of each divided area DA_{i, j} (i=1 to M, j=1 to N) that makes up each of the first areas DCₙ can be detected with good accuracy.

In addition, according to the optical properties measurement method related to the embodiment, because the best focus position is calculated based on an objective and conclusive method as in calculating the approximation curve by statistical processing, the optical properties can be measured stably and also with high precision, without fail. Incidentally, depending on the order of the approximation curve, the best focus position can be calculated, based on the inflection point or on a plurality of intersecting points of the approximation curve with a predetermined slice level.

In addition, with the exposure apparatus in the embodiment, projection optical system PL is adjusted prior to exposure so that the optimum transfer is performed taking into consideration the optical properties of projection optical system PL that has been measured with good accuracy by the optical properties measurement method related to the embodiment, and the pattern formed on reticle R is transferred onto wafer W via such projection optical system PL. Furthermore, a focus control target value on exposure is set, taking into consideration the best focus position decided in the manner described above, therefore, irregular colors that occur due to defocusing can be effectively suppressed. Accordingly, with the exposure apparatus related to the embodiment, fine patterns can be transferred onto the wafer with high precision.

In the above embodiment, the case has been described where the formed state of the image of measurement pattern MPₙ is detected by comparing quantitative score E_{i, j} to threshold value SH and converting the results into pattern availability information (binarization information), however, the present invention is not limited to this. In the above embodiment, outer frame DBF of evaluation point corresponding area DBₙ is detected with good accuracy, and each divided area DA_{i, j} is obtained by calculation with the outer frame serving as datums; therefore, the position of each divided area can be accurately obtained. Accordingly, template matching may be performed against each divided area whose position has been accurately obtained. In such a case, the template matching can be performed within a short period of time. In this case, for example, the imaging data of the divided area where the image is formed or the imaging data of the divided area where the image is not formed can be used as the template pattern. And, even when such data is used as the template pattern, objective and quantitative information on correlated values can be obtained for each divided area, therefore, by comparing the obtained information to a predetermined threshold value, the formed state of measurement pattern MP can be converted into binarization information (image availability information), and the formed state of the image can be detected with good precision and reproducibility as in the above embodiment.

In addition, in the above embodiment, the case has been described where the second area making up evaluation point corresponding area DBₙ is a full rectangular frame, however, the present invention is not limited to this. That is, with the second area, since its outer frame is required only to be datums for calculating the position of each divided area making up the first divided area, it does not necessarily have to be formed on the entire outer periphery of the first area that has an overall rectangular shape, and may be formed on a part of the rectangular frame shape of the divided area, such as in a U-shape.

In addition, in the method of making the second area, that is, the rectangular framed shape area or a part of the area, methods other than the method described in the above embodiment of transferring the measurement pattern onto the wafer in an overexposed state based on a step-and-repeat method may also be employed. For example, a reticle on which a rectangular frame shaped aperture pattern or a part of its pattern is formed may be loaded on reticle stage RST of exposure apparatus 100, and the reticle pattern may be transferred onto the wafer arranged on the image plane side of projection optical system PL and the overexposed second area formed on the wafer with one exposure. Besides such a method, a reticle on which an aperture pattern similar to aperture pattern APₙ previously described may be loaded on reticle stage RST, and by transferring the aperture pattern onto the wafer with an overexposed exposure energy amount based on the step-and-repeat method, the overexposed second area may be formed on the wafer. In addition, for example, by performing exposure using the above aperture pattern based on the step-and-stitch method and forming a plurality of images of the aperture pattern adjacent or joined together, the overexposed second area may be formed on the wafer. Besides such methods, the overexposed second area may be formed by moving wafer W (wafer table 18) in a predetermined direction, while the reticle on which an aperture pattern is formed is loaded on reticle stage RST and is illuminated with the illumination light, in a state where reticle stage RST is static. In any case, the overexposed second area being available allows the outer frame of the second area to be detected with good accuracy based on the detection signals with good S/N ratio, as in the above embodiment.

In the cases described above, the process of forming the overall rectangular shaped first area DCₙ made up of a plurality of divided areas arranged in a matrix on wafer W_{T} and the process of forming the overexposed second area (such as DDₙ) on the wafer at least partly in the periphery of the first area may be reversed from the above embodiment. Especially, when the exposure for forming the first area subject to image formed state detection is performed afterwards, for example, it is especially suitable to use a resist with high sensitivity such as a chemical amplifying resist as the photoresist, because it would reduce the time required from forming (transferring) the image of the measurement pattern to development.

In addition, the overexposed second area is not limited to the rectangular framed shape or a part of it described in the above embodiment. For example, the second area may be shaped so that only the borderline (inner edge) with the first area has a rectangular frame shape, while the outer edge may be optional. Even in such a case, because the overexposed second area (the area on which the pattern image is not formed) is available on the outer side of the first area, when the divided areas located at the outermost periphery within the first area (hereinafter referred to as the ‘outer edge divided areas’) are detected, the pattern image located at adjacent areas on the outer side of the first area prevents the contrast of the image formed in the outer edge divided areas from being deteriorated. Accordingly, the borderline of the outer edge divided areas and the second area can be detected with good S/N ratio, and the borderline can serve as the reference when calculating the position of other divided areas (each divided area that make up the first divided area) based on designed values, which allows the substantially accurate position of other divided areas to be obtained. And, because a substantially accurate position of the plurality of divided areas within the first area can be obtained by the operation above, the formed state of the pattern image can be detected within a short period of time, for example, by the method of using the score (the index value of the image contrast) as in the above embodiment or detecting the formed state of the image by applying the template matching method, for each of the divided areas.

And, by obtaining the optical properties of the projection optical system based on the detection results, the optical properties can be obtained based on objective and quantitative image contrast or detection results that use correlated values. Accordingly, the same effect as in the above embodiment can be obtained.

In addition, the case has been described where all of the N×M divided areas that make up the overall rectangular first area are exposed, however, exposure does not necessarily have to be performed on at least one divided area among the N×M divided areas, that is, a divided area whose exposure conditions that are set obviously do not contribute when deciding the curve P=f(Z) (such as the divided areas located in the upper right corner and in the lower right corner in FIG. 9). In this case, the second area formed on the outer side of the first area does not have to be a rectangular shape, and may be shaped so that it is partly uneven. In other words, of the N×M divided areas, the second area may be formed so that it encloses only the divided areas that have been exposed.

In addition, when the borderline of the outer edge divided areas and the second area is detected, alignment sensors other than the FIA system sensor of the alignment detection system may also be used, such as for example, an LSA system, which is an alignment sensor that detects the light amount of scattered light or diffracted light.

Even in such a case, it is possible to obtain the position of each divided area within the first area with good precision, with the inner edge of the second area serving as datums.

In addition, when each evaluation point corresponding area is made of the first area and the second area enclosing the first area as in the above embodiment, step pitch SP referred to earlier does not necessarily have to be set under the projection area size of aperture pattern AP previously described. The reason for this is because the position of each divided area making up the first area is substantially accurately obtained with a part of the second area serving as datums in the method described so far, by using such information, for example, template matching or contrast detection including the case in the above embodiment can be performed at a certain precision level, within a short period of time.

Meanwhile, in the case where step pitch SP is set under the projection area size of aperture pattern AP previously described, the second area referred to earlier does not necessarily have to be formed outside the first area. Even in such a case, the outer frame of the first area can be detected as in the above embodiment, and with the detected outer frame serving as datums the position of each divided area within the first area can be accurately obtained. And, when the image formed state is detected by, for example, template matching or detection using the scores as in the above embodiment (contrast detection), using the positional information of each divided area obtained in the manner described above, the image formed state can be detected with good precision using the imaging data that has good S/N ratio on which deterioration due to frame interference has not occurred.

However, in this case, errors on border detection may occur easily in the divided areas in the outermost periphery within the first area, on the edge where divided areas that have residual patterns are arranged. Therefore, the detection range of the border where errors may occur is preferably limited, by using the detection information of the border where errors are unlikely to occur. To describe in line with the above embodiment, the detection range of the border position on the left edge where divided areas that may have detection errors are arranged is limited, based on the detected border information of the right edge where divided areas in which errors are not likely to occur are arranged. In addition, on border detection of the upper and lower edge of the first area, the detection range of the boarder position on the left side only has to be limited using the detection information of the right side where detection errors are not likely to occur (refer to FIG. 9).

In the above embodiment, the case has been described where the degrading in contrast due to the frame interference in the patterned area has been prevented, by setting step pitch SP of wafer W_{T} narrower than usual so that the frames do not remain in between the divided areas that make up the evaluation point corresponding area formed on wafer W_{T}. However, the degrading in contrast due to the existing frames can also be prevented in the following manner.

More particularly, similar to the measurement pattern MP previously described, a reticle on which a measurement pattern including multibar pattern is prepared, loaded onto reticle stage RST, and the measurement pattern is transferred onto the wafer based on the step-and-repeat method or the like. And, with the above operation, a predetermined area, which is made up of a plurality of adjacent divided areas where the multibar pattern transferred in each divided area and its adjacent pattern are arranged at distance L so that the contrast of the image of the multibar pattern is not influenced by the adjacent pattern, may be formed on the wafer.

In this case, because the multibar pattern transferred onto each divided area and its adjacent pattern are spaced at a distance exceeding distance L where the contrast of the image of the multibar pattern is not influenced by the adjacent pattern, when the formed state of the image in at least a part of a plurality of divided areas among the plurality of divided areas making up the predetermined area is detected based on the image processing method such as image processing, template matching, or contrast detection including score detection, imaging signals that have a good S/N ratio of the image of the multibar pattern transferred onto each divided area can be obtained. Accordingly, based on the imaging signals, by the image processing method such as template matching, or contrast detection including score detection, the formed state of the image of the multibar pattern formed in each divided area can be detected with good accuracy.

For example, in the case of template matching, objective and quantitative information on correlated values can be obtained for each divided area, whereas in the case of contrast detection, objective and quantitative information on contrast values can be obtained for each divided area, and, in any case, by comparing the obtained information with their respective threshold values, the formed state of the image of the multibar pattern can be converted into binarization information, and the formed state of the image of the multibar pattern can be detected with good precision and reproducibility for each divided area.

Accordingly, by obtaining the optical properties of the projection optical system based on the above detection results in such a case as in the above embodiment, the optical properties are obtained based on the detection results that use the objective and quantitative correlated values and contrast or the like. Accordingly, the optical properties can be measured with good precision and good reproducibility when compared with the convention method. In addition, the number of evaluation points can be increased, as well as reduce the spacing between the evaluation points, and as a consequence, the measurement accuracy of the optical properties measurement can be improved.

In the above embodiment, when detecting the border in the outer frame DBF detection previously described, the case has been described where the pixel column data (raw data) is used to detect the border position according to the amount (tone difference) of the pixel value, however the present invention is not limited to this, and the differential waveform of the pixel column data (raw data on gray level) may also be used.

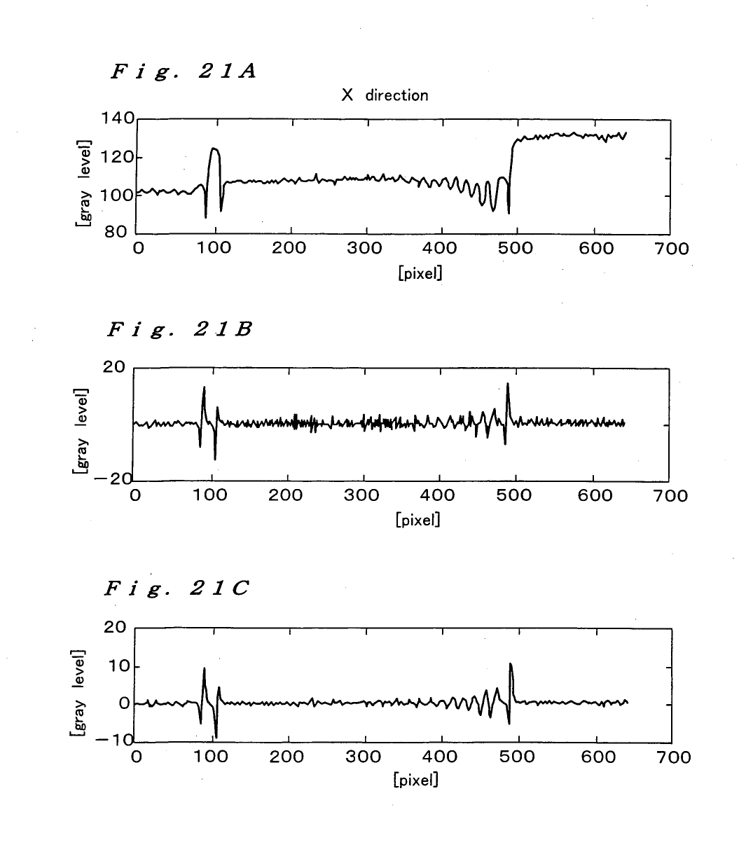

FIG. 21A shows the raw data on gray level obtained on border detection, whereas FIG. 21B shows the differential data, which is the raw data in FIG. 21A, differentiated. When the signal output of the frame portion is difficult to distinguish in the differential data due to noise or residual patterns, the raw data may be differentiated after smoothing filter is performed, as is shown in FIG. 21. The outer frame can be detected also in such a manner.

In the above embodiment, the case has been described where a certain type of L/S pattern (multibar pattern) arranged in the center within aperture pattern AP is used as measurement pattern MPₙ on reticle R_{T}, however, as a matter of course, the present invention is not limited to this. As the measurement pattern, a dense pattern or an isolated pattern may be used, or both patterns may be used together. Or, at least two types of an L/S pattern that have different periodic directions, an isolated line, or a contact hole may also be used. When the L/S pattern is used as measurement pattern MPₙ, the duty ratio and the periodic direction may be optional. In addition, when a periodic pattern is used as measurement pattern MPₙ, the periodic pattern is not limited to an L/S pattern, but may also be, for example, a pattern that has dot marks periodically arranged. This is because the formed state of the image is detected using the score (contrast), different from the conventional method of measuring the line width or the like of an image.

In addition, in the above embodiment, the best focus position is obtained based on a certain type of score, however, the present invention is not limited to this, and a plurality of types of scores can be set and the best focus position may be obtained based on such scores, or the best focus position may be obtained based on the average value (or the weighting average value) of such scores.

In addition, in the above embodiment, the area where the pixel data is extracted is described as a rectangle, however, the present invention is not limited to this, and for example, it may be a circular shape, an elliptical shape, or a triangular shape. In addition, the size may be optional. That is, by setting the extraction area according to the shape of measurement pattern MPₙ, noise can be reduced and the S/N ratio can be increased.

In addition, in the above embodiment, one type of threshold value is used for detecting the formed state of the image, however, the present invention is not limited to this, and a plurality of threshold values may be used. In the case of using a plurality of threshold values, the formed state of the image of the divided area may be detected by comparing the respective threshold values to the scores. In this case, for example, when it is difficult to calculate the best focus position from the first threshold value, the detection of the formed state is performed using a second threshold value, and the best focus position can be obtained from the detection results.

In addition, a plurality of threshold values may be set in advance, the best focus position obtained for each threshold value, and then the average value (a simple average value or a weighting average value) may be determined as the best focus position. For example, the focus position when exposure energy amount P is the local extremum may be sequentially calculated according to each threshold value, and the average value of each focus position may be the best focus position. The best focus position may also be decided by obtaining the two intersecting points (focus position) of an approximation curve showing the relation between exposure energy amount P and focus position Z and an appropriate slice level (exposure energy amount), calculating the average value of both intersecting points per each threshold value, and deciding their average value (a simple average value or a weighting average value) to be the best focus position.

Or, the best focus position may be decided by calculating the best focus position for each threshold value, and in the relation between the threshold value and the best focus position, the average value (a simple average value or a weighting average value) of the best focus position in an interval where the best focus position changes the least with respect to the threshold value may be decided as the best focus position.

In addition, in the above embodiment, a value that is already set in advance is used as the threshold value; however, the present invention is not limited to this. For example, an area on wafer W_{T} where measurement pattern MPₙ is not transferred may be imaged, and the score obtained from the imaging may be used as the threshold value.

When the outer frame detection previously described is not performed, then the resist image formed in evaluation point corresponding area DBₙ does not necessarily have to be imaged at once. For example, when the resolution of the imaging data needs to be improved, the magnification of the FIA sensor of alignment detection system AS may be increased, and by sequentially repeating the stepping operation of moving wafer table 18 in the XY two-dimensional direction at a predetermined distance and the imaging of the resist image by the FIA sensor alternately, the imaging data can be taken in per each divided area. Furthermore, for example, the number of times of image loading by the FIA sensor may differ in the first area and the second area referred to earlier, and such an arrangement can reduce the measurement time.

In exposure apparatus 100 in the above embodiment, main controller 28 can achieve the measurement process automatically, by performing the optical properties measurement of the projection optical system described above according to a processing program stored in the storage device (not shown). As a matter of course, the processing program may be stored in other information storage mediums (such as a CD-ROM or a MO). Furthermore, the processing program may be downloaded from a server (not shown) upon measurement. In addition, the measurement results can be sent to the server (not shown), or can be sent outside by email or file transfer, via the Internet or an intranet.

In addition, an imaging device provided outside the exposure apparatus only for imaging (such as an optical microscope) may be used as the imaging device. In addition, when outer frame detection is performed in a method other than the image processing, alignment sensors of the LSA system can also be used. Furthermore, the optical properties of projection optical system PL can be adjusted based on the measurement results previously described (such as the best focus position), without any intervention from an operator. That is, the exposure apparatus can have an automatic adjustment function.

In addition, when the position of each divided area is not calculated using the outer frame as datums, the evaluation point corresponding area on the wafer does not have to be made up of a plurality of divided areas arranged in a matrix as is described in the above embodiment. That is, wherever the transferred image of the pattern is formed on the wafer, the score can be sufficiently obtained using the imaging data of the transferred image. In other words, the arrangement does not matter so long as the imaging data file can be made.

In addition, in the above embodiment, as an example, the dispersion (or the standard deviation) of pixel values within a designated range is employed as score E, however, the present invention is not limited to this, and an additional value or a differential sum of the pixel values within the divided area or part of the divided area (such as the designated range referred to above) may be employed as score E. In addition, the outer frame detection algorithm described in the above embodiment is a mere example, and the present invention is not limited to this. For example, by using the same border detection method described earlier in the description, at least two points each may be detected on the four sides of evaluation point corresponding area DBₙ (the upper, lower, left, and right sides). Even when such an arrangement is employed, corner detection or rectangular approximation as in the earlier description can be performed, based on at least the eight points that are detected. In addition, in the above embodiment, the case has been described where measurement pattern MPₙ is formed within the aperture pattern by a light shielding portion as is shown in FIG. 3, however, the present invention is not limited to this, and on the contrary to FIG. 3, a measurement pattern made of a light transmitting pattern may be formed within the light shielding portion.

Second Embodiment

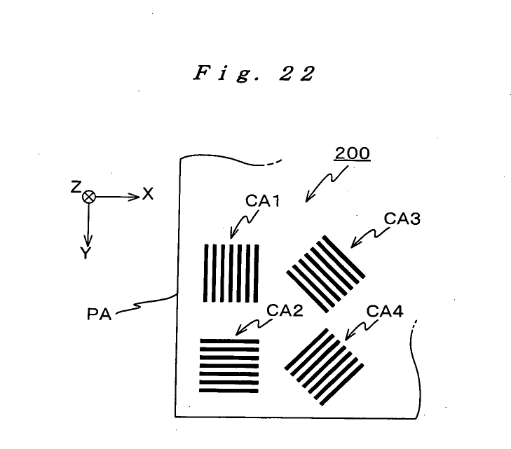

Next, a second embodiment related to the present invention will be described below, referring to FIGS. 22 to 30. In the second embodiment, the same type of exposure apparatus as exposure apparatus 100 related to the first embodiment described earlier will be used to perform optical properties measurement of projection optical system PL and exposure. The only difference in the exposure apparatus compared to exposure apparatus 100 previously described is the processing algorithm of the CPU in the main controller, and the arrangement of the remaining parts are the same as exposure apparatus 100. Accordingly, in the following description, from the viewpoint of avoiding repeating the same description, the same reference numerals will be used for the same parts, and the description thereabout will be omitted.

In the second embodiment, when the optical properties are measured, a measurement reticle (hereinafter referred to as R_{T}′) is used on which a measurement pattern 200 shown in FIG. 22 is formed as the measurement pattern. Similar to measurement reticle R_{T} previously described, a pattern area PA made up of a shielding member such as chromium is formed in the center of a glass substrate that is substantially square, and measurement pattern 200 is formed in a total of five places where light transmitting areas are formed, in the center of pattern PA (coinciding with the center of reticle R_{T}′ (reticle center)) and in the four corners. In addition, reticle alignment marks are also formed in the same manner.

Measurement pattern 200 formed in pattern area PA of measurement reticle R_{T}′ will now be described, referring to FIG. 22.

As is shown as an example in FIG. 22, measurement pattern 200 in the second embodiment is made up of four types of patterns consisting of a plurality of bar patterns (light shielding portion), that is, a first pattern CA1, a second pattern CA2, a third pattern CA3, and a fourth pattern CA4. The first pattern CA1 is a line and space (hereinafter shortened as ‘L/S’) pattern that has a predetermined line width, and its periodic direction is in the horizontal direction of the page surface (X-axis direction: a first periodic direction). The second pattern CA2 has a shape of the first pattern CA1 rotated counterclockwise at an angle of 90 degrees within the page surface, and has a second periodic direction (the Y-axis direction). The third pattern CA3 has a shape of the first pattern CA1 rotated counterclockwise at an angle of 45 degrees within the page surface, and has a third periodic direction. And, the fourth pattern CA4 has a shape of the first pattern CA1 rotated clockwise at an angle of 45 degrees within the page surface, and has a fourth periodic direction. That is, other that the different periodic directions, the patterns CA1 to CA4 are L/S patterns each formed under the same formation conditions (such as the period and duty ratio).

In addition, the second pattern CA2 is disposed below the first pattern CA1 (on the +Y side) on the page surface, the third pattern CA3 is disposed on the right side of the first pattern CA1 (on the +X side), and the fourth pattern CA4 is disposed below the third pattern CA3 (on the +Y side).

In addition, within pattern area PA of reticle R_{T}′, measurement pattern 200 is formed within the field of projection optical system PL at respective positions that correspond to a plurality of evaluation points whose optical properties need to be detected, in a state where alignment has been performed on reticle R_{T}′.

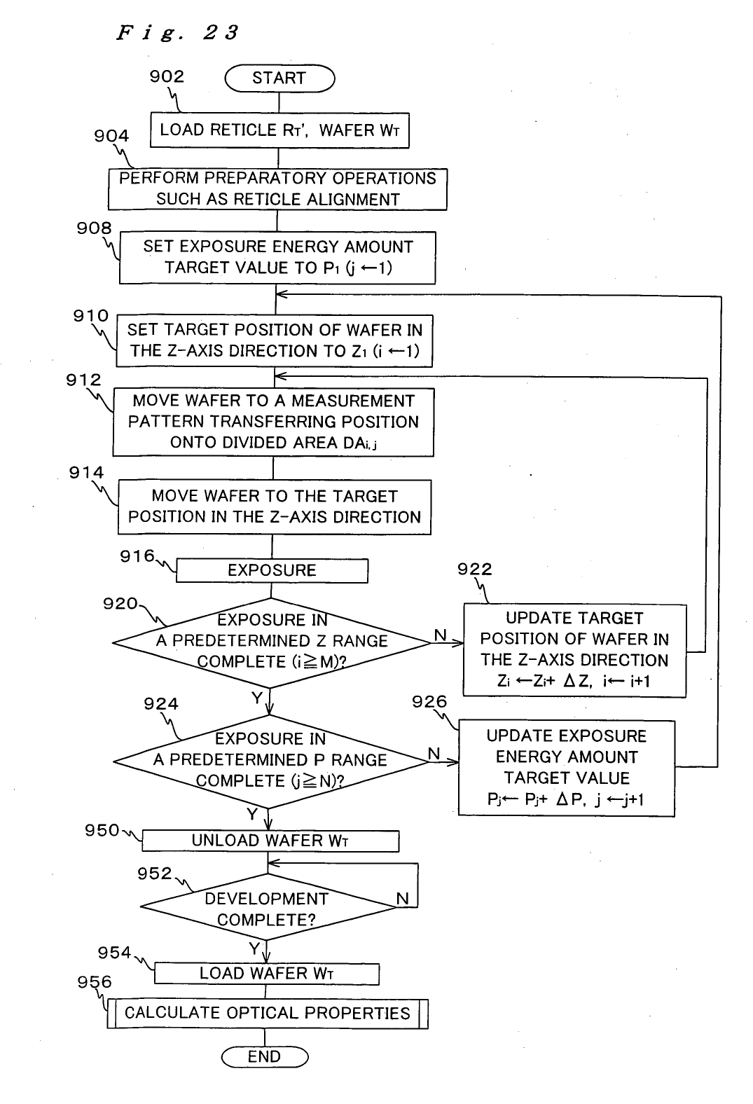

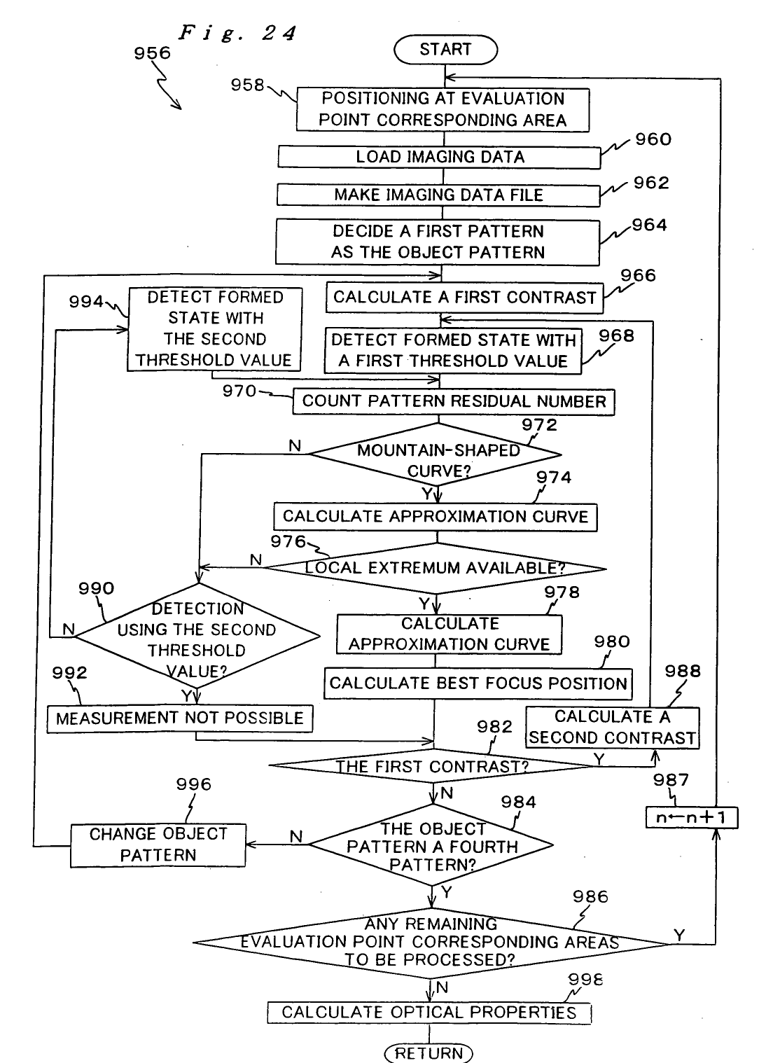

Next the optical properties measurement method of projection optical system PL in the exposure apparatus of the second embodiment will be described, according to FIGS. 23 and 24, which show a simplified processing algorithm of the CPU in main controller 28 and a flow chart, and referring to other drawings as appropriate.

First of all, in step 902 in FIG. 23, reticle R_{T}′ is loaded onto reticle stage RST in a similar manner as in step 402 previously described, and wafer W_{T} is loaded onto wafer table 18. On the surface of wafer W_{T}, a photosensitive layer is formed with a positive type photoresist.

In the next step, step 904, the predetermined preparatory operations such as reticle alignment and setting the reticle blind are performed, in the same procedure as in step 404 described earlier.

In the next step, step 908, the target value of the exposure energy amount is initialized, as in step 408 previously described. That is, along with setting the target value of the exposure energy amount, counter j, which is used for setting the movement target position of wafer W_{T} in the row direction upon exposure, is initialized to ‘1’, and target value Pⱼ of the exposure energy amount is set to P₁ (j←1). And, in this embodiment as well, the exposure energy amount is to vary from P₁ to P_{N} (for example, N=23) by a scale of ΔP (Pⱼ=P₁ to P₂₃)

In the next step, step 910, the target value of the focus position of wafer W_{T} (the position in the Z-axis direction) is initialized, as in step 410 previously described. That is, along with setting the target value of the focus position of wafer W_{T}, counter i, which is used for setting the movement target position of wafer W_{T} in the column direction upon exposure, is initialized to ‘1’, and target value Zᵢ of the focus position of wafer W_{T} is set to Z₁ (i←1). And, in this embodiment as well, the focus position of wafer W_{T} varies from Z₁ to Z_{M} (for example, M=13) by a scale of ΔZ (Zᵢ=Z₁ to Z₁₃).

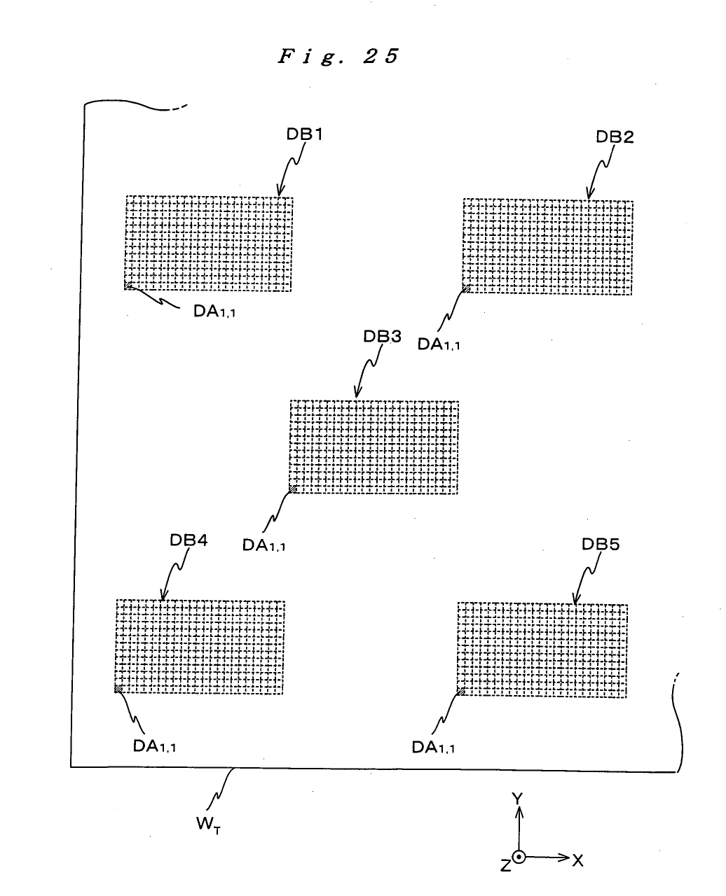

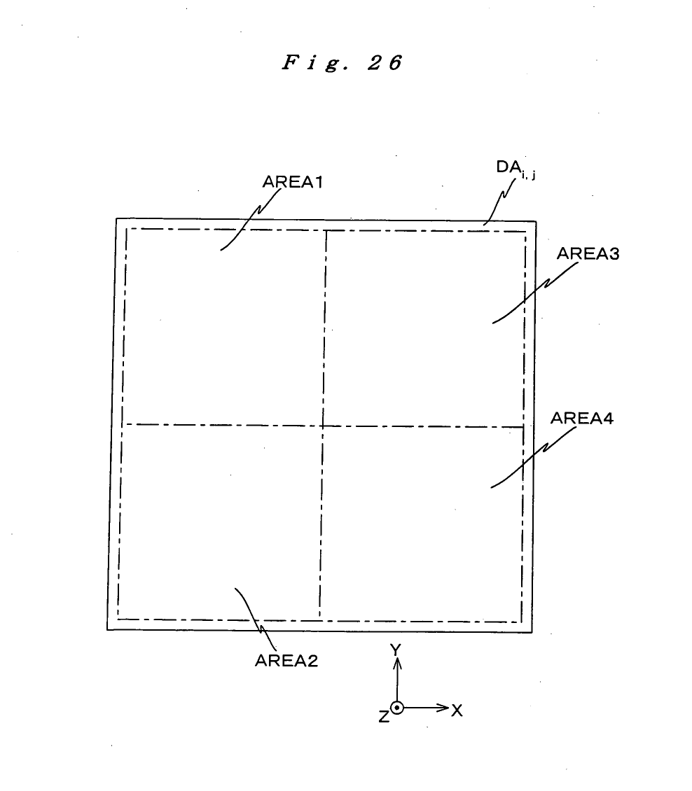

Accordingly, in the second embodiment, exposure is performed N×M times (for example, 23×13=299), so that measurement pattern 200ₙ (n=1 to 5) is sequentially transferred onto wafer W_{T} while respectively changing the position of wafer W_{T} in the optical axis direction of projection optical system PL and the energy amount of pulse illumination light IL irradiated on wafer W_{T}. On areas DB1 to DB5 on wafer W_{T} that correspond to each of the evaluation points within the field of projection optical system PL (hereinafter referred to as ‘evaluation point corresponding area’), N×M measurement patterns 200ₙ are to be transferred, as is shown in FIG. 25. Evaluation point corresponding areas DB1 to DB5 correspond to a plurality of evaluation points within the field of projection optical system PL whose optical properties are to be detected. Therefore, in this embodiment, in order to make data processing efficient, each of the evaluation point corresponding areas DB1 to DB5 are divided virtually into N×M matrix-shaped divided areas, and each divided area will be expressed as DA_{i, j} (i=1 to M, j=1 to N). As in the first embodiment, divided areas DA_{i, j} are arranged so that the +X direction is the row direction (the increasing direction of j) and the +Y direction is the column direction (the increasing direction of i). In addition, the subscripts ᵢ and ⱼ, and _{M} and _{N} used in the description below will have the same meaning as the description above.

Referring back to FIG. 23, in the next step, step 912, XY stage 20 (wafer W_{T}) is moved, as in step 412 described earlier, to a position where the image of measurement pattern 200ₙ is to be transferred; to virtual divided area DA_{i, 1} in each of the evaluation point corresponding areas DBn (n=1 to 5) (in this case, DA_{1, 1} (refer to FIG. 25) on wafer W_{T}.

In the next step, step 914, wafer table 18 is finely driven in the Z-axis direction and the direction of inclination, so that the focus position of wafer W_{T} coincides with target value Zᵢ that is set (in this case, Z₁), as in step 414 previously described.

Then, exposure is performed in the next step, step 916. In this case, exposure amount control is performed so that the exposure energy amount (exposure amount) at one point on wafer W_{T} matches the target value that has been set (in this case, P₁). As the control method of the exposure energy amount, the first to third methods that are described earlier in the description can be employed independently, or they can be appropriately combined.

With such operations, the images of measurement pattern 200ₙ are transferred onto divided area DA_{1, 1} of each of the evaluation point corresponding areas DB1 to DB5 on wafer W_{T}, as is shown in FIG. 25.

In the next step, step 920, the judgment is made whether exposure in the predetermined Z range has been completed by judging whether the target value of the focus position of wafer W_{T} is Z_{M} or over. In this case, because exposure has only been completed at only the first target value Z₁, the step then moves onto step 922 where counter i is incremented by 1 (i←i+1) and ΔZ is added to the target value of the focus position of wafer W_{T} (Zᵢ←Z+ΔZ). In this case, the target value of the focus position is changed to Z₂ (=Z₁+ΔZ), and then the step returns to step 912. In step 912, XY stage 20 is moved a predetermined step pitch in a predetermined direction (in this case, the −Y direction) within the XY plane, so that the position of wafer W_{T} is set at divided area DA_{2, 1} of each of the evaluation point corresponding areas DB1 to DB5 on wafer W_{T} where the image of measurement patterns 200ₙ are each transferred.

And, in the next step, step 914, wafer table 18 is stepped by ΔZ in the direction of optical axis AXp so that the focus position of wafer W_{T} coincides with target value (in this case, Z₂), and in step 916, exposure is performed as is previously described, and the image of measurement patterns 200ₙ are each transferred onto divided area DA_{2, 1} of each of the evaluation point corresponding areas DB1 to DB5 on wafer W_{T}.

Hereinafter, until the judgment in step 920 turns out positive, that is, until the target value of the focus position of wafer W_{T} set at this point reaches Z_{M}, the loop processing of steps 920→922→912→914→916 (including decision making) is repeatedly performed. With this operation, measurement patterns 200ₙ are transferred respectively onto divided areas DA_{i, 1} (i=3 to M) of each of the evaluation point corresponding areas DB1 to DB5 on wafer W_{T}.

Meanwhile, when exposure of divided area DA_{M, 1} is completed, and the judgment in step 920 above turns out positive, the step then moves to step 924 where the judgment is made whether the target value of the exposure energy amount set at that point is P_{N} or over. In this case, because the target value of the exposure energy amount set at that stage is P₁, the decision making in step 924 turns out negative, therefore, the step moves to step 926.

In step 926, counter j is incremented by 1 (j←j+1) and ΔP is added to the target value of the exposure energy amount (Pⱼ←Pⱼ+ΔP). In this case, the target value of the exposure energy amount is changed to P₂ (=P₁+ΔP), and then the step returns to step 910.

Then, in step 910, when the target value of the focus position of wafer W_{T} has been initialized, the loop processing of steps 912→914→916→920→922 is repeatedly performed. This loop processing continues until the judgment in step 920 turns positive, that is, until exposure in the predetermined focus position range (Z₁ to Z_{M}) of wafer W_{T} with the exposure energy amount at target value P₂ is completed. With this operation, measurement patterns 200ₙ are transferred respectively onto divided area DA_{i, 2} (i=1 to M) of each of the evaluation point corresponding areas DB1 to DB5 on wafer W_{T}.

Meanwhile, when exposure is completed at target value P₂ of the exposure energy amount in the predetermined focus position range (Z₁ to Z_{M}) of wafer W_{T}, the decision in step 920 turns positive, and the step moves to step 924 where the judgment is made whether the target value of the exposure energy amount is equal to or exceeds P_{N}. In this case, since the target value of the exposure energy amount is P₂, the decision in step 924 turns out to be negative, and the step then moves to step 926. Then, in step 926, counter j is incremented by 1 and ΔP is added to the target value of the exposure energy amount (Pⱼ←Pj+ΔP). In this case, the target value of the exposure energy amount is changed to P₃, and then the step returns to step 910. Hereinafter, processing (including decision making) similar to the one referred to above is repeatedly performed.

When exposure at the predetermined exposure energy range (P₁ to P_{N}) is completed in the manner described above, the decision in step 924 turns positive and the step moves onto step 950. By the operation above, in each of the evaluation point corresponding area DBn on wafer W_{T}, as is shown in FIG. 25, N×M (as an example, 23×13=299) transferred images (latent images) of measurement pattern MPₙ are formed under different exposure conditions.

In step 950, wafer W_{T} is unloaded from wafer stable 18 via the wafer unloader (not shown) and also carried to the coater developer (not shown), which is inline connected to the exposure apparatus, using the wafer carrier system.

After wafer W_{T} is carried to the above coater developer, the step then moves on to step 952 where the step is on hold until the development of wafer W_{T} has been completed. During the waiting period in step 952, the coater developer develops wafer W_{T}. When the development is completed, resist images of evaluation point corresponding areas DBₙ (n=1 to 5) having rectangular shapes are formed on wafer W_{T}, as is shown in FIG. 25, and wafer W_{T} on which the resist images are formed will be used as a sample for measuring the optical properties of projection optical system PL.

In the waiting state in the above step 952, when the notice from the control system of the coater developer (not shown) that the development of wafer W_{T} has been completed is confirmed, the step then moves to step 954 where instructions are sent to the wafer loader (not shown) so as to reload wafer W_{T} on wafer table 18 as is described in step 902, and then the step moves on to step 956 where a subroutine to calculate the optical properties of the projection optical system (hereinafter also referred to as ‘optical properties measurement routine’) is performed.

In the optical properties measurement routine, first of all, in step 958 in FIG. 24, wafer W_{T} is moved to a position where the resist image of the above evaluation point corresponding area DBₙ on wafer W_{T} can be detected with alignment detection system AS, referring to a counter n, as in step 502 previously described. In this case, counter n is initialized at n=1. Accordingly, in this case, wafer W_{T} is set at a position where the resist image of the above evaluation point corresponding area DB1 on wafer W_{T} shown in FIG. 25 can be detected with alignment detection system AS. In the following description regarding the optical properties measurement routine, the resist image of evaluation point corresponding area DBₙ will be summed up as ‘evaluation point corresponding area DBₙ’ as appropriate.

In the next step, step 960, the resist image of evaluation point corresponding area DBₙ (in this case DB1) on wafer W_{T} is picked up using the FIA sensor of alignment detection system AS, and the imaging data is taken in. And, also in the case of the second embodiment, with the imaging data consisting of a plurality of pixel data supplied from the FIA sensor, the value of the pixel data becomes larger when the shade of the resist image becomes more intense (close to black).

In addition, in this case, the case has been described where the resist image formed in evaluation point corresponding area DB1 has been picked up at once, however, for example, when the resolution of the imaging data needs to be improved, the magnification of the FIA sensor of alignment detection system AS may be increased, and by sequentially repeating the stepping operation of moving wafer table 18 in the XY two-dimensional direction at a predetermined distance and the imaging of the resist image by the FIA sensor alternately, the imaging data can be taken in per each divided area.

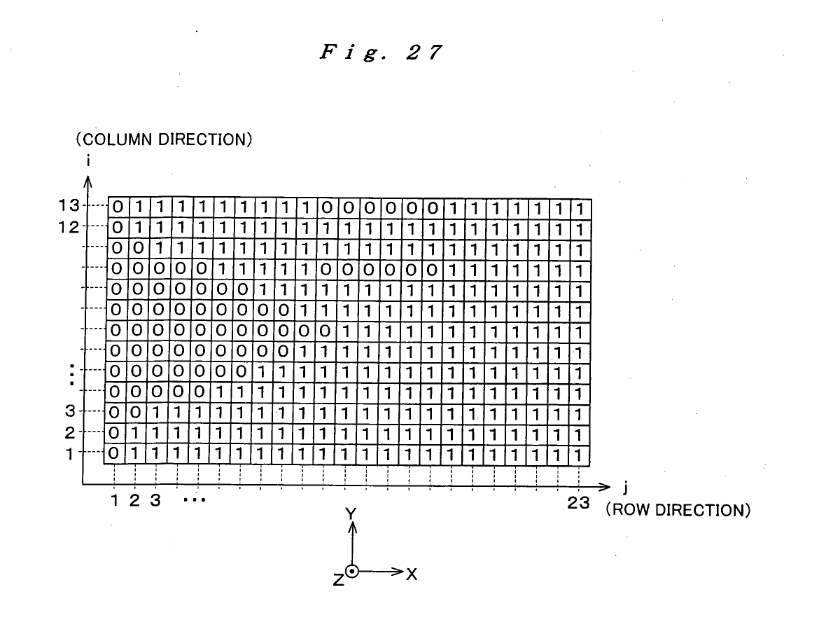

In the next step, step 962, the imaging data of the resist image formed in evaluation point corresponding area DBn (in this case DB1) from the FIA sensor is organized, and an imaging data file of each divided area DA_{i, j} is made for each of the patterns CA1 to CA4. That is, since the images of the four patterns CA1 to CA4 are transferred onto each divided area DA_{i, j}, divided area DA_{i, j} is further divided into four rectangular shaped areas as is shown in FIG. 26, and the imaging data file is made with the pixel data within AREA 1; the first area where the image of pattern CA1 is transferred serving as the imaging data of pattern CA1, the pixel data within AREA 2; the second area where the image of pattern CA2 is transferred serving as the imaging data of pattern CA2, the pixel data within AREA 3; the third area where the image of pattern CA3 is transferred serving as the imaging data of pattern CA3, and the pixel data within AREA 4; the fourth area where the image of pattern CA4 is transferred serving as the imaging data of pattern CA4.

Returning back to FIG. 24, in the next step, step 964, the object pattern is set to the first pattern CA1, and the imaging data of the first pattern CA1 in each divided area DA_{i, j} is extracted from the imaging data file.

In the next step, step 966, all the pixel data included within the first area AREA1 are added up for each divided area DA_{i, j} and the contrast is obtained as the representative value related to the pixel data, and the additional value (addition results) is to be expressed as a first contrast K1_{i, j} (i=1 to M, j=1 to N).

In the next step, step 968, the formed state of the image of the first pattern CA1 is detected for each divided area DA_{i, j}, based on the first contrast K1_{i, j}. Various ways of detecting the formed state of the image can be considered, however, in the second embodiment, the focus will be on whether the image of the pattern is formed within the divided area or not as in the first embodiment. That is, the first contrast K1_{i, j} of the first pattern CA1 of each divided area DA_{i, j} is compared with a predetermined first threshold value S1 to detect whether the image of the first pattern CA1 can be located in each divided area. In this case, when the first contrast K1_{i,j} is equal to or more than the first threshold value S1, the judgment is made that the image of the first pattern CA1 is formed and the judgment value F1_{i, j} (i=1 to M, j=1 to N) that serve as the detection results are set to ‘0’. Meanwhile, when the first contrast K1_{i, j} is less than the first threshold value S1, the judgment is made that no image of the first pattern CA1 is formed and the judgment value F1_{i, j} that serve as the detection results are set to ‘1’. According to such detection, detection results such as the one shown in FIG. 27 can be obtained for the first pattern CA1. Such detection results are stored in the storage device (not shown). The first threshold value S1 is a value set in advance, and it can also be changed by the operation via the input/output device (not shown).

Referring back to FIG. 24, in step 970, the number of divided areas that have the image of the pattern formed is obtained per each focus position as in the first embodiment, based on the above detection results. That is, the number of divided areas whose judgment value is ‘0’ is counted per each focus position, and the counted results are expressed as a pattern residual number Tᵢ (i=1 to M). On such counting, the so-called skipping area whose value is different from its periphery is to be ignored. For example, in the case of FIG. 27, the focus position and pattern residual number on wafer W_{T} are as follows: pattern residual number T₁=1 at focus position Z₁, T₂=1 at Z₂, T₃=2 at Z₃, T₄=5 at Z₄, T₅=7 at Z₅, T₆=9 at Z₆, T₇=11 at Z₇, T₈=9 at Z₈, T₉=7 at Z₅, T₁₀=5 at Z₁₀, T₁₁=2 at Z₁₁, T₁₂=1 at Z₁₂, and T₁₃=1 at Z₁₃. The relation between the focus position and pattern residual number Tᵢ can be obtained in the manner described above.

In this case as well, in order to reduce the influence that the skipping areas have on the detection results of pattern residual number Tᵢ, the filtering process, which is previously described, may be performed.

Referring back to FIG. 24, in the next step, step 972, the above relation between the focus position and pattern residual number Tᵢ is checked to see if it has a mountain-shaped curve. For example, when detection results shown in FIG. 27 have been obtained for the first pattern CA1, because in the center focus position (=Z₇) the pattern residual number T₇ is 11 and at the focus position on both edges (=Z₁ and Z₁₃) the pattern residual numbers (T₁ and T₁₃) are 1, the judgment is made that the results show a mountain-shaped curve (the judgment in step 972 is positive), which takes the step to step 974.

In step 974, the relation between the focus position and the exposure energy amount is obtained from the relation between the focus position and pattern residual number Tᵢ. That is, pattern residual number Tᵢ is converted into exposure energy amount. In this case as well, for the same reasons as in the first embodiment, pattern residual number Tᵢ can be regarded proportional to the exposure energy amount.

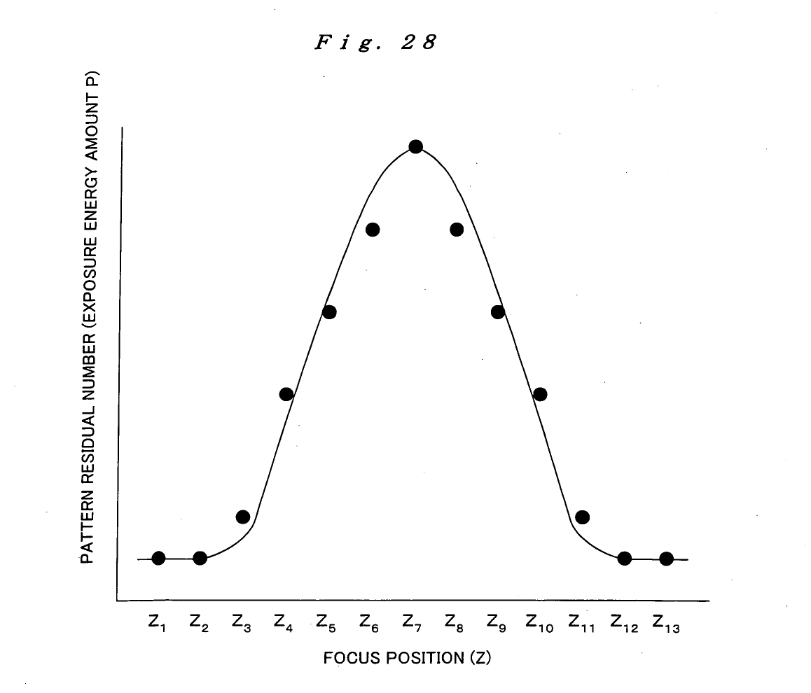

Accordingly, the relation between the focus position and the exposure energy amount shows the same tendency as the relation between the focus position and pattern residual number Tᵢ (refer to FIG. 28).

In the next step, step 974 in FIG. 24, a high order approximation curve (for example, a fourth to sixth order curve) such as the one shown in FIG. 28 that shows the correlation between the focus position and the exposure energy amount is obtained, based on the above relation between the focus position and the exposure energy amount.

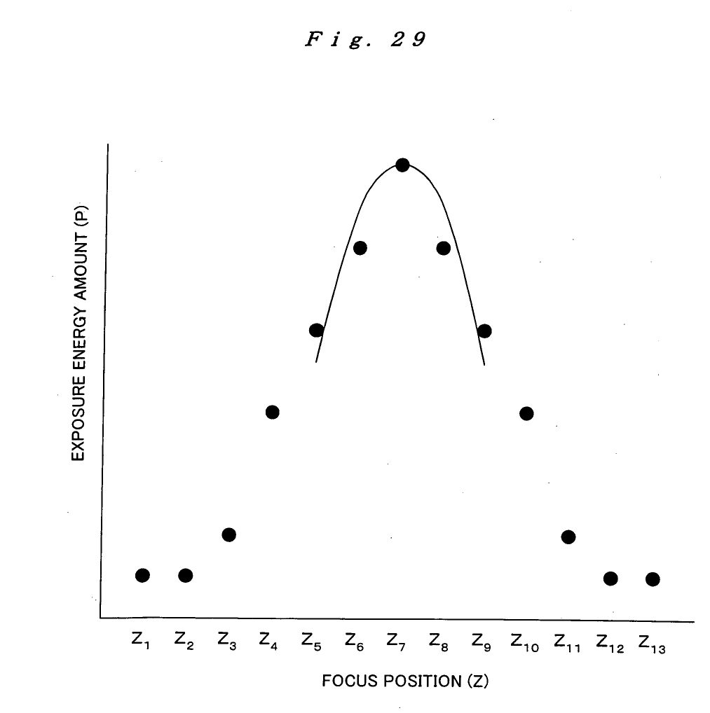

In the next step, step 976, the judgment is made whether a local extremum of a certain level can be obtained or not in the above approximation curve. And, when the decision is approved, that is, when the local extremum can be obtained, the step then moves on to step 978 where a high order approximation curve (for example, a fourth to sixth order curve) denoting the correlation between the focus position and the exposure energy amount is obtained again, centering on the local extremum and its vicinity, such as in FIG. 29.

Then, in the next step, step 980, the extremum value of the above high order approximation curve is obtained, and the focus position in that case is set as the best focus position and stored in the storage device (not shown). This allows the best focus position of the first pattern CA1 to be obtained based on the first contrast K1_{i, j}.

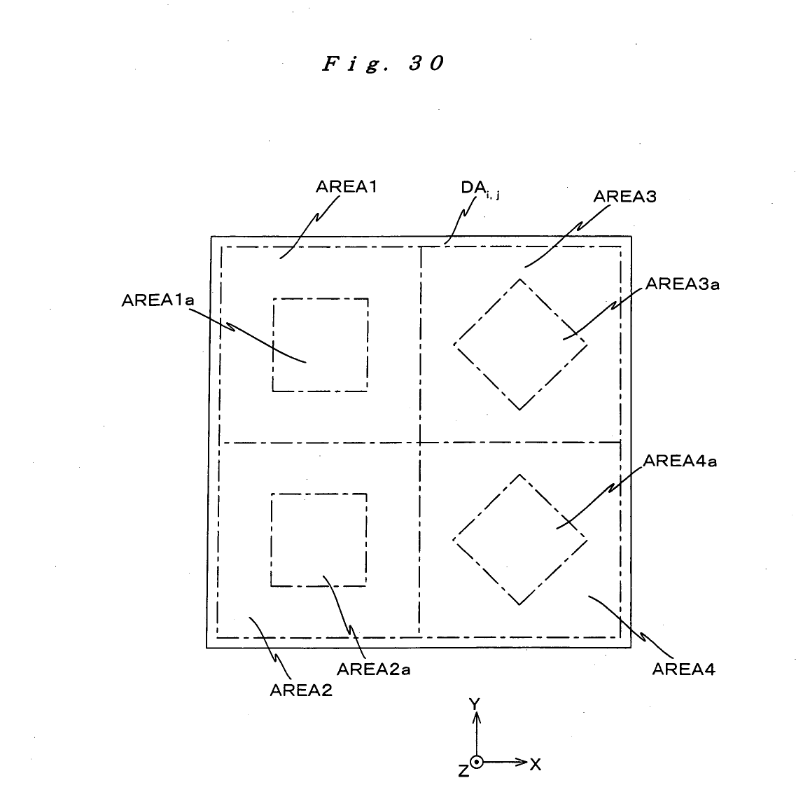

In the next step, step 982, the judgment is made whether the contrast used for detecting the formed state of the image is the first contrast K1_{i,j} or not. And, when the decision turns out to be positive, that is, when the contrast is the first contrast K1_{i, j}, the step then moves on to step 988 where a second contrast of the object pattern in each divided area DA_{i, j}, in this case the first pattern CA1, is obtained. To be more specific, the imaging data of the first pattern CA1 is extracted from the imaging data file. And, for each divided area DA_{i, j}, as is shown in FIG. 30, all the pixel data included in a first sub-area AREA1a, which is around ¼^{th} of the first area AREA1 and is set in the center of the first area AREA1, is added and the contrast serving as the representative value related to the pixel data is obtained, and the additional value (addition results) is to be expressed as the second contrast K2_{i, j} (i=1 to M, j=1 to N). That is, the contrast is obtained, excluding the imaging data of the line patterns on both edges of the L/S pattern making up the first pattern CA1. Accordingly, the size of the first sub-area AREA1a is decided depending on the size of the first pattern CA1.

Then, the step returns to step 968 in FIG. 24, and in the manner previously described, the processing and decision making in steps 968→970→972→974→976→978→980 (including decision making) are repeatedly performed, using the second contrast K2_{i, j} instead of the first contrast K1_{i, j}. In this manner, the best focus position of the first pattern CA1 can be obtained based on the second contrast K2_{i, j}.

Meanwhile, when the judgment in step 982 turns out to be negative, that is, when the contrast used for detecting the formed state of the image is not the first contrast K1_{i, j}, the judgment is made that the processing related to the subject pattern, in this case, the first pattern CA1, has been completed, and the step then moves to step 984.

In step 984, the judgment is made whether the object pattern on which the processing has been completed is the fourth pattern CA4 or not. In this step, because the object pattern on which the processing has been completed is the first pattern CA1, the decision made in step 984 is negative, and the step moves to step 996 where the object pattern is changed to the next object pattern, in this case, the second pattern CA2, and then the step returns to step 966.

In step 966, the first contrast K1_{i, j} of the object pattern, in this case, the second pattern CA2, is calculated for each divided area DA_{i,j} as in the case of the first pattern previously described. With this operation, the representative value of all the pixel data included within the second area AREA2 is calculated as the first contrast K1_{i, j} of the second pattern CA2.

And, in the same manner as in the first pattern CA1 previously described, the processing and decision making in steps 968→970→972→974→976→978→980 are repeatedly performed. In this manner, the best focus position of the second pattern CA2 can be obtained based on the first contrast K1_{i, j}.

In the next step, step 982, the judgment is made whether the contrast used for detecting the formed state of the image is the first contrast K1_{i, j} or not, however since in this case the first contrast K1_{i, j} is used, therefore, the decision here is positive, and the step moves on to step 988 where the second contrast of the object pattern in each divided area DA_{i, j}, in this case the second pattern CA2, is calculated in the manner previously described. With such operation, for each divided area DA_{i, j}, as is shown in FIG. 30, the representative value of all the pixel data included within a second sub-area AREA2a, which is around ¼^{th} of the second area AREA2 and is set in the center of the second area AREA2, is calculated as the second contrast K2_{i, j} (i=1 to M, j=1 to N).

Then, the step returns to step 968 where the processing and decision making in steps 968→970→972→974→976→978→980 are repeatedly performed using the second contrast K2_{i, j} in the same manner as before. In this manner, the best focus position of the second pattern CA2, which is the object pattern, can be obtained based on the second contrast K2_{i, j}.

Meanwhile, when the processing in the second pattern CA2 is completed in the manner described above, the judgment in step 982 results negative, and the step moves on to step 984.

In step 984, the judgment is made whether the object pattern on which the processing has been completed is the fourth pattern CA4 or not. In this step, because the object pattern on which the processing has been completed is the second pattern CA2, the decision made in step 984 is negative, and the step moves to step 996 where the object pattern is changed to the next object pattern, in this case, the third pattern CA3, and then the step returns to step 966.

In step 966, the first contrast K1_{i, j} of the object pattern, in this case, the third pattern CA3, is calculated for each divided area DA_{i, j} as in the cases previously described. With this operation, the representative value of all the pixel data included within the third area AREA3 is calculated as the first contrast K1_{i, j} of the third pattern CA3.

Then, the processing and decision making in steps 968→970→972→974→976→978→980 are repeatedly performed. In this manner, the best focus position of the third pattern CA3 can be obtained based on the first contrast K1_{i, j}.

In the next step, step 982, the judgment is made whether the contrast used for detecting the formed state of the image is the first contrast K1_{i, j} or not, however since in this case the first contrast K1_{i, j} is used, therefore, the decision here is positive, and the step moves on to step 988 where the second contrast of the object pattern in each divided area DA_{i, j}, in this case the third pattern CA3, is calculated in the manner previously described. With such operation, for each divided area DA_{i, j}, as is shown in FIG. 30, the representative value of all the pixel data included within a third sub-area AREA3a, which is around ¼^{th} of the third area AREA3 and is set in the center of the third area AREA3, is calculated as the second contrast K2_{i, j}(i=1 to M, j=1 to N).

Then, the step returns to step 968 where the processing and decision making in steps 968→970→972→974→976→978→980 are repeatedly performed using the second contrast K2_{i, j} in the same manner as before. In this manner, the best focus position of the third pattern CA3, which is the object pattern, can be obtained based on the second contrast K2_{i, j}.

Meanwhile, when the processing in the third pattern CA3 is completed in the manner described above, the judgment in step 982 results negative, and the step moves on to step 984.

In step 984, the judgment is made whether the object pattern on which the processing has been completed is the fourth pattern CA4 or not. In this step, because the object pattern on which the processing has been completed is the third pattern CA3, the decision made in step 984 is negative, and the step moves to step 996 where the object pattern is changed to the next object pattern, in this case, the fourth pattern CA4, and then the step returns to step 966.

In step 966, the first contrast K1_{i, j} of the object pattern, in this case, the fourth pattern CA4, is calculated for each divided area DA_{i, j} as in the cases previously described. With this operation, the representative value of all the pixel data included within the fourth area AREA4 is calculated as the first contrast K1_{i, j} of the fourth pattern CA4.

Then, the processing and decision making in steps 968→970→972→974→976→978→980 are repeatedly performed. In this manner, the best focus position of the fourth pattern CA4 can be obtained based on the first contrast K1_{i, j}.

In the next step, step 982, the judgment is made whether the contrast used for detecting the formed state of the image is the first contrast K1_{i, j} or not, however since in this case the first contrast K1_{i, j} is used, therefore, the decision here is positive, and the step moves on to step 988 where the second contrast of the object pattern in each divided area DA_{i, j}, in this case the fourth pattern CA4, is calculated in the manner previously described. With such operation, for each divided area DA_{i, j}, as is shown in FIG. 30, the representative value of all the pixel data included within a fourth sub-area AREA4a, which is around ¼^{th} of the fourth area AREA4 and is set in the center of the fourth area AREA4, is calculated as the second contrast K2_{i, j} (i=1 to M, j=1 to N)

Then, the step returns to step 968 where the processing and decision making in steps 968→970→972→974→976→978→980 are repeatedly performed using the second contrast K2_{i, j} in the same manner as before. In this manner, the best focus position of the fourth pattern CA4, which is the object pattern, can be obtained based on the second contrast K2_{i, j}.

Meanwhile, when the processing in the fourth pattern CA4 is completed in the manner described above, the judgment in step 982 results negative, then further in step 984 the judgment turns out to be positive, and the step moves on to step 986. In step 986, the judgment is made whether there are any evaluation point corresponding areas left that have not been processed, referring to counter n previously described. In this case, since the processing has been completed for only evaluation point corresponding area DB1, the decision here is affirmative, therefore the step moves to step 987 where counter n is incremented by 1 (n←n+1), and then the step returns to step 958 where the position of wafer W_{T} is set at a location where evaluation point corresponding area DB2 can be detected with alignment detection system AS, referring to counter n.

Hereinafter, the processing and decision making from step 958 onward are repeated, and as in the case of evaluation point corresponding area DB1, the best focus position is obtained for each of the first pattern to fourth pattern in evaluation point corresponding area DB2, based on the first contrast and the second contrast.

Then, when the processing on the fourth pattern CA4 of evaluation point corresponding area DB2 is completed, the judgment in step 984 is affirmed, and the step then moves to step 986 where the judgment is made whether there are any evaluation point corresponding areas left that have not been processed, referring to counter n previously described. In this case, since the processing has been completed for only evaluation point corresponding areas DB1 and DB2, the decision here is affirmative, therefore the step moves to step 987 where counter n is incremented by 1 (n<n+1), and then the step returns to step 958. Hereinafter, the processing and decision making from step 958 onward are repeated, so that the best focus position is obtained for each of the first pattern to fourth pattern in the remaining evaluation point corresponding areas DB3 to DB5 based on the first contrast and the second contrast, as in the case of evaluation point corresponding area DB1.

On the other hand, when the decision in the above step, step 976, turns out to be negative, that is, when it is decided that a local extremum of a certain level cannot be obtained in the above approximation curve, the step then moves onto step 990 where the judgment is made whether the threshold value used to detect the formed state of the image was a second threshold value S2 or not. And, when the decision in step 990 is negative, that is, when the threshold value used in detecting the formed state was the first threshold value S1, the step then moves to step 994 where the formed state of the image is detected using the second threshold value S2 (≠the first threshold value S1). As in the case of the first threshold value S1, the second threshold value S2 is also set in advance, and it can be changed by the operator by the input/output deice (not shown). In step 994, the formed state of the image is detected according to the same procedure as in step 968 previously described. And, when the formed state of the image has been detected in step 994, the step then moves on to step 970 where the same processing and decision making described earlier are repeated.

Meanwhile, when the decision made is positive in the above step, step 990, that is, when the threshold value used to detect the formed state of the image was the second threshold value S2, the step then moves on to step 992 where it is decided that measurement is not possible, and the information (that measurement is not possible) is stored in the storage device (not shown) as the detection results, then, the step moves onto step 982.

Furthermore, contrary to the description that has been made earlier, when the decision in step 972 has been denied, that is, when it is decided that a mountain-shaped curve cannot be confirmed in the relation between the focus position and pattern residual number Ti, the step then moves on to step 990 where from there onward, the same processing and decision making are performed as is previously described.

When the calculation of the best focus position or the decision of not being able to perform measurement has been completed for all the measurement point corresponding areas DB1 to DB5 on wafer W_{T} in the manner described above, the decision in step 986 turns negative, and the step then moves on to step 998 where other optical properties are calculated, for example, in the following manner based on the best focus position data obtained in the operations above.

More specifically, for example, the average value (a simple average value or a weighting average value) of the best focus position obtained from the second contrast of each pattern CA1 to CA4 is calculated for each evaluation point corresponding area, and is determined as the best focus potion of each evaluation point within the field of projection optical system PL, as well as the curvature of field of projection optical system PL being calculated, based on the calculation results of the best focus position.

In addition, for example, astigmatism is obtained, from the best focus position obtained from the second contrast of the first pattern CA1 and the best focus position obtained from the second contrast of the second pattern CA2, as well as from the best focus position obtained from the second contrast of the third pattern CA3 and the best focus position obtained from the second contrast of the fourth pattern CA4. And, from their average value, the astigmatism at each evaluation point within the field of projection optical system PL is obtained.

Furthermore, for example, for each evaluation point within the field of projection optical system PL, by performing approximation by the least squares method based on the astigmatism calculated in the manner described above, regularity within the astigmatism surface is obtained, and also from the regularity within the astigmatism surface and the curvature of field, the total focus difference is obtained.

In addition, for example, for each of the patterns CA1 to CA4, the influence of the coma of the projection optical system is obtained from the difference between the best focus position obtained from the first contrast and the best focus position obtained from the second contrast, as well as the relation between the periodic direction of the pattern and the influence of the coma being obtained.

The optical properties data obtained in the manner described above are stored in the storage device (not shown), and are also shown on the screen of the display device (not shown).

The processing in step 956 in FIG. 23 is completed in this manner, and the series of processes measuring the optical properties is completed.

Exposure operations by the exposure apparatus in the second embodiment in the case of device manufacturing are performed in the same manner as in exposure apparatus 100 of the first embodiment; therefore, the description here will be omitted.

As is described so far, according to the optical properties measurement method related to the second embodiment, since the image processing method is used where the formed state of the image is detected by comparing the contrast serving as a representative value related to the pixel data of the area where the image is transferred with the predetermined threshold value, the time required to detect the formed state of the image can be reduced when compared with the case where the measurement is performed visually in the conventional method (such as the CD/focus method referred to earlier).

In addition, since an objective and quantitative detection method called image processing is used, the formed state of the pattern image can be detected with good accuracy compared with the conventional measurement method. And, because the best focus position is decided based on the detection results of the objective and quantitative detection of the formed state, it becomes possible to obtain the best focus position within a shorter period of time and with good accuracy. Accordingly, the measurement precision and the reproducibility of the measurement results of the optical properties decided based on the best focus position can be improved, which, as a consequence, can improve the throughput in the optical properties measurement.

In addition, because the measurement pattern can be smaller compared with the conventional measurement method (such as the CD/focus method or the SMP focus measurement method referred to earlier), many measurement patterns can be arranged within pattern area PA of the reticle. Accordingly, the number of evaluation points can be increased, and the spacing in between each of the evaluation points can also be narrowed, which as a consequence, makes it possible to improve the measurement precision of the optical properties measurement.

In addition, in the second embodiment, because the formed state of the image of the measurement pattern is detected by comparing the contrast of the area where the image is transferred and the predetermined threshold value, there is no need to arrange patterns other than the measurement patterns (for example, fiducial patterns for comparison, or mark patterns for position setting) within pattern area PA of reticle R_{T}. Accordingly, the evaluation points can be increased, and it also becomes possible to narrow the spacing between each evaluation point. With such an arrangement, as a consequence, the measurement precision and the reproducibility of the measurement results of the optical properties can be improved.

According to the optical properties measurement method related to the second embodiment, because the best focus position is calculated based on an objective and conclusive method such as approximation curve calculation by statistical processing, the optical properties can be measured stably with high precision, without fail. And, depending on the order of the approximation curve, the best focus position can be calculated, based on the inflection point or on a plurality of intersecting points of the approximation curve with a predetermined slice level.

In addition, according to the exposure method related to the second embodiment, because the focus control target value upon exposure is set taking into consideration the best focus position decided in the manner described above, color variation occurring due to a defocused state can be effectively suppressed, which makes it possible to transfer fine patterns on the wafer with high precision.

Furthermore, in the second embodiment, the first contrast has a high S/N ratio since it is the additional value of pixel data of the entire area where the image of the pattern is transferred, therefore, the relation between the formed state of the image and exposure conditions can be obtained with good precision.

In addition, in the second embodiment, because the pixel data of the line patterns located on both edges of the line patterns making up the L/S pattern are excluded from the pixel data of the area where the image of the L/S pattern is transferred in the second contrast, the influence of coma of the projection optical system to the detection results of the formed state of the image can be omitted, and the optical properties can be obtained with good accuracy.

Moreover, from the difference of the best focus position based on the first contrast and the best focus position based on the second contrast, the influence of coma, which is one of the optical properties of the projection optical system, can be extracted.

In the above second embodiment, measurement pattern 200ₙ formed on reticle R_{T}′ has been described as four types of L/S patterns that are only different in the periodic direction, however, as a matter of course, the present invention is not limited to this. As the measurement pattern, either a dense pattern or an isolated pattern may be used, or both patterns may be used together, or the pattern may be at least one type of an L/S pattern, for example, only one type of an L/S pattern. Or, an isolated line and a contact hole may be used as the pattern. When the L/S pattern is used as the measurement pattern, the duty ratio and the periodic direction may be optional. In addition, when a periodic pattern is used as the measurement pattern, the periodic pattern does not necessarily have to be an L/S pattern, and for example, may be a pattern that has dot marks periodically arranged. This is because the formed state of the image is detected by contrast, rather than measuring the line width as in the conventional method.

In addition, in the above second embodiment, the best focus position is obtained for two types of contrasts (both the first contrast and the second contrast); however, the best focus position may be obtained by either one of the contrasts.

Furthermore, in the above second embodiment, the pixel data where the pattern is formed is described to be greater than where the pattern is not formed, however, the present invention is not limited to this. In addition, in the above embodiment, the contrast is obtained from the additional value of the pixel data, however, the present invention is not limited to this, and for example, the differential sum, dispersion, or standard deviation of the pixel data can be calculated, and the calculation results may be the contrast. And, for example, the pixel data of the area where the pattern does not remain may serve as datums, and the pattern availability can be judged when the contrast deviates to black or white.

In the above second embodiment, the representative value related to the pixel data (score) may be employed as the second contrast. In this case, as the representative value (score) for performing pattern availability judgment, the variation of pixel values within each area (in the case of the above embodiment, the first area AREA1 to the fourth area AREA4) can be used. For example, dispersion (or standard deviation, additional value, differential sum, or the like) of the pixel value in the designated range within the area can be employed as score E.

For example, when patterns CA1 to CA4 are located in a range that has substantially the same center as the areas where each of the patterns are transferred (AREA1 to AREA4) and is reduced by approximately 60% of the areas (AREA1 to AREA4), as the above designated range the range that has substantially the same center as the areas (AREA1 to AREA4) and is reduced by approximately A % (as an example, 60%<A %<100%) can be used for score calculation.

In this case, because the patterned area takes up around 60% of each area (AREA1 to AREA4), it can be predicted that when the percentage of the area used in score calculation against the areas (AREA1 to AREA4) increases, the S/N ratio will also increase. Accordingly, for example, the ratio A %=90% can be employed. In this case as well, it is preferable to experimentally check several percentage cases and define the A % at a percentage where the most stable results can be obtained.

Since score E obtained in the above method expresses pattern availability in numerical values, pattern availability can be automatically and stably confirmed by performing binarization with a predetermined threshold value, as is previously described.

When the representative value related to the pixel data, which is obtained in a similar manner as the above score E, is used on detecting the formed state of the pattern, for example, even in the case when only one type of L/S pattern is used as the measurement pattern, the pattern availability judgment is expected to be accurately performed. In this case, when described in line with the above second embodiment, the image of only one L/S pattern will be formed within area DA_{i, j}, however, when the representative value related to the pixel data decided in a similar manner as score E is used, the pattern availability judgment can be stably performed, therefore, the two types of contrast values do not necessarily have to be detected as in the above second embodiment.

In addition, in the above second embodiment, the shape of the area where the pixel data is extracted is described as a rectangle, however, the present invention is not limited to this, and for example, the area may have a circular shape, an elliptic shape, or a triangular shape. In addition, the size of the area can be optional. That is, setting the extracting area according to the shape of the measurement pattern can reduce noise, as well as improve the S/N ratio. As a matter of course, also in such a case, the pixel data may be used partially without using all the data, and at least one of the additional value, differential sum, dispersion, and standard deviation of the partial pixel data may be set as the representative value, which is compared with a predetermined threshold value to detect the formed state of the image of the measurement pattern.

In addition, in the above second embodiment, two types of threshold values are used for detecting the formed state of the image, however, the present invention is not limited to this, and it may be at least one threshold value.

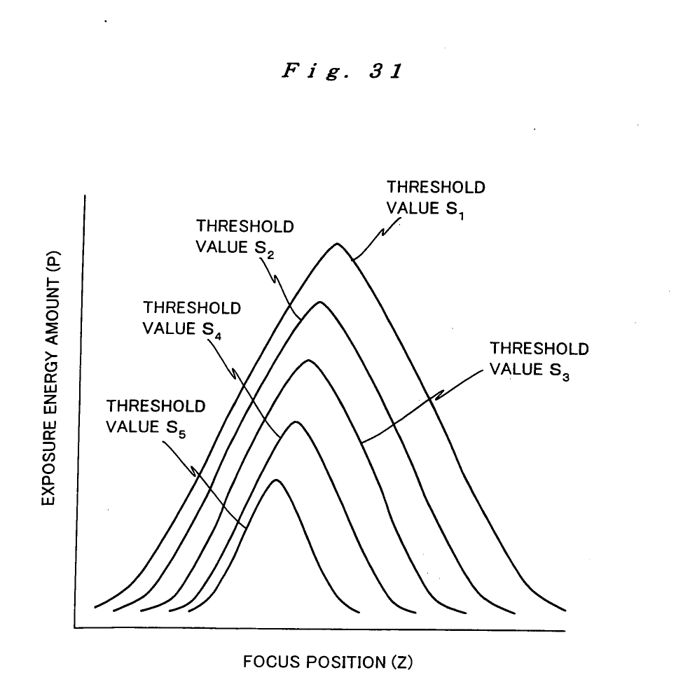

Furthermore, in the above second embodiment, the formed state is detected using the second threshold value and the best focus position is obtained from the detection results, only in the case when the best focus position is difficult to calculate from the detection results using the first detection value, however, a plurality of threshold values Sₘ may be set in advance, and a best focus position Zₘ may be obtained per each threshold value Sₘ and an average value (a simple average value or a weighting average value) of such threshold values may be set as the best focus position Z_{best}. As an example, FIG. 31 shows a simplified relation between exposure energy amount P and focus position Z, based on detection results using five types of threshold values S₁ to S₅. From this relation, the focus position when exposure energy amount P is the local extremum is sequentially calculated according to each threshold value. And, the average value of each focus position is set as the best focus position Z_{best}. The two intersecting points (focus positions) of an approximation curve that shows the relation between exposure energy amount P and focus position Z and an appropriate slice level may be obtained, and the average value of both intersecting points per each threshold value calculated and their average value (a simple average value or a weighting average value) may be decides to be the best focus position Z_{best}.

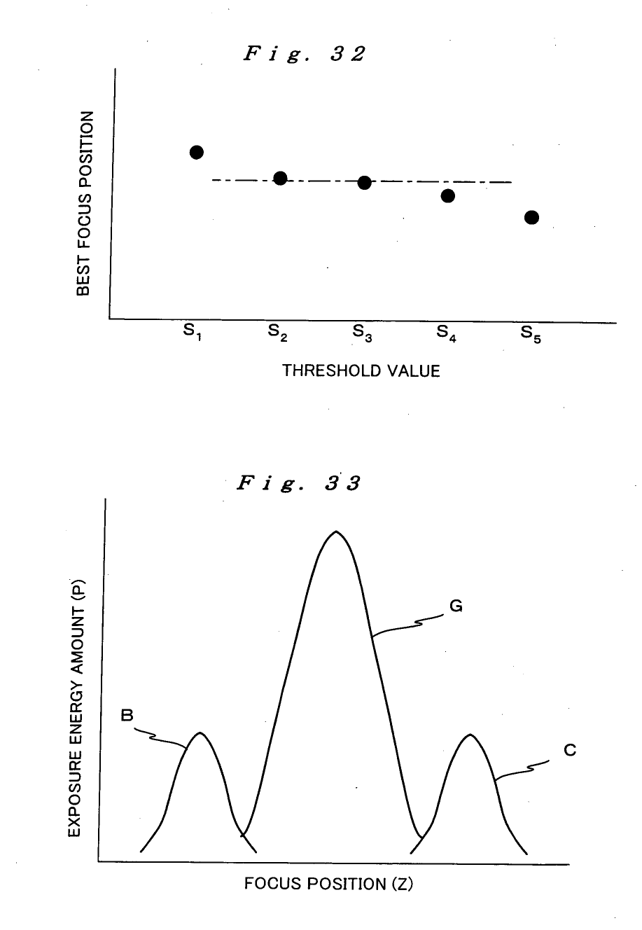

Or, the best focus potion Zₘ may be calculated per each threshold value Sₘ, and as is shown in FIG. 32 in the relation between threshold value Sₘ and the best focus potion Zₘ, the average value of the best focus potion Zₘ in a range where the best focus potion Zₘ alters the smallest (in FIG. 32, the simple average value or the weighting average value of Z₂ and Z₃) with respect to the change in threshold value Sₘ may be decided as the best focus position Z_{best}.

In addition, in the above second embodiment, a value that is set in advance is used as the threshold value; however, the present invention is not limited to this. For example, an area on wafer W_{T} where the measurement pattern is not transferred may be imaged, and the contrast obtained in such a case may be used as the threshold value.

Furthermore, in the above second embodiment, the N×M divided areas have all been exposed, however, at least one of the N×M divided areas does not have to be exposed, in the same manner as in the first embodiment previously described.

With the exposure apparatus in the above second embodiment, the measurement process can be automatically performed by the main controller performing the measurement of optical properties of the projection optical system according to a processing program stored in the storage device (not shown). As a matter of course, the processing program may also be stored in other information storage mediums (such as a CD-ROM, or an MO). Furthermore, the processing program may be downloaded from a server (not shown) when the measurement is performed. In addition, the measurement results can be sent to the server (not shown), or may be notified outside by e-mail or file transfer via the Internet or an intranet.

In addition, when processing is performed in a similar manner as in the above second embodiment, there may be cases in the relation between exposure energy amount P and focus position Z where a plurality of local extremums are included, as is shown in FIG. 33. In such a case, the best focus position may be calculated based on only a curve G that has the maximum local extremum, however, curves B and C that have small local extremums may contain necessary information; therefore, the best focus position is preferably calculated using curves B and C as well without ignoring them. For example, the average value of the focus position corresponding to the local extremums of curves B and C and the focus position corresponding to the local extremum of curve G may be averaged (as a simple average value or a weighting average value) and may be decided as the best focus position.

In the above second embodiment, the case has been described where the line width of each pattern is the same, however, the present invention is not limited to this, and the patterns may include lines with a different line width. This makes it possible to obtain the influence that the line width has on the optical properties.

In addition, in the above second embodiment, the evaluation point corresponding areas on the wafer does not necessarily have to be made into divided areas in the shape of a matrix, as is previously described. That is because at whatever position on the wafer the transferred image of the pattern is formed, it is sufficiently possible to obtain the contrast using its imaging data. That is, as long as the imaging data file can be made, the contrast can be obtained.

The techniques described in the above first embodiment and those described in the above second embodiment may be appropriately combined. For example, in the above embodiment, a similar pattern as in the second embodiment may be used as the measurement pattern in the above first embodiment. In such an arrangement, in addition to the curvature of field of projection optical system PL, astigmatism for each evaluation point in the field of projection optical system PL, regularity within the astigmatism surface, and moreover, the total focus difference can be obtained with high precision from the regularity within the astigmatism surface and the curvature of field, as in the above first embodiment.

In the above first and second embodiments, the image forming characteristics of projection optical system PL has been adjusted via the image forming characteristics correction controller, however, in the case when the image forming characteristics cannot be controlled to be within a predetermined range with only the image forming characteristics correction controller, projection optical system PL may at least be partly exchanged, or at least one of the optical elements of projection optical system PL may be re-processed (aspheric processing). In addition, especially when the optical elements are lens elements their decentration can be changed, or the lens elements can be rotated wit the optical axis serving as the center. In such a case, when the resist image or the like is detected using the alignment detection system of the exposure apparatus, the main controller may notify the operator for an assistance request through a warning message on the display (monitor) or through the Internet or a cellular phone, and the information necessary for adjusting projection optical system PL such as the place where optical elements should be exchanged or reprocessed in projection optical system PL may preferably be notified together. With such an arrangement, not only the operation time such as the optical properties measurement but also its preparation time can also be reduced, which results in being able to reduce the operation suspension time of the exposure apparatus, or in other words, being able to improve the operation rate of the exposure apparatus.

In addition, in the above first and second embodiments, the case has been described where after the measurement pattern is transferred onto each divided area DA_{i, j} on wafer W_{T}, the resist image formed in each divided area DA_{i, j} on wafer W_{T} after development is picked up by alignment detection system AS of the FIA system and image processing on the imaging data is performed, however, the optical properties measurement method related to the present invention is not limited to this. For example, the subject to imaging may be the latent image formed on the resist upon exposure, and the imaging may also be performed on the image obtained by developing the wafer where the above image is formed and performing etching on the wafer (etching image). In addition, the photosensitive layer for detecting the formed state of the image on the object such as the wafer is not limited to a photoresist, so long as an image (a latent image or a manifest image) can be formed by an irradiation of light (energy). For example, the photosensitive layer may be an optical recording layer or a magenetooptic recording layer. Therefore, accordingly, the object on which the photosensitive layer is formed is not limited to a wafer, a glass plate, or the like, and it may be a plate or the like on which the optical recording layer, the magenetooptic recording layer, or the like can be formed.

In addition, as the imaging device, an imaging device provided outside the exposure apparatus solely for imaging (for example, an optical microscope) may be used. In addition, it is possible to use the alignment detection system AS of the LSA system as the imaging device, so long as the contrast information of the transferred image can be obtained. Furthermore, the optical properties of projection optical system PL can be adjusted based on the measurement results previously described (such as the best focus position), without the operator intervening. That is, the exposure apparatus can have automatic adjustment functions.

In addition, in the above first and second embodiments, the case has been described where the exposure conditions that are changed on pattern transfer are the position of wafer W_{T} in the optical axis direction of the projection optical system and the energy amount (exposure dose amount) of the energy beam irradiated on the surface of wafer W_{T}, however, the present invention is not limited to this. For example, the exposure conditions may be either an illumination condition (including the type of mask) or a setting condition of the entire arrangement related to exposure such as the image forming characteristics of the projection optical system, and in addition, exposure does not necessarily have to be performed while changing the two types of exposure conditions. That is, even when the pattern of the measurement mask is transferred onto a plurality of areas on the object such as a wafer and the formed state of the transferred images is detected while only one type of exposure condition, such as the position of wafer W_{T} in the optical axis direction of the projection optical system is changed, smooth detection by contrast measurement (including measurement using the score) or the method of template matching can be effectively performed. For example, instead of using the energy amount, the optical properties of the projection optical system can be measured by the change in line width of a line pattern, pitch of a contact hole, or the like.

In addition, in the above first and second embodiments, the best exposure amount can be decided along with the best focus position. That is, the best exposure amount is set by setting the exposure energy amount also to the low energy amount side, obtaining the width of the focus position where the image is detected per exposure energy amount by performing the processing similar to the above embodiments, and calculating the exposure energy amount when the width becomes maximum, which is the best exposure amount.

Furthermore, in the above first and second embodiments, since the illumination condition of the reticle can be changed according to the pattern to be transferred onto the wafer with the exposure apparatus in FIG. 1, for example, it is preferable to perform similar processing as the above embodiments under a plurality of illumination conditions used in the exposure apparatus and to obtain the optical properties referred to earlier (such as the best focus position) per the illumination conditions. In addition, when the forming conditions of the pattern to be transferred onto the wafer (such as the pitch, line width, availability of phase shift areas, or whether the pattern is a dense pattern or an isolated pattern) are different, processing similar to each of the above embodiments may be performed for each pattern using the measurement pattern with the same or similar forming conditions as the pattern, in order to obtain the optical properties referred to earlier per each forming condition.

In addition, in the above first and second embodiments, as the optical properties of projection optical system PL, the depth of focus may be obtained for the measurement points previously described. In addition, the photosensitive layer (photoresist) formed on the wafer may not only be a positive type, but it can be a negative type as well.

Furthermore, the light source of the exposure apparatus to which the present invention is applied is not limited to a KrF excimer laser or an ArF excimer laser, and it may also be an F₂ laser (wavelength 157 nm) or a pulse laser light source in other vacuum ultraviolet regions. Besides such light sources, as the exposure illumination light, for example, a harmonic wave may be used that is obtained by amplifying a single-wavelength laser beam in the infrared or visible range emitted by a DFB semiconductor laser or fiber laser, with a fiber amplifier doped with, for example, erbium (or both erbium and ytteribium), and by converting the wavelength into ultraviolet light using a nonlinear optical crystal. In addition, an extra-high pressure mercury lamp that emits an emission line in the ultraviolet region (such as a g-line or an i-line) or the like may also be used. In such a case, the exposure energy may be adjusted by lamp output control, an attenuation filter such as an ND filter, a light restricting diaphragm, or the like.

In the above embodiments, the cases have been described where the present invention has been applied to a reduction projection exposure apparatus based on a step-and-repeat method, however, as a matter of course, the application scope of the present invention is not limited to this. That is, the present invention can also be suitably applied to equipment such as an exposure apparatus based on a step-and-scan method or a step-and-stitch method, a mirror projection aligner, or a photorepeater. For example, when the present invention is used in the exposure apparatus based on the step-and-scan method, especially when the exposure apparatus based on the step-and-scan method is used in the first embodiment, a reticle on which a square or a rectangular shaped aperture pattern similar to aperture pattern AP described earlier is formed is loaded on the reticle stage, and based on the scanning exposure method, the rectangular framed shaped second area previously described, can be formed. In such a case, the time required for forming the second area can be reduced, compared with the case in the embodiments previously described.

Furthermore, projection optical system PL may be a dioptric system, a catadioptric system, or a reflection system. Or, it may be a reduction system, an equal magnification system, or a magnifying system.

For example, in the case of a scanning exposure apparatus, an illumination area that is a narrow rectangular shape or an arc-shaped slit is formed in the non-scanning direction, and by arranging the evaluation points within an area in the image field of the projection optical system corresponding to the illumination area, the optical properties of projection optical system PL such as the best focus position or curvature of field, and the best exposure amount can be obtained in the same manner as in the above embodiments. In addition, in the case of a scanning exposure apparatus using a pulsed light source, the exposure dose amount (exposure energy amount, integrated energy amount) on the image plane can be adjusted to a desired value by adjusting at least one of the energy amount per pulse irradiated on the image plane from the pulsed light source, the pulse repetition frequency, the width of the illumination area in the scanning direction (or the so-called slight width), and the scanning velocity.

Furthermore, the present invention can be widely applied not only to the exposure apparatus that manufactures semiconductor devices, but can also be applied to equipment such as the exposure apparatus for liquid crystals that transfers liquid crystal display device patterns on square shaped glass plates, the exposure apparatus for manufacturing display devices such as a plasma display or an organic EL, thin film magnetic heads, imaging devices (such as a CCD), micromachines, DNA chips, and the like, as well as the exposure apparatus used for manufacturing masks and reticles. In addition, the present invention can be applied not only to the exposure apparatus that manufactures reticles and masks used when manufacturing microdevices such as semiconductor devices, but also to an exposure apparatus that transfers circuit patterns onto a glass substrate or a silicon wafer in order to produce reticles and masks used in an optical exposure apparatus, an EUV exposure apparatus, an X-ray exposure apparatus, an electron beam exposure apparatus, or the like.

In each of the above embodiments, the cases have been described where the exposure apparatus operates based on the static exposure method, however, the optical properties of the projection optical system can also be measured by performing the same processing as in the above embodiments even when using the exposure apparatus based on the scanning exposure method. In addition, in a scanning exposure type exposure apparatus, when the wafer is exposed using the measurement pattern described earlier, the optical properties that do not include the influence of the movement accuracy of the reticle stage and the wafer stage is preferably obtained. As a matter of course, the measurement pattern may be transferred based on the scanning exposure method, and the dynamic optical properties may be obtained.

Device Manufacturing Method

Next, an embodiment of a device manufacturing method that uses the above exposure apparatus and the exposure method is described.

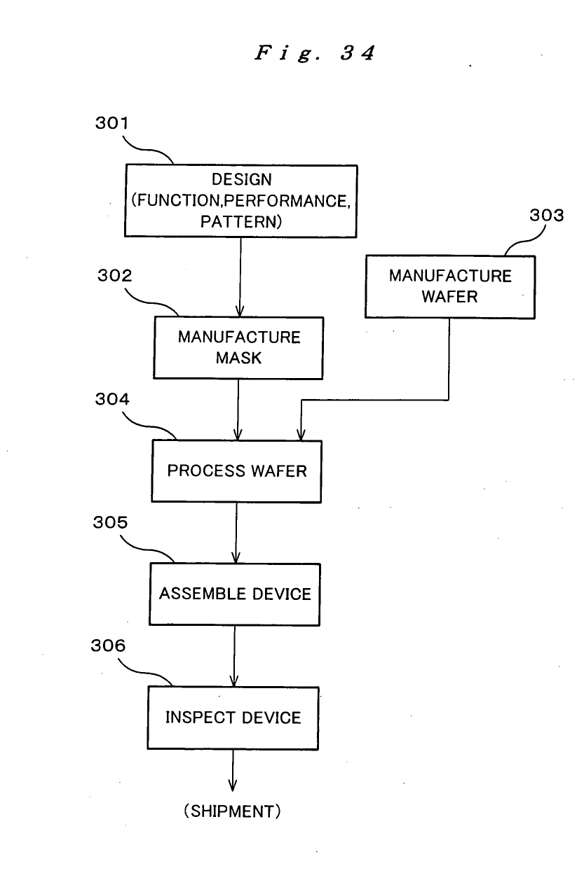

FIG. 34 is a flow chart showing an example of manufacturing a device (a semiconductor chip such as an IC or an LSI, a liquid crystal panel, a CCD, a thin magnetic head, a micromachine, or the like). As shown in FIG. 34, in step 301 (design step), function/performance is designed for a device (for example, circuit design for a semiconductor device) and a pattern to implement the function is designed. In step 302 (mask manufacturing step), a mask on which the designed circuit pattern is formed is manufactured, whereas, in step 303 (wafer manufacturing step), a wafer is manufacturing by using a silicon material or the like.

In step 304 (wafer processing step), an actual circuit and the like is formed on the wafer by lithography or the like using the mask and wafer prepared in steps 301 to 303, as will be described later. Next, in step 305 (device assembly step) a device is assembled using the wafer processed in step 304. The step 305 includes processes such as dicing, bonding, and packaging (chip encapsulation), as necessary.

Finally, in step 306 (inspection step), tests on operation, durability, and the like are performed on the device processed in step 305. After these steps, the device is completed and shipped out.

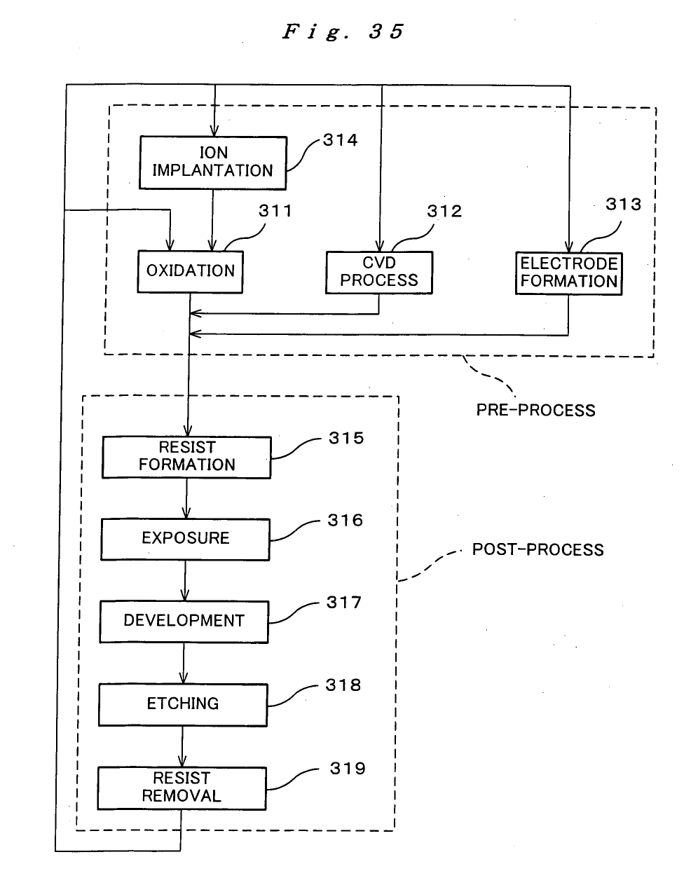

FIG. 35 is a flow chart showing a detailed example of step 304 described above in manufacturing the semiconductor device. Referring to FIG. 35, in step 311 (oxidation step), the surface of the wafer is oxidized. In step 312 (CVD step), an insulating film is formed on the wafer surface. In step 313 (electrode formation step), an electrode is formed on the wafer by vapor deposition. In step 314 (ion implantation step), ions are implanted into the wafer. Steps 311 to 314 described above make up a pre-process for the respective steps in the wafer process, and are selectively executed depending on the processing required in the respective steps.

When the above pre-process is completed in the respective steps in the wafer processing, a post-process is executed in the following manner. In this post-process, first, in step 315 (resist formation step), the wafer is coated with a photosensitive agent. Next, in step 316 (exposure step), the circuit pattern on the mask is transferred onto the wafer by the exposure apparatus and the exposure method described above. And, in step 317 (development step), the wafer that has been exposed is developed. Then, in step 318 (etching step), an exposed member of an area other than the area where the resist remains is removed by etching. Finally, in step 319 (resist removing step), when etching is completed, the resist that is no longer necessary is removed.

By repeatedly performing these pre-process and post-process steps, multiple circuit patterns are formed on the wafer.

When using such device manufacturing method in the embodiment, since the exposure apparatus and the exposure method described in the above embodiments are used in the exposure process, exposure with high precision can be performed via the projection optical system the has been adjusted taking into consideration the optical properties that have been obtained with good accuracy in the optical properties measurement method previously described, which in turn makes it possible to manufacture high integration devices with good productivity.

While the above-described embodiments of the present invention are the presently preferred embodiments thereof, those skilled in the art of lithography systems will readily recognize that numerous additions, modifications, and substitutions may be made to the above-described embodiments without departing from the spirit and scope thereof. It is intended that all such modifications, additions, and substitutions fall within the scope of the present invention, which is best defined by the claims appended below.

What is claimed is:

1. An optical properties measurement method in which optical properties of a projection optical system that projects a pattern on a first surface onto a second surface is measured, said measurement method comprising:
a first step in which a rectangular shaped first area in general made up of a plurality of divided areas arranged in a matrix shape is formed on an object, by a measurement pattern arranged on said first surface being sequentially transferred onto said object arranged on said second surface side of said projection optical system while at least one exposure condition is changed;
a second step in which an overexposed second area is formed in an area on said object that is at least part of the periphery of said first area;
a third step in which a formed state of an image of said measurement pattern in a plurality of divided areas that are at least part of said plurality of divided areas making up said first area is detected; and
a fourth step in which optical properties of said projection optical system are obtained, based on results of said detection.

2. The optical properties measurement method of claim 1 wherein
said second step is performed prior to said first step.

3. The optical properties measurement method of claim 1 wherein
said second area is at least part of a rectangular frame shaped area that encloses said first area, slightly larger than said first area.

4. The optical properties measurement method of claim 1 wherein
in said second step, said second area is formed by transferring a predetermined pattern arranged on said first surface onto said object arranged on said second surface side of said projection optical system.

5. The optical properties measurement method of claim 4 wherein
said predetermined pattern is a rectangular shaped pattern in general, and
in said second step, said rectangular shaped pattern in general arranged on said first surface is transferred onto said object arranged on said second surface side of said projection optical system by a scanning exposure method.

6. The optical properties measurement method of claim 4 wherein
said predetermined pattern is a rectangular shaped pattern in general, and
in said second step, said rectangular shaped pattern in general arranged on said first surface is sequentially transferred onto said object arranged on said second surface side of said projection optical system.

7. The optical properties measurement method of claim 1 wherein
in said second step, said measurement pattern arranged on said first surface is sequentially transferred onto said object arranged on said second surface side of said projection optical system with an overexposed exposure amount, so as to form said second area.

8. The optical properties measurement method of claim 1 wherein
in said third step, each position is calculated for said plurality of divided areas making up said first area, with part of said second area as datums.

9. The optical properties measurement method of claim 1 wherein
in said third step, said formed state of an image in a plurality of divided areas that are at least part of said plurality of divided areas making up said first area is detected by a template matching method, based on imaging data corresponding to said plurality of divided areas that make up said first area and to said second area.

10. The optical properties measurement method of claim 1 wherein
in said third step, said formed state of an image in a plurality of divided areas that are at least part of said plurality of divided areas making up said first area is detected with a representative value related to pixel data of each of said divided areas obtained by imaging serving as a judgment value.

11. The optical properties measurement method of claim 10 wherein
said representative value is at least one of an additional value, a differential sum, a dispersion, and a standard deviation of said pixel data.

12. The optical properties measurement method of claim 10 wherein
said representative value is at least one of an additional value, a differential sum, a dispersion, and a standard deviation of a pixel value within a designated range in each divided area.

13. The optical properties measurement method of claim 10 wherein
on detecting said formed state of said image, binarization is performed comparing said representative value for each of said divided areas to a predetermined threshold value.

14. The optical properties measurement method of claim 1 wherein
said exposure condition includes at least one of a position of said object in an optical axis direction of said projection optical system and an energy amount of an energy beam irradiated on said object.

15. The optical properties measurement method of claim 1 wherein
on transferring said measurement pattern, said measurement pattern is sequentially transferred onto said object while a position of said object in an optical axis direction of said projection optical system and an energy amount of an energy beam irradiated on said object are changed, respectively,
on detecting said formed state of said image, image availability of said measurement pattern in said at least part of said plurality of divided areas on said object is detected, and
on obtaining said optical properties, the best focus position is decided from a correlation between an energy amount of said energy beam and a position of said object in said optical axis direction of said projection optical system that corresponds to said plurality of divided areas where said image is detected.

16. An optical properties measurement method in which optical properties of a projection optical system that projects a pattern on a first surface onto a second surface is measured, said measurement method comprising:
a first step in which a measurement pattern including a multibar pattern arranged on said first surface is sequentially transferred onto an object arranged on said second surface side of said projection optical system while at least one exposure condition is changed, and a predetermined area made up of a plurality of adjacent divided areas is formed where said multibar pattern transferred on each divided area and its adjacent pattern are spaced apart at a distance greater than distance L, which keeps contrast of an image of said multibar pattern from being affected by said adjacent pattern;
a second step in which a formed state of an image in a plurality of divided areas that are at least part of said plurality of divided areas making up said predetermined area is detected; and
a third step in which optical properties of said projection optical system are obtained, based on results of said detection.

17. The optical properties measurement method of claim 16 wherein
in said second step, said formed state of an image is detected by an image processing method.

18. The optical properties measurement method of claim 16 wherein
when resolution of an imaging device that images each of said divided areas is expressed as R_{f}, contrast of said multipattern image is expressed as C_{f}, process factor determined by process is expressed as P_{f}, and detection wavelength of said imaging device is expressed as λ_{f}, then said distance L is expressed as a function L=f (C_{f}, R_{f}, P_{f}, and λ_{f}).

19. The optical properties measurement method of claim 16 wherein
said predetermined area is a rectangular shape in general made up of a plurality of divided areas arranged in a matrix on said object.

20. The optical properties measurement method of claim 19 wherein
in said second step, a rectangular outer frame made up of an outline of the outer periphery of said predetermined area is detected based on imaging data corresponding to said predetermined area, and with said outer frame as datums, each position of a plurality of divided areas that make up said predetermined area is calculated.

21. The optical properties measurement method of claim 16 wherein
in said first step, as a part of said exposure condition, an energy amount of an energy beam irradiated on said object is changed so that a plurality of specific divided areas that are at least a part of a plurality of divided areas located on the outermost portion within said predetermined area becomes an overexposed area.

22. The optical properties measurement method of claim 16 wherein
in said second step, said formed state of an image in a plurality of divided areas that are at least part of said plurality of divided areas making up said predetermined area is detected by a template matching method, based on imaging data corresponding to said plurality of divided areas making up said predetermined area.

23. The optical properties measurement method of claim 16 wherein
in said second step, said formed state of an image in a plurality of divided areas that are at least part of said plurality of divided areas making up said predetermined area is detected with a representative value related to pixel data of each of said divided areas obtained by imaging serving as a judgment value.

24. The optical properties measurement method of claim 23 wherein
said representative value is at least one of an additional value, a differential sum, a dispersion, and a standard deviation of said pixel data.

25. The optical properties measurement method of claim 23 wherein
said representative value is at least one of an additional value, a differential sum, a dispersion, and a standard deviation of a pixel value within a designated range in each divided area.

26. The optical properties measurement method of claim 16 wherein
said exposure condition includes at least one of a position of said object in an optical axis direction of said projection optical system and an energy amount of an energy beam irradiated on said object.

27. The optical properties measurement method of claim 16 wherein
on transferring said measurement pattern, said measurement pattern is sequentially transferred onto said object while a position of said object in an optical axis direction of said projection optical system and an energy amount of an energy beam irradiated on said object are changed, respectively,
on detecting said formed state of said image, image availability of said measurement pattern in said at least part of said plurality of divided areas on said object is detected, and
on obtaining said optical properties, the best focus position is decided from a correlation between an energy amount of said energy beam and a position of said object in said optical axis direction of said projection optical system that corresponds to said plurality of divided areas where said image is detected.

28. An optical properties measurement method in which optical properties of a projection optical system that projects a pattern on a first surface onto a second surface is measured, said measurement method comprising:
a first step in which a rectangular shaped predetermined area in general made up of a plurality of divided areas arranged in a matrix shape is formed on an object, by arranging a measurement pattern formed on a light transmitting section on said first surface and sequentially moving said object arranged on said second surface side of said projection optical system at a step pitch whose distance corresponds to the size equal to said light transmitting section and under, while at least one exposure condition is changed;
a second step in which a formed state of an image in a plurality of divided areas that are at least part of said plurality of divided areas making up said predetermined area is detected; and
a third step in which optical properties of said projection optical system are obtained, based on results of said detection.

29. The optical properties measurement method of claim 28 wherein
in said second step, said formed state of said image is detected by an image processing method.

30. The optical properties measurement method of claim 28 wherein
said step pitch is set so that projection areas of said light transmitting section are one of being substantially in contact and being overlapped on said object.

31. The optical properties measurement method of claim 30 wherein
on said object, a photosensitive layer is made of a positive type photoresist on its surface, said image is formed on said object after going through a development process after said measurement pattern is transferred, and said step pitch is set so that a photosensitive layer between adjacent images on said object is removed by said development process.

32. The optical properties measurement method of claim 28 wherein
on said object, a photosensitive layer is made of a positive type photoresist on its surface, said image is formed on said object after going through a development process after said measurement pattern is transferred, and said step pitch is set so that a photosensitive layer between adjacent images on said object is removed by said development process.

33. The optical properties measurement method of claim 28 wherein
in said first step, as a part of said exposure condition, an energy amount of an energy beam irradiated on said object is changed so that a plurality of specific divided areas that are at least a part of a plurality of divided areas located on the outermost portion within said predetermined area becomes an overexposed area.

34. The optical properties measurement method of claim 28 wherein said second step includes:
an outer frame detection step in which a rectangular outer frame made up of an outline of the outer periphery of said predetermined area is detected based on imaging data corresponding to said predetermined area; and
a calculation step in which each position of a plurality of divided areas that make up said predetermined area is calculated with said outer frame as datums.

35. The optical properties measurement method of claim 34 wherein
in said outer frame detection step, said outer frame detection is performed based on at least eight points that are obtained, which are at least two point obtained on a first side to a fourth side that make up said rectangular outer frame that form an outline of the outer periphery of said predetermined area.

36. The optical properties measurement method of claim 34 wherein
in said calculation step, each position of said plurality of divided areas that make up said predetermined area is calculated by using known arrangement information of a divided area and equally dividing an inner area of said outer frame that has been detected.

37. The optical properties measurement method of claim 34 wherein said outer frame detection step includes:
a rough position detecting step in which rough position detection is performed on at least one side of a first side to a fourth side that make up said rectangular outer frame that form an outline of the outer periphery of said predetermined area; and
a detail position detecting step in which the position of said first side to said fourth side is detected using detection results of said rough position detection performed on at least one side calculated in said rough position detecting step.

38. The optical properties measurement method of claim 37 wherein
in said rough position detecting step, border detection is performed using information of a pixel column in a first direction that passes near an image center of said predetermined area, and a rough position of said first side and said second side that are respectively located on one end and the other end in said first direction of said predetermined area and extend in a second direction perpendicular to said first direction is obtained, and
in said detail position detecting step
border detection is performed, using a pixel column in said second direction that passes through a position a predetermined distance closer to said second side than said obtained rough position of said first side and also a pixel column in said second direction that passes through a position a predetermined distance closer to said first side than said obtained rough position of said second side, and said third side and said fourth side that are respectively located on one end and the other end in said second direction of said predetermined area extending in said first direction and two points each on both said third side and said fourth side are obtained,
border detection is performed, using a pixel column in said first direction that passes through a position a predetermined distance closer to said fourth side than said obtained third side and also a pixel column in said first direction that passes through a position a predetermined distance closer to said third side than said obtained fourth side, and two points each on both said third side and said fourth side of said predetermined area are obtained,
four corners of said predetermined area, which is a rectangular shaped area, are obtained as intersecting points of four straight lines that are determined based on two points each being located on said first side to said fourth side, and
based on said four corners that are obtained, rectangle approximation is performed by a least squares method to calculate said rectangular outer frame of said predetermined area including rotation.

39. The optical properties measurement method of claim 38 wherein
on said border detection, a detection range of a border where error detection may easily occur is narrowed down, using detection information of a border where error detection is difficult to occur.

40. The optical properties measurement method of claim 38 wherein
on said border detection, intersecting points of a signal waveform formed based on pixel values of each of said pixel columns and a predetermined threshold value t are obtained, and then a local maximal value and a local minimal value close to each intersecting point are obtained,
an average value of said local maximal value and said local minimal value that have been obtained is expressed as a new threshold value t′, and
a position where said signal waveform crosses said new threshold value t′ in between said local maximal value and said local minimal value is obtained, which is determined as a border position.

41. The optical properties measurement method of claim 40 wherein
said threshold value t is set by
obtaining the number of intersecting points of a threshold value and a signal waveform formed of pixel values of linear pixel columns extracted for said border detection while said threshold value is changed within a predetermined fluctuation range, deciding a threshold value to be a temporary threshold value when said number of intersecting points obtained matches a target number of intersecting points determined according to said measurement pattern, obtaining a threshold range that includes said temporary threshold value and said number of intersecting points matches said target number of intersecting points, and deciding the center of said threshold range center as said threshold value t.

42. The optical properties measurement method of claim 41 wherein
said fluctuation range is set based on an average and a standard deviation of said pixel values of linear pixel columns extracted for said border detection.

43. The optical properties measurement method of claim 28 wherein
in said second step, said formed state of an image in a plurality of divided areas that are at least part of said plurality of divided areas making up said first area is detected by a template matching method, based on imaging data corresponding to said predetermined area.

44. The optical properties measurement method of claim 28 wherein
in said second step, said formed state of an image in a plurality of divided areas that are at least part of said plurality of divided areas making up said predetermined area is detected with a representative value related to pixel data of each of said divided areas obtained by imaging serving as a judgment value.

45. The optical properties measurement method of claim 44 wherein
said representative value is at least one of an additional value, a differential sum, a dispersion, and a standard deviation of said pixel data.

46. The optical properties measurement method of claim 44 wherein
said representative value is at least one of an additional value, a differential sum, a dispersion, and a standard deviation of a pixel value within a designated range in each divided area.

47. The optical properties measurement method of claim 46 wherein
said designated range is a reduced area where each of said divided areas is reduced at a reduction rate decided according to a designed positional relationship between an image of said measurement pattern and said divided area.

48. The optical properties measurement method of claim 28 wherein
said exposure condition includes at least one of a position of said object in an optical axis direction of said projection optical system and an energy amount of an energy beam irradiated on said object.

49. The optical properties measurement method of claim 28 wherein
in said first step, said measurement pattern is sequentially transferred onto said object while a position of said object in an optical axis direction of said projection optical system and an energy amount of an energy beam irradiated on said object are changed, respectively,
in said second step, image availability of said measurement pattern in said at least part of said plurality of divided areas on said object is detected, and
in said third step, the best focus position is decided from a correlation between an energy amount of said energy beam and a position of said object in said optical axis direction of said projection optical system that corresponds to said plurality of divided areas where said image is detected.

50. An optical properties measurement method in which optical properties of a projection optical system that projects a pattern on a first surface onto a second surface is measured, said measurement method comprising:
a first step in which a measurement pattern arranged on said first surface is sequentially transferred onto a plurality of areas on an object arranged on said second surface side of said projection optical system while at least one exposure condition is changed;
a second step in which said measurement pattern transferred with different exposure conditions on said plurality of areas is imaged, imaging data for each area consisting of a plurality of pixel data is obtained, and a formed state of an image of said measurement pattern is detected in a plurality of areas that are at least part of said plurality of areas, using a representative value related to pixel data for each area; and
a third step in which optical properties of said projection optical system are obtained, based on results of said detection.

51. The optical properties measurement method of claim 50 wherein
in said second step, said formed state of an image of said measurement pattern is detected in a plurality of areas that are at least part of said plurality of areas by setting a representative value that is at least one of an additional value, a differential sum, a dispersion, and a standard deviation of all pixel data for each area, and comparing said representative value with a predetermined threshold value.

52. The optical properties measurement method of claim 50 wherein
in said second step, said formed state of an image of said measurement pattern is detected in a plurality of areas that are at least part of said plurality of areas by setting a representative value that is at least one of an additional value, a differential sum, a dispersion, and a standard deviation of partial pixel data for each area, and comparing said representative value with a predetermined threshold value.

53. The optical properties measurement method of claim 52 wherein
said partial pixel data is pixel data within a designated range within said each area, and said representative value is one of an additional value, a differential sum, a dispersion, and a standard deviation of said pixel data.

54. The optical properties measurement method of claim 53 wherein
said designated range is a partial area in said each area, which is determined according to an arrangement of said measurement pattern within said each area.

55. The optical properties measurement method of claim 50 wherein
in said second step, said formed state of an image of said measurement pattern is detected for a plurality of different threshold values by comparing said threshold values with said representative value, and
in said third step, said optical properties are measured based on results of said detection obtained for each of said threshold values.

56. The optical properties measurement method of claim 50 wherein
said second step includes:
a first detection step in which a first formed state of an image of said measurement pattern is detected by setting a representative value that is at least one of an additional value, a differential sum, a dispersion, and a standard deviation of all pixel data for each area in a plurality of areas that are at least part of said plurality of areas, and comparing said representative value with a predetermined threshold value; and
a second detection step in which a second formed state of said image of said measurement pattern is detected by setting a representative value that is at least one of an additional value, a differential sum, a dispersion, and a standard deviation of partial pixel data for each area in a plurality of areas that are at least part of said plurality of areas, and comparing said representative value with a predetermined threshold value, and
in said third step, optical properties of said projection optical system are obtained, based on results of detecting said first formed state and results of detecting said second formed state.

57. The optical properties measurement method of claim 56 wherein
in said second step, said first formed state and said second formed state of an image of said measurement pattern are each detected for a plurality of different threshold values, by comparing said threshold values and said representative value for each threshold value, and
in said third step, optical properties of said projection optical system are obtained, based on results of detecting said first formed state and results of detecting said second formed state obtained for each of said threshold values.

58. The optical properties measurement method of claim 50 wherein
said exposure condition includes at least one of a position of said object in an optical axis direction of said projection optical system and an energy amount of an energy beam irradiated on said object.

59. The optical properties measurement method of claim 50 wherein
in said first step, said measurement pattern is sequentially transferred onto a plurality of areas on said object while a position of said object in an optical axis direction of said projection optical system and an energy amount of an energy beam irradiated on said object are changed, respectively,
in said second step, said formed state of said image is detected for each position in said optical axis direction of said projection optical system, and
in said third step, the best focus position is decided from a correlation between an energy amount of said energy beam with which said image was detected and a position of said object in said optical axis direction of said projection optical system.

60. An exposure method in which an energy beam for exposure is irradiated on a mask, and a pattern formed on said mask is transferred onto an object via a projection optical system, said method comprising:
an adjustment step in which said projection optical system is adjusted taking into consideration optical properties that are measured using said optical properties measurement method of claim 1; and
a transferring step in which said pattern formed on said mask is transferred onto said object via said projection optical system that has been adjusted.

61. A device manufacturing method including a lithographic process, wherein
in said lithographic process, exposure is performed using said exposure method of claim 60.

62. An exposure method in which an energy beam for exposure is irradiated on a mask, and a pattern formed on said mask is transferred onto an object via a projection optical system, said method comprising:
an adjustment step in which said projection optical system is adjusted taking into consideration optical properties that are measured using said optical properties measurement method of claim 16; and
a transferring step in which said pattern formed on said mask is transferred onto said object via said projection optical system that has been adjusted.

63. A device manufacturing method including a lithographic process, wherein in said lithographic process, exposure is performed using said exposure method of claim 62.

64. An exposure method in which an energy beam for exposure is irradiated on a mask, and a pattern formed on said mask is transferred onto an object via a projection optical system, said method comprising:
an adjustment step in which said projection optical system is adjusted taking into consideration optical properties that are measured using said optical properties measurement method of claim 28; and
a transferring step in which said pattern formed on said mask is transferred onto said object via said projection optical system that has been adjusted.

65. A device manufacturing method including a lithographic process, wherein
in said lithographic process, exposure is performed using said exposure method of claim 64.

66. An exposure method in which an energy beam for exposure is irradiated on a mask, and a pattern formed on said mask is transferred onto an object via a projection optical system, said method comprising:
an adjustment step in which said projection optical system is adjusted taking into consideration optical properties that are measured using said optical properties measurement method of claim 50; and
a transferring step in which said pattern formed on said mask is transferred onto said object via said projection optical system that has been adjusted.

67. A device manufacturing method including a lithographic process, wherein
in said lithographic process, exposure is performed using said exposure method of claim 66.
